(19) United States
(12) Patent Application Publication
(10) Pub. No.: US 2015/0348169 A1
(43) Pub. Date: Dec. 3, 2015

(54) SYSTEM AND METHOD FOR MARKETPLACE SOFTWARE PLATFORM

(71) Applicants: Michael Richards Harris, East Lansing, MI (US); Charles Joseph Magolske, Denver, CO (US)

(72) Inventors: Michael Richards Harris, East Lansing, MI (US); Charles Joseph Magolske, Denver, CO (US)

(21) Appl. No.: 14/721,266

(22) Filed: May 26, 2015

Related U.S. Application Data
(60) Provisional application No. 62/003,702, filed on May 28, 2014.
(60) Provisional application No. 62/093,253, filed on Dec. 17, 2014.

(51) Int. Cl. G06Q 30/06

(52) U.S. Cl. CPC G06Q 30/0633

(57) ABSTRACT

The present invention relates to a marketplace software platform that provides the capability for: (i) the negotiation of a retailer item(s) price or selection from various price offers; (ii) the issuance of an electronic discount or intelligent coupon (the “iPON™”) that may correspond to the price selected or negotiated; and (iii) the storage and updating of such iPON™ in real time.

### CROSS-REFERENCE TO RELATED APPLICATIONS

This application claims the benefit of U.S. Provisional Application No. 62/003,702, filed May 28, 2014, and U.S. Provisional Application No. 62/093,253, filed Dec. 17, 2014, both of which are hereby incorporated by reference in their entirety.

### BACKGROUND OF THE INVENTION

1. Field of the Invention

The present invention relates to a marketplace software platform that provides the capability for: (i) the negotiation of a retailer item(s) price; (ii) the issuance of an electronic discount or intelligent coupon (the “iPON™”); (iii) the storage and updating of such iPON™s in real time, and (iv) the ability to trade or transfer the iPON™ electronically.

2. Description of the Related Art

Electronic commerce systems have become widespread in today's environment. However, despite the popularity of such systems, many problems remain with the implementation and use of such systems. For example, one common problem is customer shopping cart abandonment due to high item price. This may result in lost sales and inefficient utilization of resources. Another exemplary problem is that today, discount coupons are not tied to a customer, they are static, and cannot be enhanced. Further, discount coupons are often paper and have to be stored in physical form. This may result in customer dissatisfaction, which again may lead to lost sales and inefficient utilization of resources. Further, the coupon issuer does not have the ability to contact the person holding the coupon. Thus, a need arises for a solution to these, and many other related problems present in conventional electronic commerce systems.

### SUMMARY OF THE INVENTION

Embodiments of the present invention provide solutions to a number of problems present in conventional electronic commerce systems. For example, one embodiment of the present invention relates to a marketplace software platform (the “Marketplace”) to enable: (i) the negotiation of a retailer item(s) price; (ii) the issuance of an electronic discount or intelligent coupon (the “iPON™”); and (iii) the storage and updating of such iPON™s in real time. The software platform permits: (i) the application of such iPON™s towards future purchases; (ii) the management of the sales and trading of iPON™ rewards; (iii) the acquisition of iPON™s by a third party from an issuer and their further conveyance to enhance the third party's offer in a consumer negotiation; and (iv) the management of the purchase, transfer, and redemption of the iPON™. The iPON™ is a data file that represents and retains the terms and conditions of an issuer discount or store credit that is purchased by or transferred and/or awarded to a discrete user. The iPON™ is a data file that contains other pertinent information that provides the capability for security and additional functionality of the iPON™.

In one embodiment, a method for processing at least one item identified by a buyer for purchase from a seller may comprise receiving, by at least one computing device, an identification of at least one item or service identified by a buyer for purchase in an electronic commerce transaction or in a physical purchase transaction, and receiving an indication of a price the buyer is willing to pay for the at least one item or service, responsive to receiving the identification, generating, by the at least one computing device, transaction term data for the at least one item or service by: receiving, by the at least one computing device, a sequence of transaction term data inputs from the buyer, and generating, by the at least one computing device, a corresponding sequence of display information pages, each display information page including a transaction term data output generated in response to each received transaction term data input, wherein the transaction term data includes at least some of a sales price for the identified item or service, a discount or store credit for the identified item or service, a sales price for an item or service other than the identified item or service, a discount or credit for an item or service other than the identified item or service, and items or services other than the identified item or service to be included in the transaction, wherein the identified item or service or each item or service other than the identified item or service may be provided by the seller or by another party, responsive to generating the transaction term data, generating, by the at least one computing device, a data file including at least some of the transaction term data including transaction term data relating to at least some of the identified item or service and each item or service other than the identified item or service, an identification of a party providing the identified item or service and each item or service other than the identified item or service, an identification of the buyer associated with the data file, and an identification of the seller, stored in memory, wherein the memory further stores a plurality of data files associated with different buyers, different sellers, and different transactions, receiving, by at least one computing device, an identification of one of the plurality of data files from a buyer, wherein the data file is associated with the buyer, and completing the electronic commerce purchase transaction or the physical purchase transaction using at least some of the transaction term data included in the identified data file.

The method may further comprise authenticating, by at least one computing device, a buyer, and providing, by the at least one computing device, the authenticated buyer with access to at least one data file associated with that buyer. Access to at least one data file associated with that buyer may comprise capability to identify a data file to be used to complete a transaction and capability to modify the data file. The method may further comprise receiving, by the at least one computing device, at least one modification to at least one of the plurality of stored data files, wherein the modification includes modifying at least some of the transaction term data in the data file or additional information. The modification may be performed by the buyer or the modification may be performed by the seller.

In one embodiment, a method for processing an electronic coupon may comprise generating, by at least one computing device, electronic coupon data for at least one item or service by: receiving, by the at least one computing device, a sequence of electronic coupon data inputs from a recipient of the electronic coupon, and generating, by at least one computing device, a corresponding sequence of display information pages, each display information page including electronic coupon data output generated in response to each received electronic coupon data input, wherein the electronic coupon data includes at least information identifying an issuer of the electronic coupon, information identifying at least one location at which or organization with which the electronic coupon may be redeemed, information identifying an owner of the electronic coupon, information indicating a value of the electronic coupon, a unique identifier of the electronic coupon, and information relating to a co-marketing feature, responsive to generating the electronic coupon data, generating, by the at least one computing device, a data file including at least some of the electronic coupon data including information identifying an issuer of the electronic coupon, information identifying at least one location at which or organization with which the electronic coupon may be redeemed, information identifying an owner of the electronic coupon, information indicating a value of the electronic coupon, a unique identifier of the electronic coupon, and information relating to co-marketing, stored in memory, wherein the memory further stores a plurality of data files associated with different buyers, different sellers, and different transactions, receiving, by the at least one computing device, an identification of an electronic coupon, accessing a data file corresponding to the received identification of the electronic coupon, and redeeming the electronic coupon in an electronic commerce purchase transaction or a physical purchase transaction using at least some of the electronic coupon data included in the identified data file, wherein the information relating to co-marketing further defines at least one additional location at which or organization with which the electronic coupon may be redeemed and is controlled by and modifiable by the issuer of the electronic coupon.

The electronic coupon data may further include information relating to at least one enhancement to terms of the electronic coupon, information indicating whether or not transfer of the electronic coupon to another owner is allowed, information relating to re-issuance of the electronic coupon, and information indicating a price at which the electronic coupon may be re-sold. The method may further comprise securing financial information and other electronic coupon information using a crypto-currency blockchain ledger system, wherein the electronic coupon data further includes: information relating to additional security information, including at least one of a photograph of the owner of the electronic coupon, a name of the owner of the electronic coupon, and an email address of the owner of the electronic coupon. The electronic coupon data may further include video information, audio information, information defining an option to purchase an item, including information relating to terms of the option and an expiration time or date of the option, information relating to an offer to purchase an item at a lower price, information defining a variable value of the electronic coupon based on a location at which or organization with which the electronic coupon is be redeemed or based on a form of payment that is used, and information indicating products on which the electronic coupon may be used.

### BRIEF DESCRIPTION OF THE DRAWINGS

FIG. 1 is an exemplary block diagram of exemplary embodiment of a system in which embodiments of the present invention may be implemented.

FIG. 2a is a portion of an exemplary diagram of a general description of the operation of a marketplace system according to an embodiment of the present invention.

FIG. 2b is a portion of an exemplary diagram of a general description of the operation of a marketplace system according to an embodiment of the present invention.

FIG. 3 is an exemplary block diagram of a Marketplace Server system according to an embodiment of the present invention.

FIG. 4 is an exemplary block diagram of a Retailer Website Server according to an embodiment of the present invention.

FIG. 5 is an exemplary diagram of an embodiment of operation of the Marketplace system.

FIG. 6 is an exemplary diagram of a number of embodiments of platforms that may be implemented according to the present invention.

FIG. 7 is an exemplary diagram of aspects of an embodiment of an iPON™ according to the present invention.

FIG. 8 is an exemplary diagram of aspects of an embodiment of an iPON™ according to the present invention.

FIG. 9 is an exemplary diagram of an embodiment of origination of an iPON™ according to the present invention.

FIG. 10 is an exemplary diagram of aspects of an embodiment of a platform according to the present invention.

FIG. 11 is an exemplary diagram of an embodiment of an iPON™ transaction according to the present invention.

FIG. 12 is an exemplary diagram of an embodiment of an iPON™ transaction according to the present invention.

FIG. 13 is an exemplary diagram of aspects of an embodiment of a platform according to the present invention.

FIG. 14 is an exemplary diagram of aspects of an embodiment of a platform according to the present invention.

FIG. 15 is an exemplary diagram of an embodiment of an iPON™ transaction according to the present invention.

FIG. 16 is an exemplary diagram of aspects of an embodiment of a platform according to the present invention.

FIG. 17 is an exemplary diagram of aspects of an embodiment of a platform according to the present invention.

FIG. 18 is an exemplary diagram of aspects of an embodiment of a platform according to the present invention.

FIG. 19 is an exemplary diagram of aspects of an embodiment of a platform according to the present invention.

FIG. 20 is an exemplary diagram of aspects of an embodiment of a platform according to the present invention.

FIG. 21 is an exemplary diagram of an embodiment of an iPON™ transaction according to the present invention.

FIG. 22 is an exemplary diagram of an embodiment of an iPON™ transaction according to the present invention.

FIG. 23 is an exemplary diagram of aspects of an embodiment of a platform according to the present invention.

FIG. 24 is an exemplary diagram of aspects of an embodiment of a platform according to the present invention.

FIG. 25 is an exemplary diagram of an embodiment of an iPON™ transaction according to the present invention.

FIG. 26 is an exemplary diagram of an embodiment of an iPON™ transaction according to the present invention.

FIG. 27 is an exemplary diagram of an embodiment of an iPON™ transaction according to the present invention.

FIG. 28 is an exemplary diagram of aspects of an embodiment of a platform according to the present invention.

FIG. 29 is an exemplary diagram of aspects of an embodiment of a platform according to the present invention.

FIG. 30 is an exemplary diagram of aspects of an embodiment of a platform according to the present invention.

FIG. 31 is an exemplary diagram of an embodiment of an iPON™ transaction according to the present invention.

FIG. 32 is an exemplary diagram of an embodiment of an iPON™ transaction according to the present invention.

FIG. 33 is an exemplary diagram of aspects of an embodiment of a platform according to the present invention.

FIG. 34 is an exemplary diagram of features of an embodiment of the present invention.

FIG. 35 is an exemplary diagram of features of an embodiment of the present invention.

FIG. 36 is an exemplary diagram of features of an embodiment of the present invention.

FIG. 37 is an exemplary diagram of features of an embodiment of the present invention.

FIG. 38 is an exemplary diagram of an embodiment of an iPON™ transaction according to the present invention.

FIG. 39 is an exemplary diagram of an embodiment of an iPON™ transaction according to the present invention.

FIG. 40 is an exemplary diagram of aspects of an embodiment of a platform according to the present invention.

FIG. 41 is an exemplary diagram of aspects of an embodiment of a platform according to the present invention.

FIG. 42 is an exemplary diagram of aspects of an embodiment of a platform according to the present invention.

FIG. 43 is an exemplary diagram of aspects of an embodiment of a platform according to the present invention.

FIG. 44 is an exemplary diagram of aspects of an embodiment of a platform according to the present invention.

FIG. 45 is an exemplary diagram of aspects of an embodiment of a platform according to the present invention.

FIG. 46 is an exemplary diagram of aspects of an embodiment of a platform according to the present invention.

FIG. 47 is an exemplary diagram of aspects of an embodiment of a platform according to the present invention.

FIG. 48 is an exemplary diagram of an embodiment of operation of the Marketplace system.

FIG. 48 is an exemplary diagram of an embodiment of operation of the Marketplace system.

FIG. 49 is an exemplary diagram of an embodiment of operation of the Marketplace system.

FIG. 50 is an exemplary diagram of an embodiment of operation of the Marketplace system.

FIG. 51 is an exemplary diagram of an embodiment of operation of the Marketplace system.

FIG. 52 is an exemplary diagram of features of an embodiment of the present invention.

FIG. 53 is an exemplary diagram of features of an embodiment of the present invention.

FIG. 54 is an exemplary diagram of an embodiment of operation of the Marketplace system.

FIG. 55 is an exemplary diagram of an embodiment of operation of the Marketplace system.

FIG. 56 is an exemplary diagram of an embodiment of operation of the Marketplace system.

FIG. 57 is an exemplary diagram of an embodiment of operation of the Marketplace system.

FIG. 58 is an exemplary diagram of an embodiment of operation of the Marketplace system.

FIG. 59 is an exemplary diagram of an embodiment of operation of the Marketplace system.

FIG. 60 is an exemplary diagram of an embodiment of operation of the Marketplace system.

FIG. 61 is an exemplary diagram of an embodiment of operation of the Marketplace system.

FIG. 62 is an exemplary diagram of features of an embodiment of the present invention.

FIG. 63 is an exemplary diagram of features of an embodiment of the present invention.

FIG. 64 is an exemplary diagram of features of an embodiment of the present invention.

FIG. 65 is an exemplary diagram of features of an embodiment of the present invention.

FIG. 66 is an exemplary diagram of features of an embodiment of the present invention.

FIG. 67 is an exemplary diagram of features of an embodiment of the present invention.

FIG. 68 is an exemplary diagram of features of an embodiment of the present invention.

FIG. 69 is an exemplary diagram of aspects of an embodiment of a platform according to the present invention.

FIG. 70 is an exemplary diagram of aspects of an embodiment of a platform according to the present invention.

FIG. 71 is an exemplary diagram of features of an embodiment of the present invention.

FIG. 72 is an exemplary diagram of features of an embodiment of the present invention.

FIG. 73 is an exemplary diagram of features of an embodiment of the present invention.

FIG. 74 is an exemplary diagram of features of an embodiment of the present invention.

FIG. 75 is an exemplary diagram of aspects of an embodiment of a platform according to the present invention.

FIG. 76 is an exemplary diagram of features of an embodiment of the present invention.

FIG. 77 is an exemplary diagram of features of an embodiment of the present invention.

FIG. 78 is an exemplary diagram of an embodiment of operation of the Marketplace system.

FIG. 79 is an exemplary diagram of features of an embodiment of the present invention.

FIG. 80 is an exemplary diagram of features of an embodiment of the present invention.

FIG. 81 is an exemplary diagram of features of an embodiment of the present invention.

FIG. 82 is an exemplary diagram of an embodiment of operation of the Marketplace system.

FIG. 83 is an exemplary diagram of an embodiment of operation of the Marketplace system.

FIG. 84 is an exemplary diagram of an embodiment of operation of the Marketplace system.

FIG. 85 is an exemplary diagram of features of an embodiment of the present invention.

FIG. 86 is an exemplary diagram of an embodiment of operation of the Marketplace system.

FIG. 87 is an exemplary diagram of an embodiment of operation of the Marketplace system.

### DETAILED DESCRIPTION OF THE INVENTION

Embodiments of the present invention provide a number of solutions to existing problems. In particular, embodiments of the present invention are able to solve a number of problems including, but not limited to, the following:

One problem that may be solved by an embodiment of the present invention is to reduce customer shopping cart abandonment due to high item price and provide a tool for the retailer to increase the volume of Internet sales. The Negotiator appeals to the fundamental human desire to negotiate item price, as evidenced by many cultures worldwide. The Negotiator preferably increases retailer sales because the customer has already made the decision to buy. Now, only the price needs to be negotiated. The Negotiator enables the customer to make an offer to buy the item and iPON™, a retailer store credit, can be offered as an incentive in real time or simply ask for alternative pricing and several prices each with a different iPON™ value may be offered.

Another problem that may be solved by an embodiment of the present invention is that today, discount coupons are not tied to a customer, they are static, and cannot be enhanced. By developing an intelligent electronic coupon known as the iPON™: (i)ntelligent cou(PON), the coupon concept becomes a more powerful tool. This iPON™ is assigned to a known customer, and located in the holder's account. The details of each specific iPON™ are known. The details of the iPON™ holder will be known.

Another problem that may be solved by an embodiment of the present invention is that discount coupons are often paper and have to be stored in physical form. To trade or exchange these coupons, they must be mailed or hand carried. To redeem them, paper coupons often have to be brought to the store in paper form. The iPON™ solves this issue as it resides in the customer's database account, and all the customer needs to do at a physical store is bring an electronic device, such as a mobile phone or tablet, and use the application to access their online account and reveal the iPON™ promotional code at the point of sale. The promotional code could be in a variety of forms such as a Quick Response (QR) code, a bar code, or display of a serial numeric sequence etc.

Another problem that may be solved by an embodiment of the present invention is that while some electronic coupons exist on the Internet and websites that provide electronic coupons and discount codes, with the effect of partially solving the paper physical nature of coupons described in the third problem above, these discounts are non-transferrable items, and customers may not want to gather and store in their accounts. This disadvantage of existing electronic coupons is that (a) the acquirer of such a discount code or e-coupon will abandon the opportunity unless there is an immediate need for it, and (b) will not acquire such a coupon with the intent to share, trade, or sell to friends, limiting the reach of the retailer's promotion and (c) they are limited in scope, such as value, as their distribution can be as large as the audience and not controlled. The iPON™ solves both these disadvantages as a system allows members to acquire the discount opportunity and store it for further review, and create an inventory of opportunities for trading and exchanging the iPON™ with other consumers. An especially effective feature of the iPON™ is that it can be issued by the retailer to the customer with the capability for the iPON™ holder to keep the iPON™ to redeem later or potentially sell it or transfer to others in the iPON™ Optimus Advantage network. This effectively would make the iPON™ holders a promotional channel for certain offers, giving the retailer access to more interested parties, an invention that is not present today.

Another problem that may be solved by an embodiment of the present invention is the lack of customer's promoting and recommending a retailer. While this is not a problem for the customer, retailers desperately want customers to recommend and draw in other customers. Today, individuals find and use coupons for themselves. The individuals that have a coupon do not typically contact others about this coupon or attract others to a retailer's website or physical store. The database that stores the iPON™s, by definition, is a collection of many customers who use the iPON™. This will allow communication to other iPON™ holders and by definition is a social network that will allow customers to communicate with each other and promote a retailer. Further, by allowing these iPON™s to be transferred or sold to another customer, the reach of the iPON™ is extended, as is the iPON™ issuer's effectiveness to reach a larger audience.

Another problem that may be solved by an embodiment of the present invention is to generate repeat business, which is rarely generated by a specific sale, whereas the iPON™ creates a high likelihood that the customer will be back for another sale in order to redeem the iPON™ gained or purchased as part of a prior sale.

Another problem that may be solved by an embodiment of the present invention is that retailers typically can only offer cash discounts, which results in a lower sale price for an item. The iPON™ provides two ways to solve this issue, and generate a higher profit per sale. The first way is that the discount on the sale includes the benefit of an iPON™ sold with the sale and more of the original selling price is retained. The second way would be for manufacturers to absorb some of the discounts offered to customers. For example, an automobile manufacturer offers to an automobile retailer the opportunity to sell to the automobile manufacturer iPON™s with a face value of $1,000 for a price of $900. Then, this $1,000 iPON™ can be sold or given to the buyer of the automobile as a discount. This allows the automobile retailer to show a $1,000 discount, but only give up $100 for this discount, as the automobile retailer has sold the $1,000 iPON to the Automobile manufacturer for $900. For example, once an automobile manufacturer has purchased for $900 a $1,000 iPON™ from an automobile retailer, and offer to the buyer the $1,000 iPON™. The buyer could only get a $100 discount otherwise from the automobile retailer.

Another problem that may be solved by an embodiment of the present invention is using retailer discounts and promotions across national borders. Coupons today cannot be used in other countries if they are denominated in one currency. The retailer can choose to accept an iPON™ in another country and establish a favorable exchange rate. Currently, customers need to transfer funds to an account in another country and pay fees for the transfer and exchange, and often do not receive the most competitive rate. Or, they use a credit card for purchases in another country and pay exchange fees to the card issuer. A retailer can solve this issue by honoring the iPON™ in another country and providing iPON™ holders with a favorable exchange rate, using the retailer balance sheet and inter-company transfers to settle their balances between operations in different countries. The iPON™ when transferred across a border will be denominated in a different currency.

Another problem that may be solved by an embodiment of the present invention is customer management of a personal budget and expenses by using coupons. Often customers clip coupons to save money and use them when they can. They have no view of the value by retailer or product. The iPON™ database account solves this issue by keeping track of each iPON™ in each holder's account, much like a bank account.

Another problem that may be solved by an embodiment of the present invention is that cash discount coupons of gift cards do not always have a feature to allow the customer to easily ascertain the remaining balance. With an iPON™, if the full amount is not redeemed, then the iPON™ holder can look at the account and see the balance. We envision an application for the holder's account on a computer, pad, or mobile phone, where not only remaining iPON™ balances can be viewed, but also the amount of money saved by using these iPON™s is reported weekly, monthly and year-to-date.

Another problem that may be solved by an embodiment of the present invention is that customers do purchase gift cards or Visa cash cards with a cash balance. These are physical cards that can be lost, whereas an iPON™ will not be lost. Further, these prepaid cards are expensive to a retailer, as the fees for the card issuers can range from 5 to 15%. By selling direct to a customer and using the store's credit system, the retailer saves cost of a pre-paid card and can pass this cost savings on to a customer.

Another problem that may be solved by an embodiment of the present invention is that with current promotions, coupons and gift cards, each consumer operates alone. The iPON™ will allow consumers to communicate with each other and exchange or purchase iPON™s among themselves. This creates a social network where each customer can communicate with each other about offers, discounts, and iPON™s available for trade or sale.

Another problem that may be solved by an embodiment of the present invention is the illegal use of gift cards and pre-paid credit cards. Terrorists have used them to launder money. By reducing the number of these cards, which a successful iPON™ business will do, this risk is reduced. Further, the iPON™ is assigned to a discrete user who is known. The discrete user identity could be managed by a Public Key Infrastructure (PM) system.

Another problem that may be solved by an embodiment of the present invention is the Internet comparison-shopping that websites currently employ. This allows buyers to see which Internet retailer will sell the same item for less. By offering an opportunity to negotiate and receive an iPON™, the retailer gains the opportunity to earn more business and avoid losing it to website comparison-shopping. The same benefit can be achieved by allowing multiple prices with multiple iPON™ offers.

Another problem that may be solved by an embodiment of the present invention is the use of manufacturer's or global brands coupons. Today manufacturer coupons are limited to consumables such as food, soap, and other items one would find at supermarkets, grocery stores, and pharmacies. The average value of a coupon is $1.60 in 2013. This is due to the systems in these stores and set up to accept the coupons, and tie the coupon to an actual sale. Global brands and manufacturers of larger ticket item simply do not issue coupons for the reasons of potential fraud for larger value coupons and there distribution channel is not set up to receive them. The iPON™ system ties the iPON™ to an individual when issued, and the manufacturer can see who holds the iPON™ at any time. Further, for retailers to accept the manufacturer iPON, they will need to be integrated with the iPON™ software system that allows the retailer to accept the manufacturer's iPON™ and invoice the manufacturer for this discounted price.

Another problem that may be solved by an embodiment of the present invention is making electronic wallets relevant. These electronic wallets such as Apple Pay, Google Wallet, and Amazon Wallet, and many others, are downloaded onto electronic devices. At the moment, they all are merely a convenient way to store information and transact. For this reason, the use of these electronic wallets has not gained significant market acceptance and use. By moving the iPON™ to these wallets, where the customer sees the savings and uses big dollar iPON™s to buy needed merchandise, customer demand for the wallet increases. We envision these wallets not only storing and allowing spending of these iPON™s, but also providing a record of the money saved by the customer when using iPON™s.

Another problem that may be solved by an embodiment of the present invention is the potential for fraud. Unlike credit cards that can be stolen and used anywhere, the iPON™ provides many levels of security that credit cards cannot provide.

First, the iPON™ can only be spent at the merchant that issues the iPON™. It cannot be used everywhere Visa, MasterCard or American Express is accepted. As such, stealing iPON™s is not as attractive as stealing credit cards, as it can only be redeemed by the issuing retailer or manufacturer.

Second, only iPON™ holders that are accepted into the Optimus Advantage systems can spend an iPON™. So third party hackers cannot hack and take an iPON™ and send it to persons unknown.

Third, any transfer or use of an iPON™ will result in both e-mail and a text being sent to the iPON™ holder, and the holder will know immediately if any transfer or use of the iPON™ has transpired. This does not happen with cash or credit cards.

Fourth, both the retailer and the iPON™ Public Key Infrastructure (PM) Certificate of Authority registry will hold information on the iPON™s issued. As only the retailer can authorize and iPON™ to be issued, the Optimus Advantage iPON™ registry cannot be hacked to allow iPON™s to be created. If by chance the hacker was able to access the retailer and create and issue iPON™s, the same hacker would have to also manage to get these iPON™s issued to an account in the iPON™ registry to an iPON™ account holder—a very difficult task.

Fifth, if by some chance, a hacker opened an iPON™ account, and fraudulently stole an iPON™, the iPON™ or account could be frozen immediately more effectively than freezing a credit card and only one retailer needs to know they cannot accept these certain iPON™s, as opposed to a credit card that can be spent anywhere.

Sixth, unlike credit cards, an iPON™ is for a fixed value when issued, and not like a credit card where there is a usually a sizable limit. An iPON™ account for an individual is likely to have many iPON™s of various values. For a hacker or thief to profit, high value iPON™ would be needed. It would be relatively easy for an iPON™ issuer to establish heightened security protocols on iPON™s issued above a certain value or whenever more than one iPON™ is being transferred at one time to one account.

Seventh, a lot of credit card fraud occurs across borders. For an iPON™ to be valid outside the country of issue three events have to be in place. First, the iPON™ holder has to request the iPON™ issuer to re-issue the iPON™ in another currency for use in another country and the iPON™ issuer has to approve this transaction. Second, if the iPON™ holder is not the member to spend the iPON™ in another country, the iPON™ has to be transferred to the member that will spend the iPON™ and this transaction has to be approved, and upon approval the iPON™ holder will be notified. Third, the currency, and consequently the country of issue must have a retailer that will accept the iPON™. For example, it is unlikely that an international hacker gang will be able to spend a Nordstrom iPON™ in the Philippines.

Eighth, if needed, for high-risk transactions, the iPON™ can require a portion, for example 5% of the purchase, has to be made by cash or by credit card. This would limit hackers from using a stolen iPON™ they would have to also have another payment. Theoretically, a hacker could accomplish one of the following: (a) hack into a members account and (b) hack into a members phone or change the phone number and (c) learn the members access code and (d) hack into the members e mail to block any e mails to the member and (e) hack into the retailer to issue an iPON™ then spend the members iPON™ at the retailer before any of this is known. But since these tasks need to be done concurrently, it would be very difficult, if not impossible, for a hacker to execute all of these tasks.

Ninth, the most unique and novel process that will be used to assure security is the methodology that this system uses in applying Public Key Infrastructure(PKI) to redemption of the retailer iPON™. The security of using PKI is known to be a very secure and extremely difficult to overcome. The iPON™ PKI based system will rely upon PKI to prevent fraud.

The novel method the Optimus Advantage Marketplace will use in applying the PKI to manage the registry of the user's iPON™s and to verify the identity of the user, before the user accesses the iPON™ residing in the Retailers iPON™ Database is as follows:

The security will be stronger than most PKI systems because access to the iPON™ is separate from the Retailer's iPON™ Database, and must be done through the security protocol of the Optimus Advantage Market place database and so hacking or breaching the Retailer iPON™ Database will not allow access to a specific iPON™ to transact with the Retailer's iPON™ Database.

Since the identity of the user is a necessary step to redeeming the iPON™ and this identity verification is done on the Optimus Advantage Marketplace Database before access is allowed to the retailer database. If the identity cannot verified by the PKI system, which is be resident on the Optimus Advantage Marketplace Registry, the transaction will be rejected.

By separating the iPON™ credits on one database (the retailers' data base for example) and access to the iPON™ through another database (the Optimus Advantage Marketplace Database or Certificate of Authority for example) the iPON™ that resides in the retailers' database remains very secure and simply hacking into the retailers' database will not allow use of the iPON™.

Tenth, the iPON™ holder can store a photograph of one's self, in their account and for in a physical store purchase this photo can be reviewed by the retailer. This simple application of a photo is an additional layer of security that would be available if a user wished to access this feature. If the iPON™ holder wished, they could also limit this iPON™ from being used online, and mandate it be used in a physical store, or even to a specific location. It is highly unlikely that a thief or hacker would want to attempt to hack into the iPON™ and load the thief's photograph on the iPON™ in order to use the iPON™.

Another problem that may be solved by an embodiment of the present invention is that of retailers co-marketing other retailer's products. Today this is common for grocery stores that own gas stations, and provide a discount on the gas you purchase from grocery store owned gas stations. This has caused other gas station companies to collaborate with grocery stores to offer similar discounts. This requires their computer systems speak to each other. However, for almost all other retailers, tie-ups are not done as there is not easy way to get this accomplished. With the iPON™ technology, and a cloud platform, these tie-ups are simple due to the hosting capability of the cloud servers. Retailers that work together arrange a price for the purchase of the iPON™ between the retailers, and when a retailer agrees to issue an iPON™ to an account holder, then retailer A tells retailer B, who has agreed to sell the iPON™ to retailer A, to issue it to a specific customer. This is a simple solution where every retailer connected to the iPON™ system can participate without developing dedicated computer systems between retailers. The iPON™ becomes the standardized medium of exchange to make this possible.

Another problem that may be solved by an embodiment of the present invention is the restriction on retailer to price at below the manufacturer's established retail prices. Restrictions on pricing discounts established by manufacturers on retailer's pricing exist for many items that limit the retailer's ability to discount the price. This is common for higher priced items, where manufacturers have an interest in supporting the pricing to their distribution base and avoiding degradation of a product's image that might result from low pricing. In this instance, this invention of negotiation and iPON™ issuance for a discount on the next item purchased from the retailer solves this problem as the manufacturer's product is sold within the guideline price and the customer receives a discount in the form of an iPON™ from the retailer for use on another purchase.

Another problem that may be solved by an embodiment of the present invention is communication to the customer. Today retailers use direct mail and e-mail to get to their customers. The e-mail in boxes of many consumers are so full of retailer communication that is becomes burdensome to consumers in many cases. The Negotiator and iPON™ system provides customers and retailers a method to communicate with each other. For example a customer may purchase an iPON™ from a local restaurant. Imbedded in the iPON™ is a feature that allows the reservation of a specific time for a dinner. The iPON™ holder then selects a specific time allowed by the iPON™ and through the iPON™ holder's account, either through the iPON™, the account, or another method specified by the holder, confirms the reservation.

Another problem that may be solved by an embodiment of the present invention is the inherent limitation in customer loyalty reward systems. Today, retailers issue points that allow a cash discount on future purchases which are only useful at the issuing retailer. The iPON™ creates an opportunity for retailers to agree to a retail alliance that would permit the transferability of points, similar to the way partner airlines recognize passenger miles earned among other partner airlines. In this scenario, each of the retail alliance partners could issue an iPON™ with cash value that is equal to the points earned. This iPON™ would be accepted by any of the retailers in the alliance. This creates more value to rewards systems and the iPON™ provides a standard unit of value that all of the retailers in the alliance can recognize and accept.

Another problem that may be solved by an embodiment of the present invention is the cost immigrants must endure to send funds across borders to family and friends. The iPON™ provides a solution whereby it can be issued in another currency for redemption in another country by and iPON™ holder or anyone the iPON™ holder transfers this iPON™ to such as family or friends. The transfer is cost free, and cash is not moved across borders, as it is a discount that is moved across borders, thereby reducing risk of transfer.

Another problem that may be solved by an embodiment of the present invention is giving global brands and retailers easy access to charity auctions to increase their market awareness. Offering the issuing retailers the opportunity to offer an iPON™ for use by a charity auction easily solves this issue.

Another problem that may be solved by an embodiment of the present invention is that today with few exceptions, automobile manufacturers do not sell an automobile directly, yet they can only offer rebates which are contingent on the automobile being sold to a customer. By providing automobile manufacturers access to an iPON™ from many other retailers or global brands, the offers from the manufacturer can be more effective and more creative. Further, this can enhance the value proposition, as the iPON™ purchased from a third party is likely purchased at a discount to face value.

Another problem that may be solved by an embodiment of the present invention is creating the reality of the value of customer loyalty programs. One method of enhancing the value is an iPON™ for a known value, for example $20.00, being issued to a customer, and as purchases are made the value grows from zero to eventually $20.00. Once it hits $20.00, it becomes actionable and the customer can spend it. The customer's account can be viewed on a smartphone or other computer device; the customer will be able to see it grow in value, thereby making the savings more real.

Another problem that may be solved by an embodiment of the present invention is certain business-to-business transactions, where the customer who eventually pays for an item currently has no say in the merchandise offered. This is the case in hospital supplies. Customers today often do not select the brand of wheelchair or crutches. However, these manufacturers can provide an iPON™ to customers and drive choice of final product used.

Another problem that may be solved by an embodiment of the present invention is the inability of retailers to offer a product for sale and adjust the price during the sale. With the iPON™ negotiator, if a price is too low, and for example, the inventory is moving quickly, the negotiator can move the counter price upwards or reduce the iPON™ award to match market conditions.

Another problem that may be solved by an embodiment of the present invention is that physical stores do lose sales to the internet retailers. The iPON™ has the capability to have a variable value and can be set at a higher value if offered in a physical store and a lower value when redeemed online.

Another problem that may be solved by an embodiment of the present invention is high credit card fees that retailers must pay when using a credit card network, such as Visa. The novel invention is that the iPON™ operates on the existing store credit system and other coupons operate on. However, the iPON™ issued to a specific person, and as such, can be pre-sold to the person, and the person can redeem the iPON™ the same as if it were a credit card. As it operates on the retailer's network, there are no credit card fees. The Marketplace software may charge a fee for hosting the security of the transactions, but these can be much less than a credit card fee.

Another problem that may be solved by an embodiment of the present invention is receipt retention. Often, stores require customers bring in receipts for exchanges. The iPON™ is a data file that can retain the receipt for items purchased by the iPON™ once used, even if the iPON™ is fully redeemed.

Another problem that may be solved by an embodiment of the present invention is consumers need to be financially better off. The iPON™ and the negotiation software provides the consumer (a) the ability to negotiate a lower price (b) the ability to sell or trade the iPON™ on the marketplace platform provides liquidity to the consumer's iPON™ (c) once the consumer has and iPON™ in their account better offers from the iPON™ issuer may be forthcoming ad (d) as the iPON™ can be a prepaid instrument, merchants and retailers are expected to offer a discount on the prepaid iPON™ as a prepaid iPON™ provides value to the retailer that includes (i) cash up front (ii) capture of the customers budget and (iii) no credit card fees for redemption.

Historically, there have been a number of issues that have prevented this technology from being developed. They include the following:

Lack of computing speed to handle multiple negotiations in real time. Now the technology exists to permit millions of real-time negotiations.

Lack of cloud computing availability that allows real-time communication between parties. For example, coupon redemption is largely a closed system and a grocery store running on the grocery store's servers. With high-speed cloud computing, all retailers, big and small, manufacturers, and global brands can all communicate and transact with each other.

Issuing coupons to consumers has been a “shot-in-the-dark” approach (e.g., press and Internet advertisements); the coupon issuer never knows who has held them until they were redeemed. If they are redeemed in a cash sale, the issuer will never know who used these coupons. Retailers have been focused on traditional coupons that are not tied to an individual. They have not viewed coupons as valuable items issued to a specific individual as part of a sales negotiation since a platform that stores and issues a coupon (iPON™) to an individual simply has not been available. Now the owner of the iPON™ can be known by the issuer.

Because of credit cards operating on a closed system, these credit cards have been the non-cash agent of payment. Coupons never before could be sold to an individual for redemption at a retailer. Now with the iPON™ operating on a cloud solution and on a closed network, outside the credit card network, an alternative to credit cards is available.

Negotiations on websites have been limited to auction sites such as priceline.com, where a buyer books hotels. The auction sites time out with a winner. This does not work with a retailer that has many of the same items to sell, and the buyer wants to buy immediately, not waiting for an auction to time out. Priceline.com operates differently. To assure a sale, a buyer has to agree to purchase a room in a specific geographic area, at a specific quality rating, without knowledge of the specific hotel until agreeing to pay a certain price. This will not work with retail products where the buyer wishes to know what they are getting.

Coupons have been issued in mass to persons unknown, and often have fixed prices or fixed percentage discounts as today's systems do not allow for more. The iPON™ system is not a fixed coupon, but a living data file that allows offers to be adjusted dynamically with enhancements to influence a consumer. Websites for trading coupons rely on mailing the coupons to customers, and typically these coupons are for small value items.

No individual account systems exist that store coupons by a customer, sorted by manufacturer or retailer, and there is no standardized software methodology for managing a coupon and its characteristics assigned to a single user.

Previous attempts at negotiation systems have been limited to auctions involving the price only. Internet bidding is often a bidding process where you have to buy at the price of your offer (Priceline.com for example) without discussing terms other than price. The proposed system does not force a purchase at the offered price and is not confined solely to price as an iPON™ is offered as well.

Credit for use at a retailer has been limited to physical gift cards. An iPON™ displaces the physical card with a stored value in the holder's database account.

Manufacturers have never had an opportunity to sell discount opportunities to customers, and have limited their promotions to manufacturer coupons. Now with the iPON™, they can expand this discount at the retailer tool, which allows customers to re-sell, exchange or trade these discounts, creating a more powerful marketing channel.

To eliminate comparison-shopping on the Internet, some sites simply say call for price and do not indicate a price. The system provides the retailer another tool to keep the customer and challenge the Internet comparison-shopping.

Cross marketing of non-competing businesses is not commonplace or easy or effective. Often, a retailer, such as an appliance store, might offer a free entrée at a local restaurant, with the purchase of a washer and dryer. The iPON™ retailer network opens up massive possibilities. Buy a vacation package and receive an iPON™ for a clothing store. Buy a car, and chose a $1,000 iPON™ from one of several retailers. Large homebuilders can also offer packages or iPON™s for decorating, furnishing, and dressing up the house.

At the moment retailers do not have the ability to discount on certain lines of products due to pricing guidelines that manufacturers enforce. The iPON™ creates the ability for a retailer to provide a store credit when such products are purchased, effectively rewarding the buyer with a valuable store credit when the retailer cannot discount and item due to a supplier's rules.

At this point in time, retailers have loyalty reward points that operate in a closed system unique to the retailer. There is no methodology to redeem these points at other retailers. The availability of an iPON™ redemption system allows retailers to: (a) convert a customer's points to an iPON™; (b) agree to join and alliance of other retailers to accept iPON™s issued by any member of the alliance; and (c) allow customers to accumulate loyalty points and convert them to an iPON™ redeemable at a number of retailers. The iPON™ system makes this possible.

Coupons of the past were simple and could not allow the customer to provide multiple issuing to a social network for the purpose of sending to others. This would mean an iPON™ holder would have the opportunity for certain iPON™s to re-issue multiple times and become a marketing extension of the iPON™ issuer, be it a retailer or a manufacturer or a global brand.

Today the only options to send funds across borders are through the banking system with complexities and cost. The iPON™ is not cash and can be transferred in the cloud for redemptions across borders. It can be done fee free and the retailer that redeems the iPON™ can establish a favorable exchange rate and other incentives if they wish to incentivize customers to use the retailer's stores for transferring value across borders. This was not possible when retailers were not as global as they are today and when the ability to move secure data through the internet did not exist.

One embodiment of the present invention relates to a marketplace software platform (the “Marketplace”) to enable: (i) the negotiation of a retailer item(s) price; (ii) the issuance of an electronic discount or intelligent coupon (the “iPON™”); and (iii) the storage and updating of such iPON™s in real time. The software platform permits: (i) the application of such iPON™s towards future purchases; (ii) the management of the sales and trading of iPON™ rewards; (iii) the acquisition of iPON™s by a third party from an issuer and their further conveyance to enhance the third party's offer in a consumer negotiation; and (iv) the management of the purchase, transfer, and redemption of the iPON™. The iPON™ is a data file that represents and retains the terms and conditions of an issuer discount or credit that is purchased by or transferred and/or awarded to a discrete user. The iPON™ is a data file that contains other pertinent information that provides the capability for security and additional functionality of the iPON™.

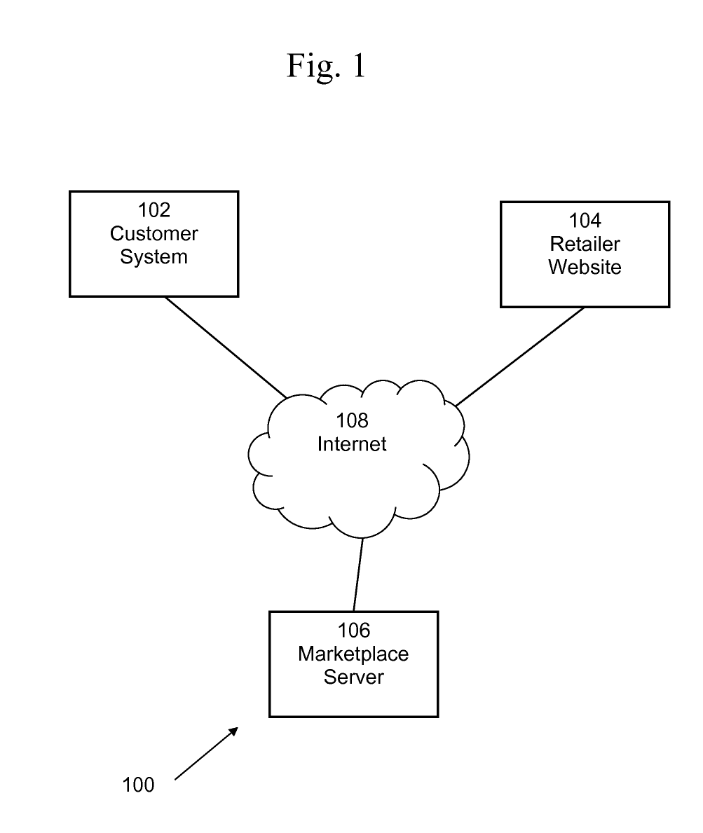

An exemplary embodiment of a system 100 in which embodiments of the present invention may be implemented is shown in FIG. 1. System 100 includes customer system 102, retailer website 104, marketplace server 106, and Internet 108. Customer system 102 may be a fixed computer system, such as a desktop personal computer, a laptop personal computer, a workstation, etc., or a mobile device, such as a smartphone, tablet, etc. Retailer website 104 may be a server computer system, or network of server computer systems, that include software to implement a retailer shopping experience functionality. Marketplace server 106 may be a server computer system, or network of server computer systems, that include software to implement a marketplace experience functionality. Internet 108, which may include public, private, and/or proprietary network segments, provides communications connectivity among customer system 102, retailer website 104, and marketplace server 106.

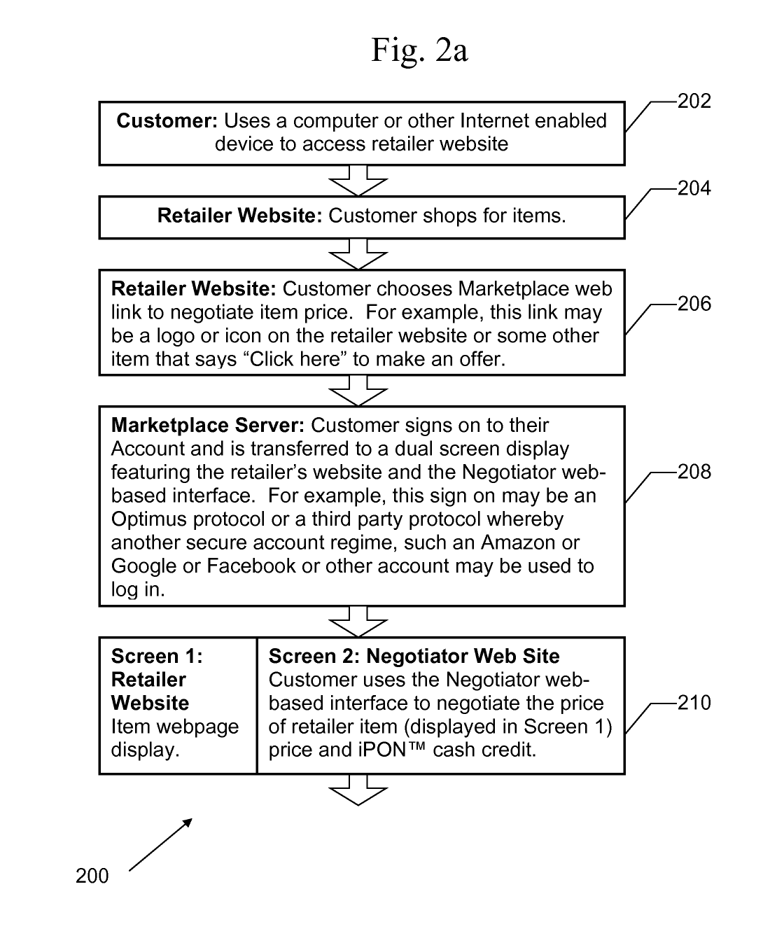

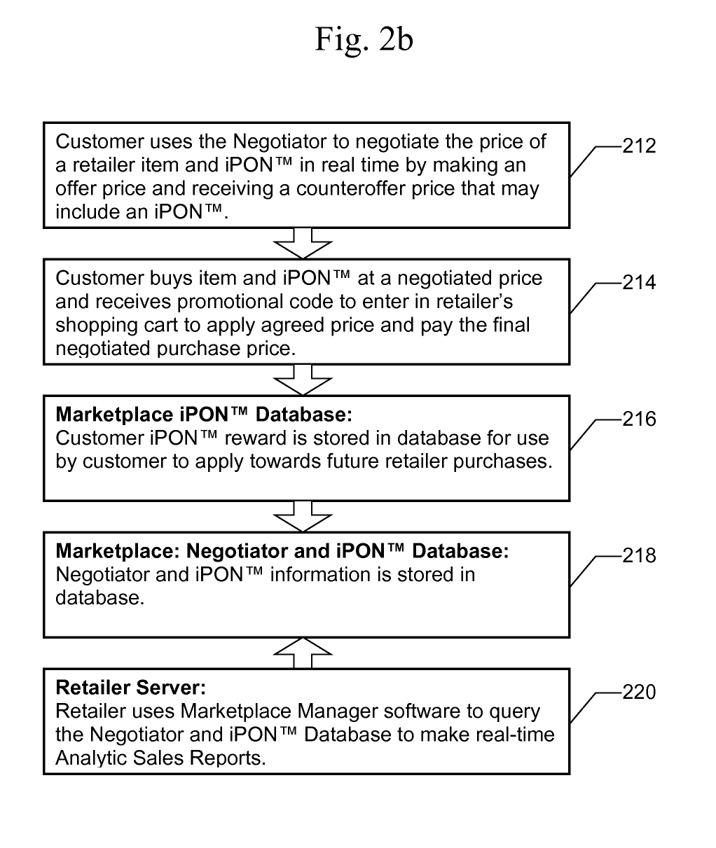

An exemplary general description of the operation of a marketplace system according to an embodiment of the present invention is shown in FIG. 2. As shown in block 202, a customer uses a computer or other Internet enabled device to access a retailer website. In block 204, the customer shops for items at the retailer website. In block 206, the customer, while shopping for items at the retailer website, chooses the Marketplace web link to negotiate the price of a selected item. For example, this link may be a logo or icon on the retailer website or some other item that says “Click here” to make an offer.

In block 208, the customer signs on to their Account on the marketplace server and may be transferred to a dual screen display 210 featuring the retailer's website and the Negotiator web-based interface. For example, this sign on may be an Optimus protocol or a third party protocol whereby another secure account regime, such an Amazon or Google or Facebook or other account may be used to log in. In block 212, the customer uses the Negotiator web-based interface to negotiate the price of a retailer item and iPON™ in real time by making an offer price and receiving a counteroffer price that may include an iPON™. In block 214, the customer buys the item and iPON™ at a negotiated price and receives a promotional code to enter in the retailer's shopping cart to apply the agreed price and pay the final negotiated purchase price.

In block 216, the customer iPON™ reward is stored in the Marketplace iPON™ database for use by the customer to apply towards future retailer purchases. In block 218, Negotiator and iPON™ information is stored in the Marketplace: Negotiator and iPON™ database. In block 220, the retailer uses the Marketplace Manager software to query the Negotiator and iPON™ Database to create real-time Analytic Sales Reports.

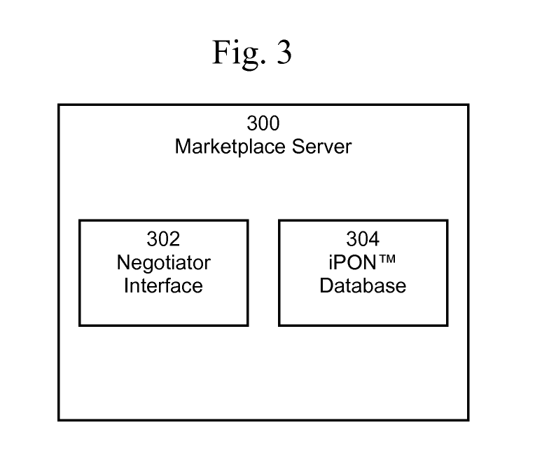

An exemplary block diagram of a Marketplace Server system 300, is shown in FIG. 3. Marketplace Server system 300 may include components such as a Negotiator interface 302 and iPON™ database 304. In one embodiment, Marketplace Server system 300 may include a computer program written in a software programming language. In one embodiment, the method operates on two or more separate computer servers that communicate with each other. One advantage of the exemplary system is that the retailer sales website is hosted on one server while the Marketplace operates on another server. Each server interfaces with the other for specific tasks. In another embodiment, however, both the retailer sales website and the Marketplace could be hosted on one server if the retailer desires a single platform. Additionally the services do not need to be on a dedicated server, but can be hosted on a cloud solution. In such a case the communication between the functional areas described in this patent application would remain substantially the same as if there were two separate servers or if the software were to be hosted in a cloud solution.

An artificial intelligence based interface may use rule based programming to respond to specific customer input with specific counteroffers in real time (Negotiator Interface 302). The Negotiator Interface may be used by retail customers to negotiate retailer item price and potentially offer an iPON™. An iPON™ is an “intelligent coupon” having cash or retailer store credit value. Intelligent means the information contained in the iPON™ can be altered by the retailer after issuance to incentivize the holder to use the iPON™ in the future after issuance. One example of this would be to increase the value of the iPON™ from $10 to $15. Another example would to increase the value on the iPON™ if it is used in a physical store as opposed to redeeming on line. This example may be used to incentivize the iPON™ holder to visit the physical store to redeem the iPON™.

In one embodiment, iPON™ Database 304 may store iPON™ cash or retailer reward credit and also manages the iPON™ transactions. Such transactions may include the storage of the iPON™, the issuance of the iPON™, a purchase of an iPON™, the sale of an iPON™, any changes in value or characteristics of the iPON™s, an interface with customers who hold and use the iPON™s on their computers and/or mobile devices, and the trading of iPON™s with other members.

In one embodiment, the customer iPON™ may be stored in the iPON™ Database 304, permitting the customer to access and manage iPON™ account. iPON™ credit can be applied towards purchase in the retailer website shopping cart or at a store location by displaying the iPON™ promotional code number on a smartphone/tablet at the point of sale (“POS”). The iPON™ code may be transferred to the POS device through scanning a graphic display, such as a QR code.

In one embodiment, the iPON™ that is stored in iPON™ Database 304 includes a number of database fields that contain information exchanged between the retailer and the customer and these iPON™ fields, containing appropriate information and logic rules, are actionable and perform certain functions when activated by the iPON™ issuer to allow these functions to execute.

The database fields describe the contents of the iPON™ database record. In one embodiment, these database fields may be updated by the retailer or customer, based upon authorization, managed and secured by the Optimus Advantage Marketplace using a Public Key Infrastructure or another method of assuring security. The iPON™ database record may be updated in a transaction with the database over a telecommunications network such as the Internet or cell phone network.

In one embodiment, the iPON™ may include features such as those described below. This embodiment may provide the capability to update the information stored in the database record, essentially updating an electronic coupon (the iPON™) after it issues, interacting with the iPON™, and both receiving and sending information to the iPON™. The retailer or customer can update the information. The iPON™ can be constantly updated based upon the communication between the retailer and the customer. In use, the iPON™ database records, stores, updates and interacts with information concerning the various parameters as described in the database fields below.

In one embodiment, the iPON™ may include features has several fields that primarily make the iPON™ work as a coupon. Such fields may include:

An iPON™ Issuer Code identifying the issuer and [for most coupons of any type the issuer is where it can be used].

A retailer ID (Identifying where the iPON™ can be redeemed). Unique for the iPON™ as this could be not only the issuing retailer, but any retailer that can redeem the iPON™ as a credit against that retailer. Typically, although current manufacturer's coupons may be redeemed at a number of retailers, conventional retailer's coupons are not set up for other retailer acceptance.

Customer ID—who owns the iPON™. This field provides the capability for the iPON™ to be transferred and a new owner defined, to keep a record of the new owner, and to consolidate a user's coupons in one account. This field further provides the capability for returns to the store will not be able to reimburse the iPON™ to the consumer.

The iPON™ value field indicated the current value of the iPON™, which may initially be zero. A zero value iPON™ may be issued, with the value to be set at a later date.

Currency—this value field allows conversion to another currency.

iPON™ ID. Each iPON™ has a unique identifier, the iPON™ ID.

A co-Marketing feature, which may be separate field that allows a co-marketer to issue the iPON™ or be imbedded in the iPON™ issuer code as described below.

In one embodiment, features may include the e-mail address of the iPON™ owner as part of the security function, the phone number of the iPON™ owner as part of the security function alone or with text communication or voice communication, and a currency exchange feature allows cross border use of the iPON™.

In one embodiment, features may include in the retailer ID there is additional information, such as that used for the Co-Marketing function and where can be used capability. For example, The iPON™ Issuer code (1) creates a technological solution to identify the iPON™ issuer and (2) may or may not define where the iPON™ can be redeemed and (3) allows co-marketing and acceptance from other merchants that are authorized by Issuer to accept the iPON™. The Issuer code allows one merchant to issue the iPON™ and in one configuration, controls which merchants can redeem the iPON™. This feature is valuable in several ways: (a) In one application, it can be for allowing a manufacture issue an iPON™ and specify which retailers are setup for acceptance when used in tandem with the retailer ID. (b) In another configuration, it can be an identifier for a co-marketing partner [retailer A] to issue and iPON™ that is a store credit redeemable for retailer A. In this manner the code not only identifies the retailer that will honor the iPON™ but also allows a co-marketing partner to issue this iPON™.

Co-Marketing may be implemented in or using a number of iPON™ database fields, such as: the iPON™ issuer code; the Retailer ID, the iPON™ ID to allow use at one or more merchants, and/or the iPON™ value, or other fields.

In one embodiment, features may include a new offer field to allow the retailer to enhance the offer. Note, this can be done in either (a) the new offer field or (b) implied in the value field. The new offer field may be more than a value adjustment, it include, for example, an additional offer such as a higher value for different merchandise. The iPON™ variable value may be a subset of this new offer field. There may be a field indicated the “allowance to be transferred” of the iPON™. There may be a re-issue code to allow the iPON™ to be reissued multiple times and a second set the make the iPON™ more valuable. The re-issue code may be a subset of allowance to be transferred. This second set allows the trading. There may be a resale price field, to facilitate the sale of the iPON™. Other fields may provide the ability to be used as a loyalty incentive to replace or augment existing loyalty programs.

In one embodiment, features may include security features. For example, security features may include a combination credit/debit card account, a current transaction and any or all iPON™ field information and registering it in a cryptocurrency blockchain ledger system. By integrating into transactions a cryptocurrency blockchain ledger system, high security is established. This means any data transferred is secure. The iPON™ transaction may be in concert with a credit card payment, and both the payment and the iPON™ transaction may be secured in the crypto-currency blockchain.

Unique customer identifiers may be used to enhance security. For example, iPON™ database fields may include a Face Biometric that when used, pops up for a store clerk to verify; a customer email address to email use changes to an email to a customer; a customer name so when used in a store, can then ascertain the ID of the user.

In one embodiment, features may include marketing features. For example, video and audio may be attached to an as part of a promotional offer or other information for the user; one or more fields, such as Time Option, Time Expiration, and Term of Validity fields, may allow options—pay a small fee for an option to buy something at a discount later; the ability to make an offer for a lower price in real time, and iPON™ value variable—allows more value depending on either where used (see customer location) or if balance of payment is cash, check or credit; and a use code—specifies products that the iPON™ can be used for.

Examples of iPON™ database fields may include:

| Database Field: | Field Example | Unique Capability | Description |
|---|---|---|---|
| iPON ™ Issuer | 37Z35U5Y27 | A code identifying | The iPON ™ Issuer |
| code | | the iPON ™ issuer. | code (1) creates a |
| | | Specific codes allow | technological solution |
| | | retail merchants to | to identify the |
| | | accept and redeem | iPON ™ issuer and (2) |
| | | this iPON ™ only if | may or may not define |
| | | the Issuer allows it. | where the iPON can |
| | | If issuer is not the | be redeemed and (3) |
| | | redeeming merchant, | allows co-marketing |
| | | such as may be the | and acceptance from |
| | | case in a co- | other merchants that |
| | | marketing | are authorized by |
| | | application, the | Issuer to accept the |
| | | iPON ™ Issuer code is | iPON ™. The Issuer |
| | | used to identify the | code allows one |
| | | issuer. | merchant to issue the |
| | | | iPON ™ and in one |
| | | | configuration, |
| | | | controls which |
| | | | merchants can redeem |
| | | | the iPON ™. This |
| | | | feature is valuable in |
| | | | several ways: (a) In |
| | | | one application, it can |
| | | | be for allowing a |
| | | | manufacture issue an |
| | | | iPON ™ and specify |
| | | | which retailers are |
| | | | setup for acceptance |
| | | | when used in tandem |
| | | | with the retailer ID. |
| | | | (b) In another |
| | | | configuration, it can |
| | | | be an identifier for a |
| | | | co-marketing partner |
| | | | [retailer A] to issue |
| | | | and iPON ™ that is a |
| | | | store credit |
| | | | redeemable for |
| | | | retailer A. In this |
| | | | manner the code not |
| | | | only identifies the |
| | | | retailer that will honor |
| | | | the iPON ™ but also |
| | | | allows a co-marketing |
| | | | partner to issue this |
| | | | iPON ™ |
| Retailer ID: | 4820087 | The Retailer ID | A Retailer ID controls |
| | | defines where the | where the iPON ™ |
| | | iPON ™ can be | can be redeemed. For |
| | | redeemed. For | instance, the Retailer |
| | | example, a retailer | ID may designate that |
| | | may have several ID's | the iPON ™ can only |
| | | and each is specific as | be redeemed at online |
| | | to where the iPON ™ | merchants. Another |
| | | can be redeemed. | Retailer ID may |
| | | | designate the iPON ™ |
| | | | can be redeemed only |
| | | | in store. The retailer |
| | | | can dynamically |
| | | | change the Retailer ID |
| | | | anytime after the |
| | | | issuance of the |
| | | | iPON ™. Further, in |
| | | | co-marketing, and |
| | | | retailer (a) may wish |
| | | | to allow the iPON ™ |
| | | | to be redeemed at |
| | | | retailer (b). The |
| | | | Retailer ID may also |
| | | | have a code that |
| | | | allows for this |
| | | | capability. |
| Customer ID: | 72A64788E | A unique customer | The history of all |
| | | ID code assigned to | iPON ™ owners will |
| | | the current owner of | be available in the |
| | | the iPON ™. If the | Customer ID field of |
| | | owner of the iPON ™ | the iPON ™. For |
| | | transfers or sells the | example, if someone |
| | | iPON ™, the old | tried to steal the |
| | | Customer ID remains | iPON ™ and was able |
| | | with the iPON ™ and | to defeat the security |
| | | a new Customer ID is | of the database |
| | | added to the iPON ™ | system, the iPON ™ |
| | | and associated with | would be able to be |
| | | the new owner. | rendered inactive, if |
| | | | the current owner |
| | | | reported it as stolen, |
| | | | even if a new ID was |
| | | | registered at the |
| | | | current iPON ™ |
| | | | holder. |
| Face Biometric | A photograph of the | The iPON ™ can hold | The iPON ™ holding |
| | iPON ™ owner or other | a photograph of the | the photograph of the |
| | biometric identity | user or other bio- | current owner, |
| | | metric identity. | allowing for facial |
| | | | recognition of the |
| | | | iPON ™ holder for |
| | | | security. Can be |
| | | | added to the iPON ™ |
| | | | when issued or when |
| | | | redeemed. Knowing |
| | | | that when an iPON ™ |
| | | | is redeemed, and a |
| | | | photograph may be |
| | | | taken and be a |
| | | | permanent record on |
| | | | the iPON ™, will deter |
| | | | illegal use or theft. |
| iPON ™ ID: | 262555 | The iPON ™ | The iPON ™ issuer or |
| | | identification number | company that is |
| | | is unique to a specific | authorized to redeem |
| | | iPON ™. | an iPON ™ will be |
| | | | able to refer to the |
| | | | iPON ™ ID. The |
| | | | iPON ™ issuer will |
| | | | always know the |
| | | | customer ID |
| | | | associated with the |
| | | | iPON ™ ID. This |
| | | | synchronicity between |
| | | | the iPON ™ ID and |
| | | | Customer ID will |
| | | | allow specific offers |
| | | | to be made to the |
| | | | iPON ™ for that |
| | | | specific user. |
| | | | Included in this ID |
| | | | can be the ability to |
| | | | use at one or more |
| | | | merchants. |
| Amount Paid for | $30 | Records not only the | Allows Merchant to |
| iPON ™ | | remuneration to | see the history of an |
| | | acquire the iPON ™, | iPON ™ selling prices |
| | | but allows recording | as it is re-sold and |
| | | of prices that were | gives the merchant the |
| | | paid for the transfer | data that can be used |
| | | of the iPON ™ to | to process offers and |
| | | another and facilitates | sales of future |
| | | a sale of the iPON ™. | iPON ™s. |
| iPON ™ Value | $50.00 | The iPON ™ value is | This data field (a) |
| | | the current value on | establishes the value |
| | | the iPON ™. This | of the iPON ™ and (b) |
| | | field (a) establishes | allows the issuer to |
| | | the value of the | transfer or redeem the |
| | | iPON ™ and (b) | iPON ™ in another |
| | | permits the iPON ™ | currency such as |
| | | conversion of the | converting USD to |
| | | iPON ™ currency into | Euro, based on the |
| | | another currency, | currency exchange |
| | | based on the | rate. Also, included |
| | | conversion rate at | in this field can be the |
| | | time of conversion, | other merchants that |
| | | e.g. - USD to Yen. | can accept this |
| | | | iPON ™. |
| iPON ™ value - | $50 | The iPON ™ value is | The feature is that |
| Variable | | the current value on | based on many |
| | | the iPON ™. This | metrics, including |
| | | value can be | where redeemed, the |
| | | increased with | value can be higher to |
| | | incentives. For | incentivize shoppers |
| | | example: | going to particular |
| | | $50 if used on Line. | location. Can also be |
| | | $55 is used in a | variable value |
| | | physical store. | depending on what is |
| | | $60 is used on a | purchased. |
| | | discount store. | |
| iPON ™ Re-Issue | R 3 3 | R 3 3 is an example | The re-issue feature |
| code | | of a code that would | allows consumers to |
| | | allow holder to re- | re-issue the iPON ™ to |
| | | issue to friends and | friends within the |
| | | family. As an | limits of the issuer's |
| | | example R means re- | conditions. |
| | | issue, “3” means re- | |
| | | issue 3 times, the 3 | |
| | | again means who | |
| | | receives the re-issue | |
| | | can also re-issue 3 | |
| | | times. | |
| iPON ™ Use Code | Apple Computer | Limits the type of | iPON ™ use is now |
| | | item that can be | restricted to the |
| | | purchased with the | purchase of specific |
| | | iPON ™. Can be | products or services. |
| | | changed by the | |
| | | retailer for broader | |
| | | use after the iPON ™ | |
| | | is issued. For | |
| | | example, iPON ™ | |
| | | Use Code: “Apple | |
| | | Computer” can be | |
| | | used to only discount | |
| | | purchase of an Apple | |
| | | Computer. | |
| Allowance to be | | Can be assigned to a | The usefulness of this |
| transferred field. | | person and only that | is for the multiple |
| | | person can use it or | transfer and copy |
| | | can be allowed to be | options as it limits |
| | | traded, transferred to | eventually how many |
| | | sold. | times and iPON ™ can |
| | | | be transferred or |
| | | | copies. As a security |
| | | | feature, the owner can |
| | | | set this as no transfer |
| | | | and it can never be |
| | | | transferred from that |
| | | | owner. |
| Time Option Field | 30% off two soup | The iPON ™ is | The feature is that the |
| | entrees for 2 days | purchased as an | iPON ™ can be |
| | | option to discount a | purchased as an |
| | | purchase within a | option to buy |
| | | certain time period. | something at a |
| | | After the time period | discount. Using the |
| | | expires the option | term for expiration, |
| | | expires. | the option can expire. |
| | | | If expired, the |
| | | | customer can contact |
| | | | the issuer to extend |
| | | | the option or the |
| | | | issuer can contact the |
| | | | iPON ™ holder to see |
| | | | if they wish to renew. |
| iPON ™ time | Your iPON ™ option | Notices can be sent to | Not only is the option |
| option expiration. | will expire in 3 days. | an iPON ™ holder | expiration novel, the |
| | Renew your option for | and they can renew | iPON ™ can notice the |
| | $2.00 for an additional | the option. | iPON ™ holder of |
| | 90 days | | imminent expiration |
| | | | and the iPON ™ |
| | | | holder can click on a |
| | | | computer device |
| | | | screen display to |
| | | | extend the iPON ™ |
| | | | expiration time |
| | | | period. |
| Term of Validity | Jun. 1, 2015-Aug. | Can be date specific | The iPON ™ has a |
| | 30, 2015. | or elapsed time | term of validity. The |
| | | period from iPON ™ | feature is the iPON ™ |
| | | issuance. | issuer can update the |
| | | | Term of Validity by |
| | | | updating the iPON ™ |
| | | | database record. |
| iPON ™ New Offer | Your iPON ™ is worth | The iPON ™ value | The iPON ™ offer |
| Field | 10% more if used before | can be enhanced. An | value will feature real |
| | a specific date. | offer can be increased | time updates of |
| | | value, can be worth | advertising and |
| | | more for if a specific | promotion. Updates |
| | | item is purchased. | are made by changing |
| | | | the value of the |
| | | | IPON ™ New Offer |
| | | | field in the database. |
| iPON ™ as a | Issuer sends an iPON ™ | iPON ™ is not | The feature is that the |
| loyalty incentive | to a customer and it has | actionable in a | iPON ™ is viewable as |
| | a face value of $200. | purchase until the | $200 not available, |
| | | customer spends $200 | and as the customer |
| | | at that particular | spends, using their |
| | | store. | loyalty account they |
| | | | can see this iPON ™ |
| | | | growing in value. |
| | | | Once $200 is spent |
| | | | the iPON ™ becomes |
| | | | available. |
| iPON ™ and item | men's blue cotton shirt | As an iPON ™ is | The list of all items |
| purchased. | | redeemed, the | purchased will be |
| | | merchandise | maintained as a |
| | | purchased is recorded | permanent record in |
| | | in the iPON ™ record. | the iPON ™ record. |
| | | | The retailer will be |
| | | | able to access the |
| | | | iPON ™ Items sold |
| | | | record allowing the |
| | | | retailer to customize |
| | | | offers for the iPON ™ |
| | | | holder. |
| Item SKU: | 37287622 | When at iPON ™ is | Facilitates issuer to |
| | | used for a purchase, | easily search the |
| | | the item SKU is | iPON ™ record to |
| | | recorded. | process all item SKU |
| | | | information. |
| Item QR code: | bitmapped QR graphic | Allows iPON ™ to be | The feature is that |
| | file associated with | easily read at a point | when the QR code is |
| | iPON ™ database record | of sale. Allows | presented, the |
| | | merchants to access | Merchant will see a |
| | | key information at the | photo and name of the |
| | | point of sale device. | iPON ™ redeemer, or |
| | | | other unique items. |
| | | | This will enhance |
| | | | security. No coupon |
| | | | can do this today. |
| Item Receipt | Record of Purchase | The receipt of the | Allows ease of returns |
| | | purchased item will | and paper receipts are |
| | | become a permanent | no longer needed. |
| | | record in the iPON ™ | Will also refund the |
| | | record. | iPON ™ value to the |
| | | | iPON ™ holder's |
| | | | account when the |
| | | | return is made. No |
| | | | other coupon dies this |
| | | | today. |
| Item Text: | text file describing item - | When a purchase is | Item description will |
| | e.g. - blueshirttxt.doc | made the description | be available to the |
| | | of the item is stored | customer and retailer. |
| | | in the iPON ™ record. | |
| Item Video: | Video file describing | Allows customers and | The iPON ™ is a |
| | item - e.g.- | retailers to have a | platform for video |
| | blueshirtvideo.mp4 | visual record of the | advertising or other |
| | | item for sale. Video | video information on |
| | | contains an | items purchased by |
| | | advertisement of the | with the iPON ™. |
| | | item and featuring | |
| | | instructions for use | |
| | | after purchase. | |
| Item Audio: | Audio file describing | Allows customers and | The iPON ™ is a |
| | item - e.g. - | retailers to have an | platform for audio |
| | blueshirtaudio.mp3 | audio record of the | advertising or other |
| | | item for sale. Audio | video information on |
| | | contains an | items purchased by |
| | | advertisement of the | with the iPON ™. |
| | | item featuring and | |
| | | instructions for use | |
| | | after purchase. | |
| Customer Name: | John Hutchison | Assigns iPON ™ | Name is on the |
| | | owners name to the | iPON ™, and hidden |
| | | iPON ™ | until used. If used at |
| | | | that point of sale, the |
| | | | name will be |
| | | | displayed to the |
| | | | retailer when the QR |
| | | | code is presented and |
| | | | sales clerk can verify |
| | | | person by asking for |
| | | | ID. This prevents a |
| | | | thief from stealing the |
| | | | iPON ™, because they |
| | | | cannot verify the |
| | | | name of the iPON ™ |
| | | | owner at the retailer |
| | | | POS. |
| iPON ™ email, | jhutchison@gmail.com | iPON ™ owner's | The iPON ™ issuer |
| text, or voice call | 847-902-2287 | email and phone | can send a broadcast |
| message | | number account. | or targeted email, text, |
| communication. | | | or voicemail message |
| | | | to the iPON ™ owner |
| | | | to notify them of new |
| | | | sales, expiration date, |
| | | | increased iPONTM |
| | | | value etc. |
| Customer | Latitude: 43 54 23 - | Location of iPON ™ | Informs iPON ™ |
| Location: | Longitude: 43 10 19 | holder | holder validity of their |
| | | | iPON ™ when near a |
| | | | merchant that will |
| | | | accept the iPON ™. |
| | | | The value of the |
| | | | iPON ™ can be made |
| | | | to increase, as the |
| | | | iPON ™ is closer to |
| | | | the issuer. This |
| | | | encourages in store |
| | | | redemption of the |
| | | | iPON ™ compared to |
| | | | online iPON ™ |
| | | | redemption. |
| Payment method | $20.00 if paid in cash. | The payment method | When the item is |
| | $20.50 if paid by debit | influences the price | purchased with the |
| | card or check. | of the item. | iPON ™, a price |
| | $21.00 if paid by credit | | calculation is |
| | card. | | automatically made |
| | | | based upon the |
| | | | method of payment |
| | | | for value in excess of |
| | | | iPON ™ value. |
| Customer | Item price: $20 | When using a | Retailer can read |
| negotiable | If paid with cash and an | negotiable iPON ™ | iPON ™ and see price |
| iPON ™ | iPON ™, the customer | combined with a | offered and decide to |
| | could offer to pay | payment, the | accept the iPON ™ |
| | $18.00 | customer can include | negotiated offer. |
| | | a discount value of | |
| | | the iPON ™. | |
| iPON ™ Language | Source language of | Enables translation of | Permits the iPON ™ |
| translation | iPON ™ sender, e.g. - | text and voice of | issuer and customer to |
| | English to Spanish | communication | communicate in real |
| | | between iPON ™ | time using |
| | | issuer and iPON ™ | commercially |
| | | owner | available software to |
| | | | translate text and |
| | | | voice. |
| Cryptocurrency | Convert: | Cryptocurrency and | This iPON ™ claim |
| Conversion | USD/Bitcoin | central banking | registers the iPON ™ |
| | Bitcoin/USD | currencies are | owner and buyer |
| | | converted in real time | information in the |
| | | based on currency | cryptocurrency |
| | | conversion daily | blockchain serving as |
| | | exchange rate and | an official record of |
| | | registered in the | the currency |
| | | cryptocurrency | conversion |
| | | blockchain. | transaction. Used for |
| | | | non-repudiation of |
| | | | exchange purposes. |
| Combination | Credit/debit card: 5635- | Capable of combining | Combination of |
| credit/debit card | 2827-2987-2987 | any or all unique | credit/debit card |
| account, current | Any and all iPON ™ | iPON ™ field | account information |
| transaction and any | information fields such | information with the | and the current |
| or all iPON ™ field | as: | credit/debit card | transaction |
| information and | 1. Face Bio-Metric | account and | information with any |
| registering it in a | 2. Item Video | transaction | or all iPON ™ field |
| cryptocurrency | 3. Item Audio | information. | information and |
| blockchain ledger | 4. Customer Location | | registering it in a |
| system. | 5. Customer negotiable | | cryptocurrency |
| | 6. Language translation | | blockchain ledger |
| | 7. Cryptocurrency | | system. |
| | Conversion | | |
| | 8. Combination of | | |
| | credit/debit card | | |
| | information with | | |
| | iPON ™ information. | | |

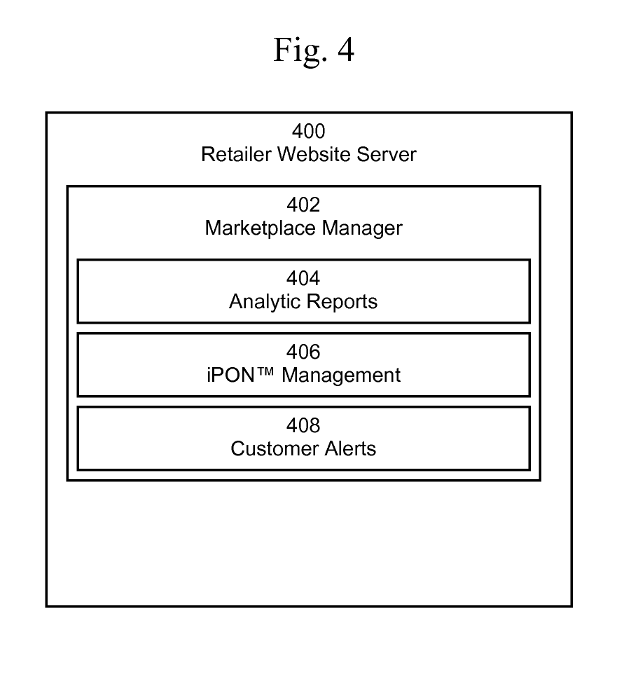

An exemplary block diagram of a Retailer Website Server 400 is shown in FIG. 4. Retailer Website Server 400 may include components such as a Marketplace Manager 402. Marketplace Manager 402 may include components such as Analytic Reports component 404, iPON™ Management 406, and Customer Alerts 408. For example, Analytic Reports component 404 may provide reports on and analysis of customer data for intelligent marketing. iPON™ Management 406 may provide the capability to create immediate retailer sales events, including the issuance of an iPON™ to a customer or commercial partner. In concert with the Marketplace Manger, it accepts an iPON™ when a purchase is made as part of the payment, and adjusts the value of an iPON™ when the full value of the iPON™ is not redeemed. iPON™ Management 406 may provide tools for the retailer to communicate with each iPON™ or iPON™ holder and may communicate with the Marketplace Server system 300 to assure that the accounts and transactions are in sync. Customer Alerts 408 may enable a retailer to communicate with customer by text or email or other method such as to the customer's iPON™ account.

For example, Analytic Reports component 404 may provide information on customer sales such as:
Who is buying?
What was the negotiated price?
When was the item sold?
Where is the customer located?

Likewise, Analytic Reports component 404 may provide optimal selling price based on:
What are the most popular items sold?
What items yielded the highest profit margin?
What item quantity needs to be sold to realize maximum profit?

In one embodiment, retailers may use the Analytic Sales Report software, which may be included in Analytic Reports component 404, to query the iPON™ Information Database for negotiation sales and iPON™ information in real time. The Analytic Sales Report software may produce real-time reports containing information about item sales and the associated iPON™ For instance, a query of the iPON™ Database could be made by asking “how many blue wool sweaters were sold within the last minute nationwide?” and receiving the answer up to the minute.

For example, iPON™ Management 406 may be used to manage the iPON™ account and corresponding customer iPON™ information. It may also manage iPON™ receipts. Every time a purchase is made, a virtual receipt may be generated and put in the customer's iPON™ account in the iPON™ database. Every time an iPON™ is redeemed, a receipt may be put in the iPON™ customer account that the iPON™ has been redeemed. The iPON™ is a dynamic file that may, for example, provide the following:
iPON™ value can be dynamically changed: e.g.—from $10 to $15.
iPON™ can be applied to a specific item.: e.g.—women's shoes
iPON™ is cancelled after redemption by customer, or the value is adjusted if the full amount is not redeemed.
iPON™ can create a variety of sales events.
iPON™ can be sold or transferred to another account in the Optimus Advantage
Exemplary Marketplace Computer Server and recorded in the Customer Account.

For example, Customer Alerts 408 may be used to enable retailers to communicate with customers by text or email. For example, Customer Alerts 408 may be used to
Contact customers by email or text.
Notify customer about new items of possible interest.
Build personal customer relationship coordinated with buying patterns.
Customer alerts may go to the iPON™ holder's iPON™ account instead of email, or be attached to the specific iPON™ in the event the iPON™ issuer wishes to communicate a specific offer to a specific iPON™.

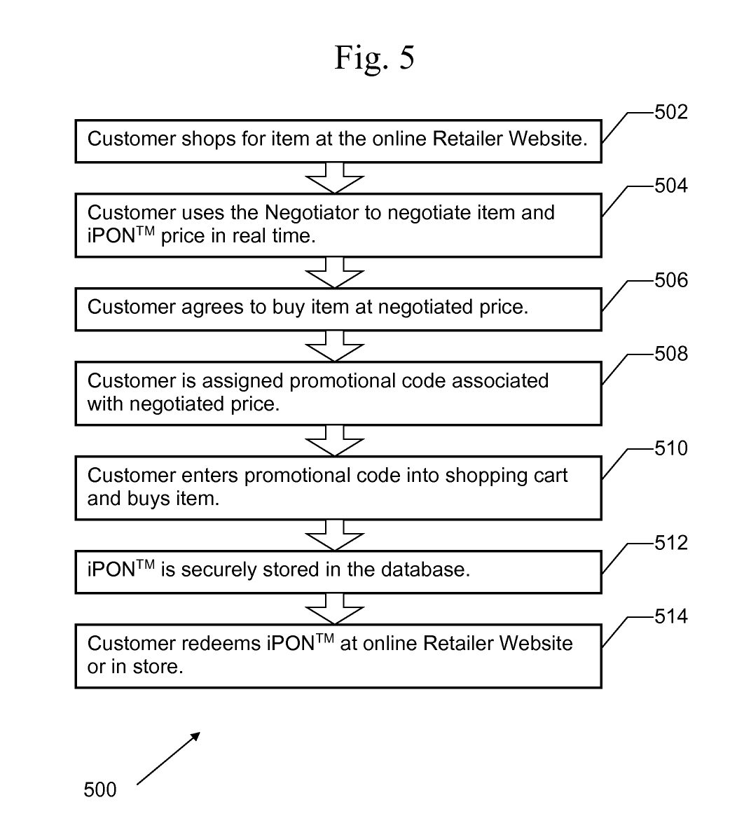

An example of one embodiment of operation of the Marketplace system 500 is shown in FIG. 5. In one embodiment, in block 502, the customer may use a telecommunications device, such as a computer, pad, or smart phone, connected to a data network, e.g., a telecommunications network, such as the Internet, cellphone, or wireless data network. The customer may access the retailer website and shop for an item of interest. Personal sign-on information may be used to establish an Optimus Advantage account and as an alternative to Optimus Advantage account information, the customer may also log into a Google, Facebook, Amazon or other account information as the system can be designed to accept this other method. A system account—called the Optimus Advantage account—is designed to store iPON™s and allow the customer to receive, store, transfer, or redeem an iPON™.

In block 504, a customer interested in negotiating the item price and an iPON™ cash credit can click on the Negotiator web link to access the Negotiator Interface. The customer may be transferred to the Marketplace website and use the Negotiator Interface, featuring a dual screen (or “screen within a screen”) display of the retailer website simultaneously beside the Negotiator Interface. This dual screen or other multiple screen display permits the customer to interact with the retailer website and use the Negotiator Interface to negotiate the item price. The customer may begin the negotiation by entering information displayed at the retailer website into the Negotiator Interface or clicking on the item to be purchased. Item(s) information such as: item name, SKU, and price are entered. The customer then enters login information such as email address and phone number, and/or an account number. The customer may enter the current item price and an offering price.

The Negotiator may immediately respond back to the customer with a counteroffer price and if the retailer elects, an iPON™ cash credit towards future purchases. The customer continues to negotiate a new price offer and the Negotiator counteroffers with a different item price and iPON™ cash credit or reward. The counteroffer criteria may be determined by the retailer and pre-programmed into the Negotiator Interface. This process continues between the customer and the Negotiator until, in block 506, the customer agrees to buy the item and iPON™ counteroffer. During this process, the Negotiator may counteroffer with a variety of combinations of price and iPON™ credits. The Negotiator software defines the parameters regarding responding to each customer offer, such parameters being set by the retailer for each item. For example, such parameters may include:

1. The geographic location of the customer derived from a correlation with an ISP. For instance, if a negotiating customer lives in New York City, they would be associated with a higher income bracket and thus able to afford a higher price, compared to a person living in a lower income bracket location. This parameter uses a counteroffer rule that makes a lesser incremental counteroffer of $2, compared to a customer located in a lower income bracket area, which would make an incremental counteroffer $5. The correlation is that a person located in a higher income bracket can afford to pay a higher price.

2. The type of computer used. There is a correlation between Apple computer users and PC users. Typically, Apple users are in a higher income bracket. This parameter uses a counteroffer rule that makes a lesser incremental counteroffer of $2 to an Apple computer user, compared to a customer using a PC and correlated with being in a lower income bracket area, which would make an incremental counteroffer $5. The correlation is that a person located in a higher income bracket can afford to pay a higher price.

3. Typical market pricing for an item that the retailer might have access to and wishes to respond with a price that is above, near or below market pricing.

4. Amount of inventory that the retailer has in stock. As the inventory drops, the price the retailer may want to sell may increase.

5. Sales tax regime of the customer. In a higher tax regime, retailer may wish to sell for less.

6. Seasonality of item. At the end of a season, retailer may wish for higher discounts.

7. Change of model anticipation. Retailer may wish to discount more if a model is expected to change and potentially become obsolete.

8. Newness of model—retailer may not wish to discount new in-demand models by much.

9. Restrictions of manufacturer on pricing. For many items, manufacturers limit the retailer's ability to discount the price. This is common for higher priced items, where manufacturers have an interest in supporting the pricing of their distribution base and avoiding degradation of product image with restricted pricing. In this instance, a retailer may place the entire discount in the iPON™ allowing a store credit on future purchases from the retailer and no discount on the product price.

In block 508, when the customer receives the item at a negotiated price with an associated iPON™, the Negotiator issues or automatically assigns a promotional code associated with the customer for the purchase of a specific item with iPON™ value. The counteroffer may or may not include an intelligent coupon (iPON™). The promotional code issued by the retailer is preferably unique for each sale that includes this negotiation and/or iPON™ issuance.

In block 510, the customer enters promotional code into shopping cart and buys the item. In block 512, the iPON™ is securely stored in the database. In block 514, the Customer redeems the iPON™ at the online Retailer Website or in a store.

In one embodiment, the iPON™ is issued as part of the consideration of the negotiated closed sale. As part of the counteroffer in the negotiation, the retailer may choose to offer: (a) simply a price or (b) one price with an iPON™ or (c) several prices, each with a different cash price and each differing cash price with an iPON™ price, and to close the negotiation the buyer picks the option they wish to have. In this last case, it is expected that as the cash price rises, the iPON™ credit for future sales will rise as well. The retailer may also choose to skip the negotiation, and simply offer one or more prices, each with a corresponding iPON™ and simply allow the customer to select one of the options.

In one embodiment, the iPON™ Database may be separate from the retailer's servers and stores these intelligent coupons (iPON™). The retailer will have the option of offering an iPON™ as part of the negotiation as a counteroffer to the customer's offer, or simply as an offer (for example buy a shirt for $20.00 and receive a $10.00 iPON™). This iPON™ is a value, such as a cash discount, or another attractive benefit, that is redeemable against another or later purchase, and is not meant to be applicable to the price offered by the retailer for the item on offer when an iPON™ is part of the total benefit the customer receives in his or her first purchase. In one embodiment, the database is operated and fees are charged for transactions whereby the iPON™ can be sold or credit transferred from one customer to another customer or redeemed.

An iPON™ is preferably unique and issued to a specific customer, and while in the database, can be enhanced electronically by the retailer. The iPON™ can be issued in any currency, be redeemed at any of the retailer's stores, even in other countries, have any feature or offer incorporated with any terms the retailer desires.

Only customers who register for an account are able to receive an iPON™. Their accounts will store, track, and issue the iPON™. When issuing the iPON™ for use, the issuing process means the retailer accepts an iPON™ as a discount of the item being sold. Each iPON™ has an associated promotional code or unique serial number. This promotional code or serial number is used to identify the serialized iPON™ having a distinct cash value, such as $10.

There are a number of examples of ways an iPON™ can be added to a customer's account. For example, these may include, but are not limited to:
1. through negotiation, using the Negotiator to negotiate an item price;
2. through transfer from another holder on the iPON™ network,
3. facilitated by the Negotiator;
4. through purchase from the retailer, similar to a gift card;
5. through earning it as part of a loyalty rewards program, where the retailer offers an iPON™ in exchange for the redemption of loyalty rewards points, or through issuance of an iPON™ as a loyalty reward;
6. through retailer re-issuance when an item purchased with an iPON™ is returned;
7. through issuance when purchased or downloaded from a manufacturer's website;
8. through the purchase and transfer by retailer A from retailer B, where retailer A may subsequently offer retailer B's iPON™ as part of a negotiation or promotion of retailer A's goods or services;
9. through distribution by a non-retail entity, such as a charity, which has been nominated by the retailer or manufacturer to distribute its iPON™;
10. through transfer from a coupon to an iPON™ in the holder's account. In this method, a retailer or manufacturer that typically advertises coupons online or in paper form—such as in the newspaper, would have a code (which may be a bar code, alpha numeric code, numeric code or QR code) on the paper coupon or e coupon that would allow a customer with an iPON™ account to add this coupon to his or her account and then it becomes an iPON™.

In one embodiment, the above transactions may be facilitated to add an iPON™ to a customer's account.

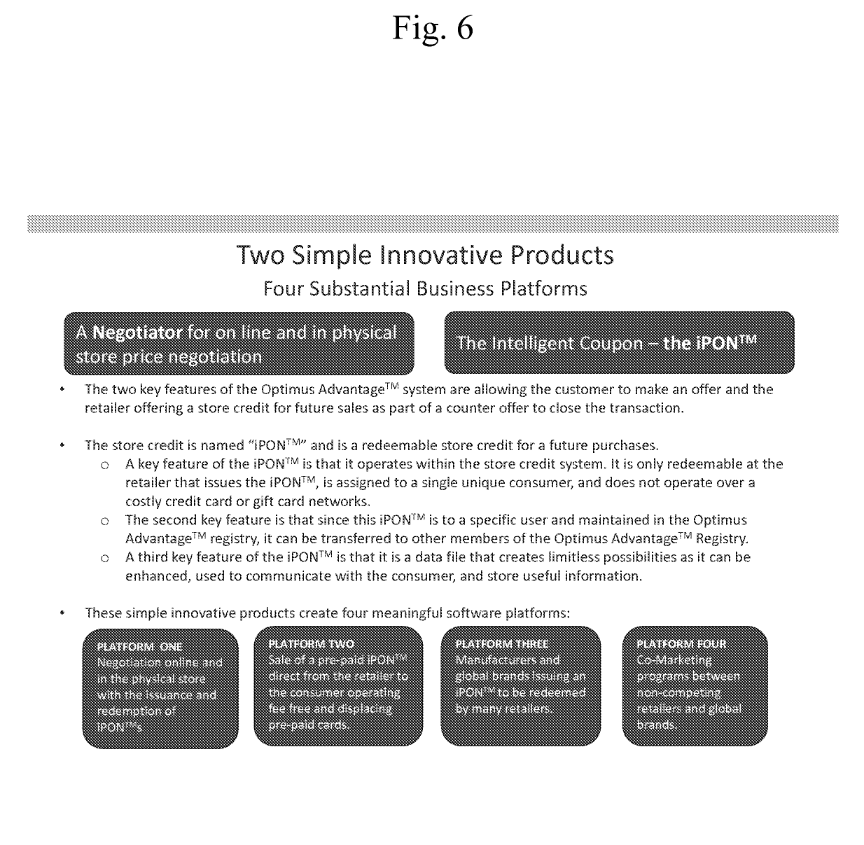

An example of a number of embodiments of platforms that may be implemented is shown in FIG. 6.

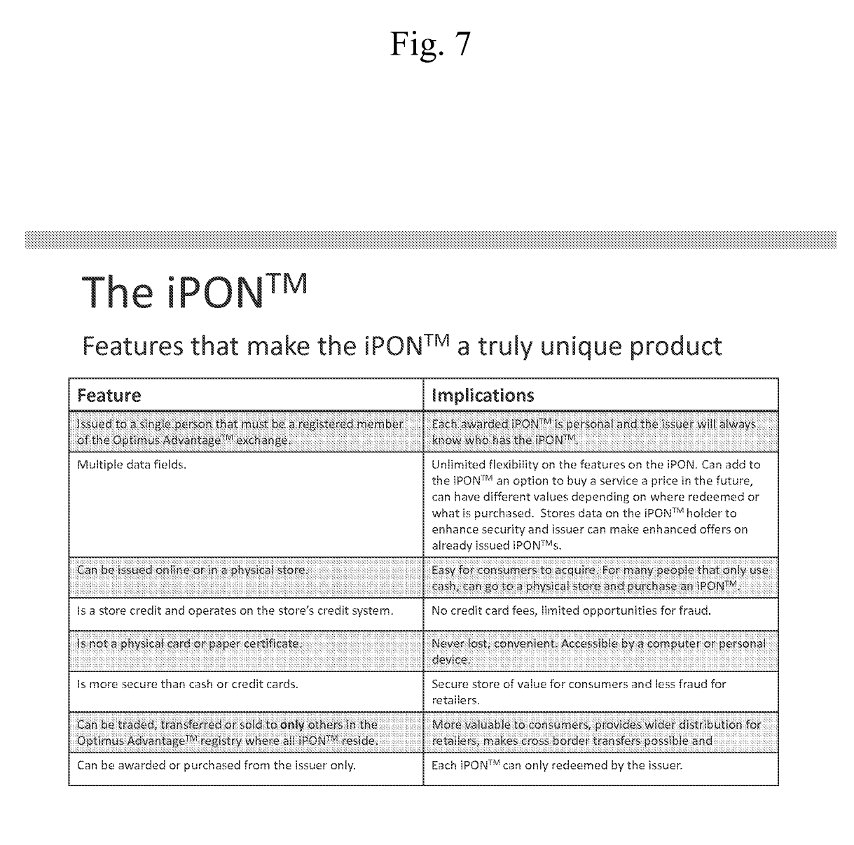

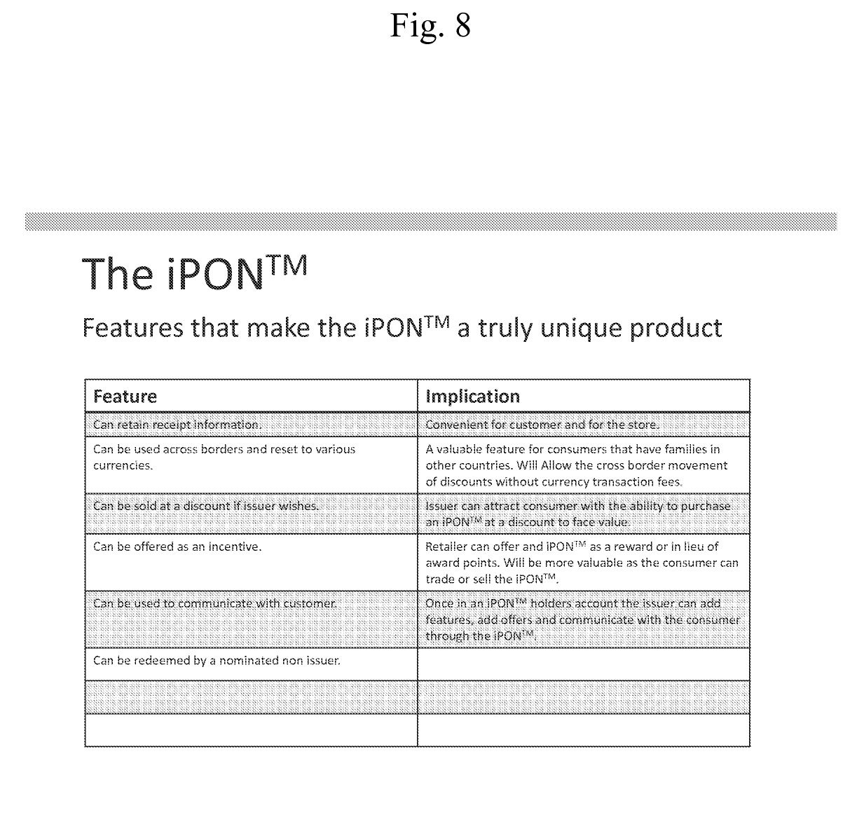

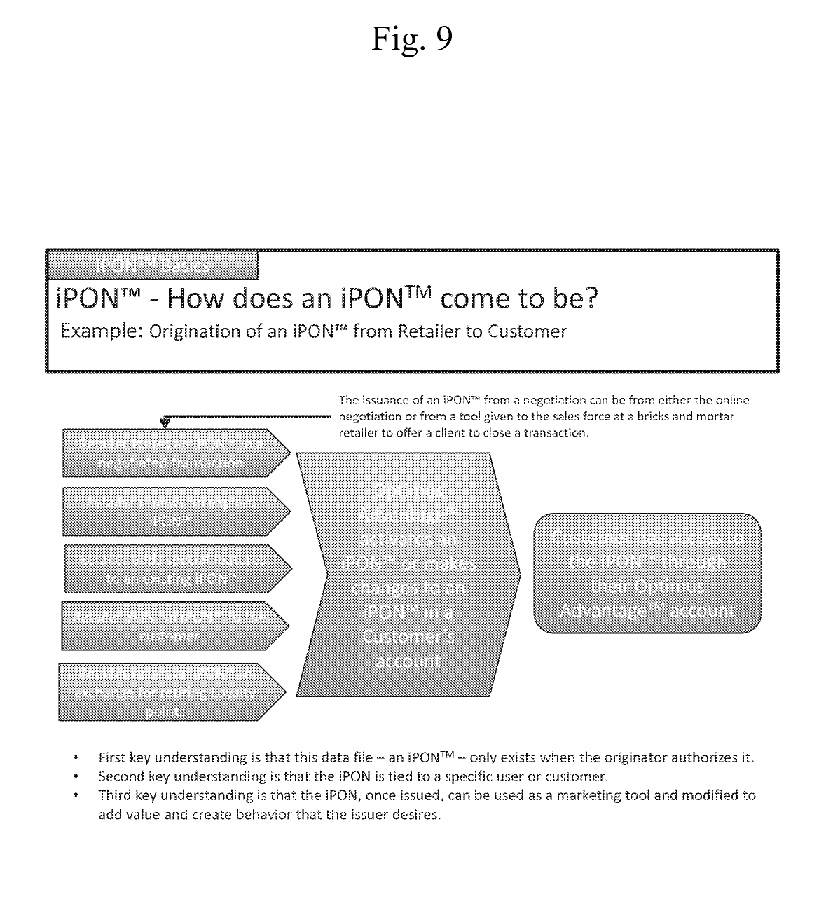

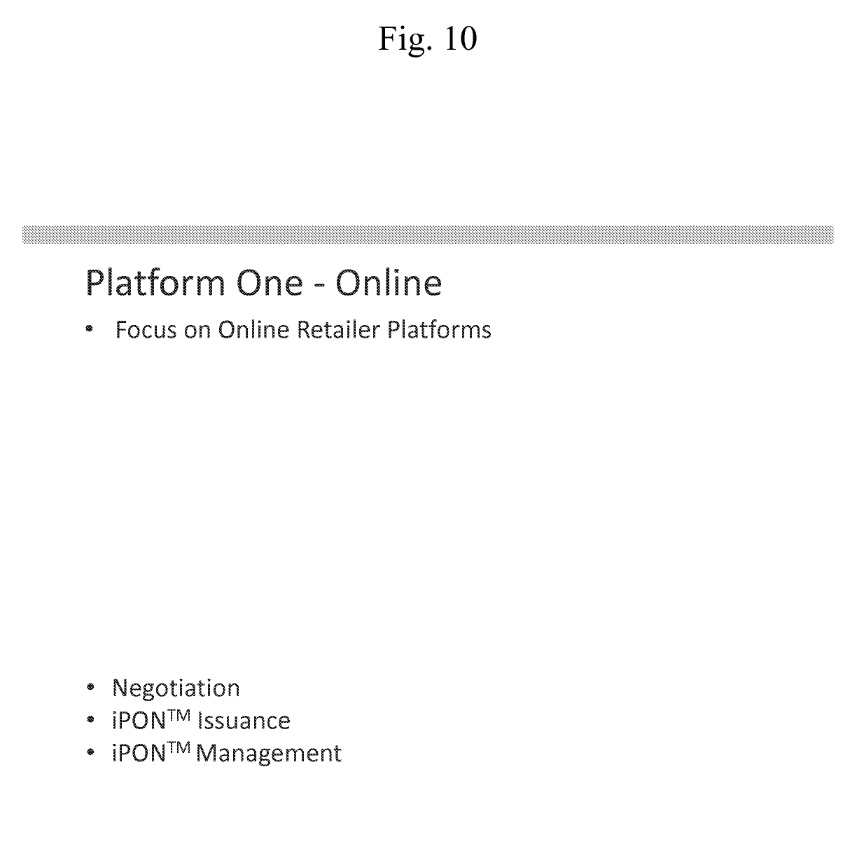

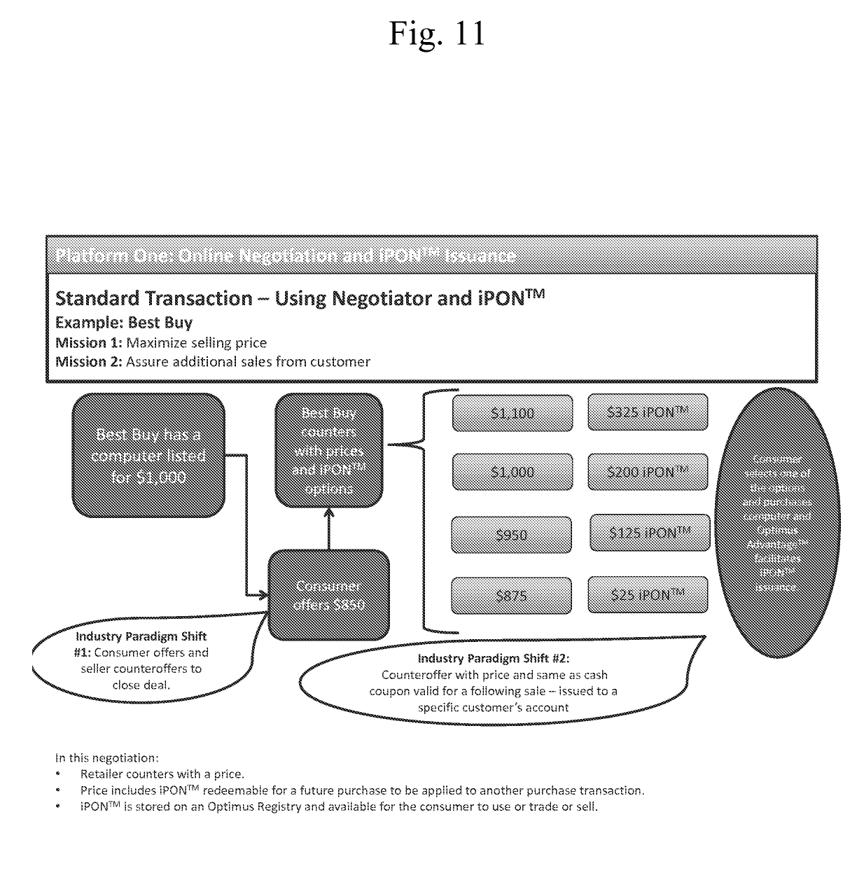

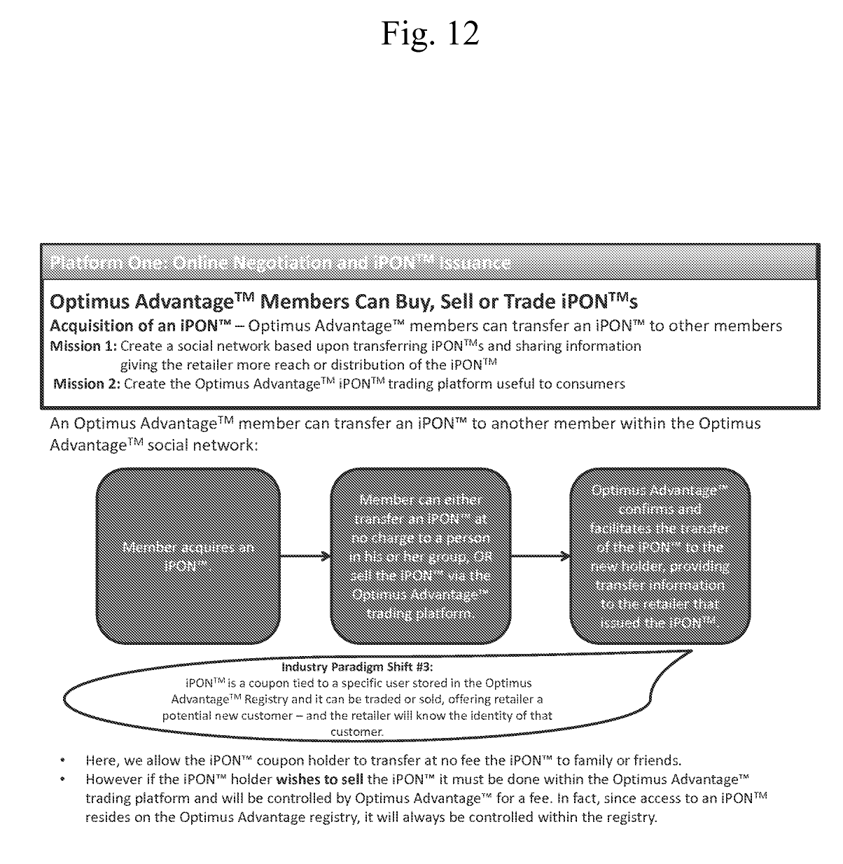

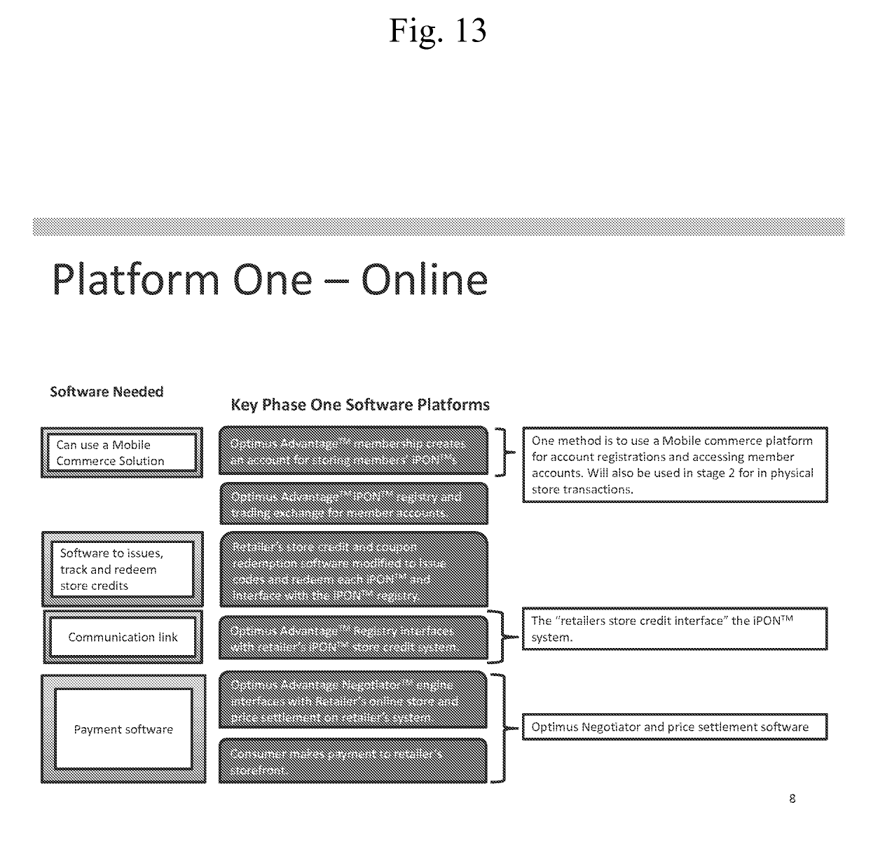

An example of aspects of an embodiment of an iPON™ is shown in FIGS. 7 and 8.

In one embodiment, the negotiation system and iPON™ may be designed for larger retailers with a larger presence in the market place. Once established with a meaningful customer base, the Optimus Advantage Marketplace iPON™ system can be expanded to serve small local retailers with a program specifically tailored to small retailers. This would include the possibility for existing account holders to:
1. Purchase a discount value iPON™ for future purchases. ($200 for 20 haircuts from a local barbershop).
2. Opt in to special iPON™, such as an offer for dinner discount at a restaurant available for certain limited hours.
3. Allowing a local retailer or service provider to offer an iPON™, if a certain number of customers opt in to use it. For example, a car dealer can offer $10 oil change, if 25 customers opt in to use it. Once the defined number opt it to use it, the iPON™ becomes valid. This is expected to cause members to draw in other customers to opt in to using the iPON™ system.
4. Other local retailer-specific deals where to enjoy 25% off, the customer must register for the iPON™ and pay a nominal amount, for example $5.00 and when they arrive at a restaurant, then gain both the 25% off and the $5.00 credit.

The small retailer application may reside on one server and may or may not use the negotiation engine. The small retailer application will require that the small retailer be able to access his or her account and allow him or her to interface with the iPON™ issuance and redemption functions.

In one embodiment, the application may be used for manufacturers. For example, at present, manufacturers promote their products by (a) offering discounts to retailers to promote a product or (b) offering manufacturer coupons to customers who then receive a discount from a retailer when purchasing an item. This manufacturer's coupon, when used, allows the retailer to submit the coupon to the manufacturer for refund. The iPON™ represents a better approach to this system. The members would have access to these manufacturer-issued iPON™s. If, for example, a member accepts a manufacturer issued iPON™, or perhaps has paid a nominal amount and purchased such an iPON™, Optimus Advantage Marketplace Manager can allow member retailers to know which member has acquired such a manufacturer iPON™ and permit the retailer to enhance the iPON™ residing in the same member's account, provided that the retailer uses the manufacturer's iPON™ to close the sale with respect to that specific manufacturer's product.

In one embodiment, the present invention enables the customer to negotiate a price for an item with an artificial intelligence computer-based software interface incorporating logic rules representative of the limits set by a mathematical formula. Customer interaction with the computer software program consists of making a monetary offer to buy an item for sale at the retailer website.

One advantage of an embodiment of the present invention is that the counteroffer to the customer's offer may include an iPON™ cash credit redeemable in future sales as part of the reply to the customer's offer. In one embodiment, this iPON™ (intelligent coupon) comprises a business method for storing, transferring and redeeming value at a specific retailer. This embodiment provides that the iPON™ is issued to a single person.

Yet another advantage of the iPON™ itself is that it can be issued in a transaction other than the negotiation process and used for a discount on a purchase.

One embodiment of the present invention allows retailers to provide customers with the ability to negotiate a new price of an item for sale at a retailer website and as part of the negotiation, the retailer would not only agree on an alternative price, but also issue an iPON™ (intelligent coupon) digital cash credit towards a future item purchased from the merchant. As an example, a seller, such as Best Buy, may have a vacuum cleaner posted for sale at $149.99. Marketplace software would interface with the retailer's web page, and facilitate a negotiation. In this negotiation, the software allows the retailer several options for a counteroffer, and especially unique is that the counteroffer may use iPON™s, which are essentially electronic same as cash discounts, that are assigned to the unique buyer.

The software program responds to the customer's new price offer with a price counteroffer, based upon using a pre-programmed mathematical formula; e.g. original price: $149.99, customer makes an offer of $125.00. A counteroffer is then made to the customer, using the mathematical equation for processing the counteroffer. The counteroffer could be, for example, any of the following:
1. No discount;
2. Agree to the price offered;
3. A price above the offered $125.00, for example $135.00;
4. A price above the asking $149.99 plus an iPON™ same as cash credit for a discount on a future purchase (for example, $175.00 purchase price and an iPON™ for $75.00);
5. A price higher than the customer's $125.00 offer and an iPON™ (for example $135.00 and an iPON™ for $30.00);
6. Accept the customer's offer and if the order is placed in the next 5 minutes, an iPON™ would be issued for $15.00; or
7. Additional benefits may include services such as free shipping or an extended product warranty.

In one embodiment, the Marketplace software provides the retailer the opportunity to counteroffer in several different ways. The retailer may respond with only one option, and iterate back and forth with the customer for a final price or, more likely, in response to the customer's offer, reply with several options, whereby the customer would select one of several offers. These counteroffers may include, but are not limited to, a price and an iPON™ credit. The expectation is that the retailer will provide larger iPON™ credits as the selling cash price increases. In fact, we expect sellers to sometimes achieve a higher than listed price with a large enough iPON™ credit.

In this embodiment, once the negotiation finishes, the customer may be issued a promotional code number corresponding to the negotiated price, which would include an iPON™ to the customer's account at the iPON™ Database.

To buy the item, the customer may enter the promotional code number in the shopping cart (or the system may automatically do this) and the item selling price is automatically discounted to the negotiated price. Upon payment, the customer buys the item at the negotiated price, and an intelligent coupon (iPON™) is assigned to the customer. The individual iPON™ may be stored in the iPON™ Database and available for redemption by the customer at the retailer's website or in store using a display of the iPON™ on the customer's device connected to the Internet, such as a smartphone or other mobile device.

In one embodiment, the customer redeems the iPON™ at the retailer website by selecting an item for sale, and negotiating the price or simply accepting the price for this item, and accessing his or her account to display iPON™s available in the iPON™ Database. When the customer is ready to pay, the account number in the database containing the individual coupon value or the serial number of the iPON™ is entered into the retailer shopping cart and a deduction from the item price is made, based upon the value of the individual iPON™. The customer iPON™ database account balance is deducted for the amount applied towards the purchase price.

In one embodiment, the retailer may establish the artificial intelligence rules used by the Negotiator Interface and be able to accomplish at least some of the following as it interfaces with the Negotiator Interface Software:
1. Set parameters for counteroffer for each SKU or item name to be used in the negotiation;
2. Identify which items will accept negotiation, or allow all to accept negotiation;
3. Issue a promotional code number for the specific agreed offer at the end of the negotiation, so the customer can input the promotional code number in the retailer's shopping cart;
4. Upon the purchase, authorize the issuance of an iPON™ credit to that specific customer, which would then be stored in the member's account;
5. Upon return of the merchandise, notify of the return, and if the retailer desires, require the iPON™ credit that was issued in the negotiation to be revoked or revised to other terms that may incentivize the customer to come back for another purchase;
6. If a customer wishes to purchase an iPON™ credit, set the price for a value, and upon receiving payment notify the Marketplace to add the iPON™ credit to the customer account; and
7. For future purchases, accept as payment an iPON™ credit. The iPON™ redemption verifies the buyer and the credit, and informs of the acceptance of the credit so that the system adjusts the buyer's account, and notifies the buyer that the credit was spent.

In one embodiment, the Marketplace software operates on the computer server and may perform at least one of the following:
1. Host the Negotiator Interface and present a split or partial screen interface to allow the simultaneous display of the retailer website and the Negotiator used by the customer to negotiate item price and iPON™ value;
2. Access the mathematical parameters for counteroffers made by the Negotiator Interface.
3. Make price counteroffers;
4. Recognize an agreement in the price and notify the seller the deal is agreed;
5. Upon a purchase, which includes payment, receive a promotional retailer code number and store in the buyer's account for making future purchases;
6. Upon a purchase, issue an iPON™ to the customer's account;
7. Upon return of merchandise, receive from the seller a notice to revoke the iPON™ credit or other protocol the retailer may desire; and
8. Any time an iPON™ is redeemed, a small fee is charged to the redeeming customer that is paid to the Marketplace operator.

In one embodiment, the Marketplace may offer at least the following:
1. Register a buyer and assign an identity to the buyer;
2. Accept, store and remove iPON™ value credits either on the Marketplace registry or be the access and communicator to the iPON™ issuers database where the credits will be stored;
3. Issue the iPON™ credit when the buyer wants to spend it or allow buyer access to the iPON™ credit when the buyer wishes to spend it;
4. Email or text the buyer when they receive an iPON™ credit;
5. Text the buyer's phone or send to e-mail, or both, when buyer's iPON™ is redeemed;
6. Provide a method of using the iPON™ at the (Point of Sale) POS in the physical retail store; displayed on the buyer's cell phone or other mobile device;
7. Provide the customer a list of all retailer iPON™s available in his or her account;
8. Allow a method for the holder to transfer iPON™ to contacts in the network:
   a. To avoid fraud, iPON™ holder “Holder A” nominates to send an iPON™ to “Holder B”. Once nominated, the iPON™ is frozen with the new Holder's name, and does not transfer until Holder A requests the release of the iPON™
   b. This transaction also has to be approved by the retailer;
9. Once an iPON™ account is registered, will give each customer the opportunity to opt in to a specific retailer and to opt in to receiving special offers. These offers will reside in the customer's account, with, at the customer's option, a notice sent via e-mail or text, or both:
   a. For example, a retailer can notify the iPON™ holder that there is an end of season sale for 30% off, and if an iPON™ is used, the discount is now 35% off.
   b. The customer can opt in to manufacturer offers. So, for example, if a manufacturer wants to offer an iPON™ for $50 off a new android pad, would provide that manufacturer or any other manufacturer a method for distributing manufacturer discounts to members. For example the system would offer:
      i. To sell this iPON™ for $5.00 to someone that has opted in for this $50.00 manufacturer discount;
      ii. Hold an auction where bids are submitted and the bidders above a certain price are issued an iPON™;
      iii. As part of the auction, for those that bid above a certain price, the iPON™ value is increased; and
      iv. To allow the manufacturer to offer at no charge a certain number of this particular iPON™;
10. Provide iPON™s to be used by small local retailers to offer coupons to customers, once customers opt in for a local small retailer.
   a. So, for example, a company, that sells a gift card for $9.99 haircuts could easily offer an iPON™ in the same way. Any customer that opts in for that company, can purchase an iPON™ for $9.99.
   b. Local restaurants can do the same. They can offer to sell iPON™s, and have other offers, that once a customer opts in for a particular restaurant, they can accept offers.
   c. Opt in to special iPON™ offers for off-hours service, such as a massage business, whereby discount is available for certain hours.
   d. A local retailer or service provider can offer an iPON™ conditioned on the participation of a certain number of customers. For example, a car dealer can offer $10 oil changes if 25 customers opt in to use it. Once the defined number opt in to use it, the iPON™ becomes valid and all customers are billed for the iPON. This is expected to cause members to draw in other customers to opt into to using the iPON.
   e. Unlike conventional coupons which last a predetermined amount of time (e.g. 180 days) before expiring, the iPON™ can be made as an offer that times out but is capable of later reactivation with a resetting of the iPON™ value.
   f. A novel feature of an iPON™ is that I can also be sold or issued by a local retailer as an option to purchase an item or service at a discounted price. Once this option expires, the retailer can contact the buyer of this now expired option, and offer to renew the option.

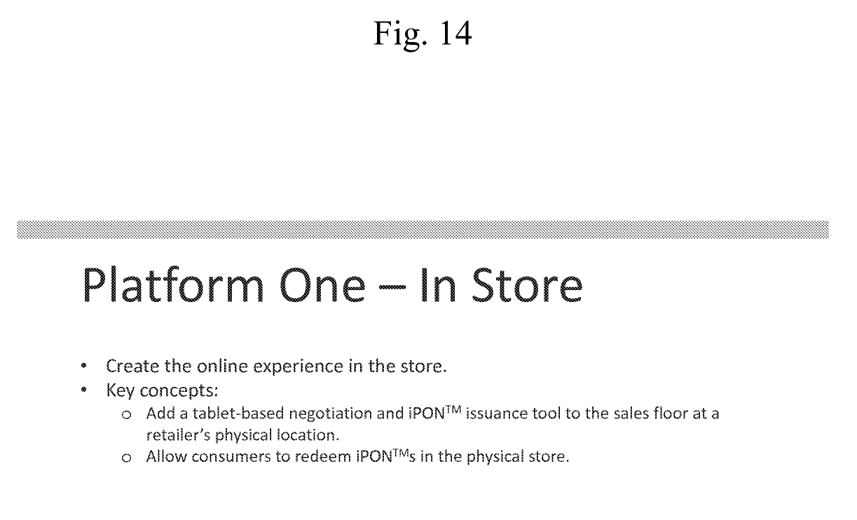

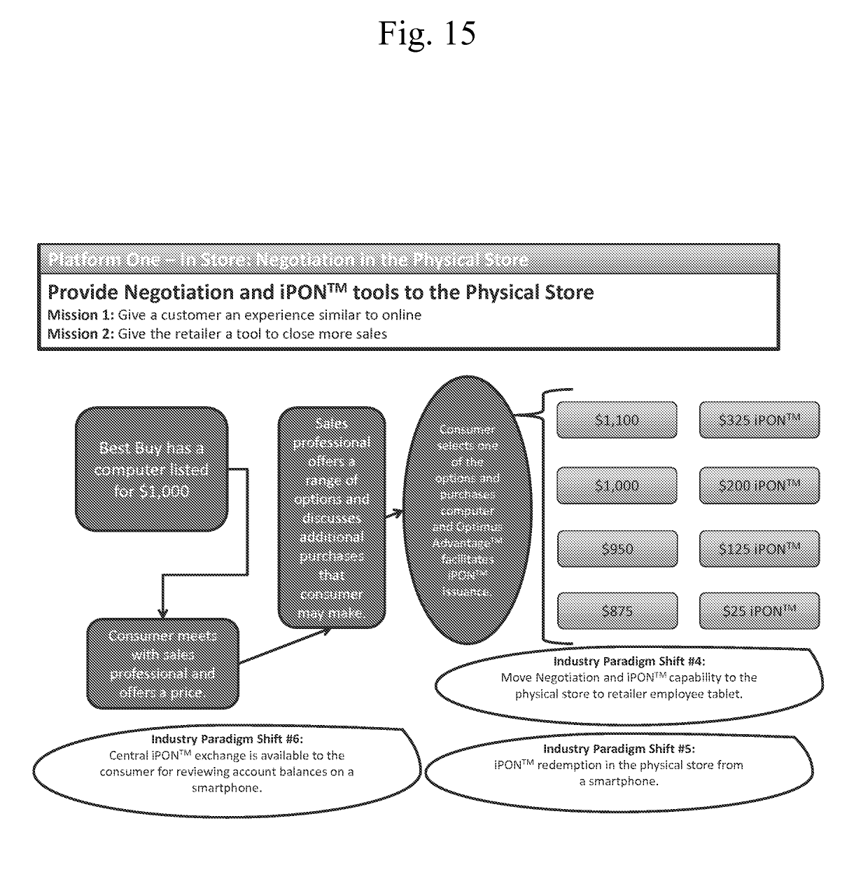

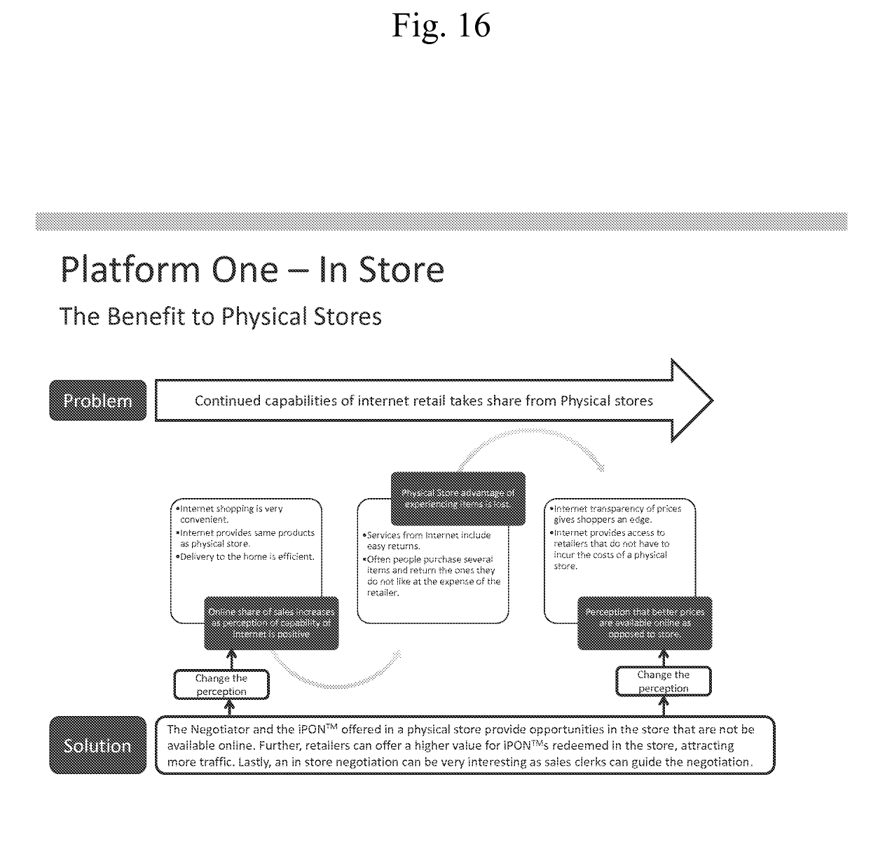

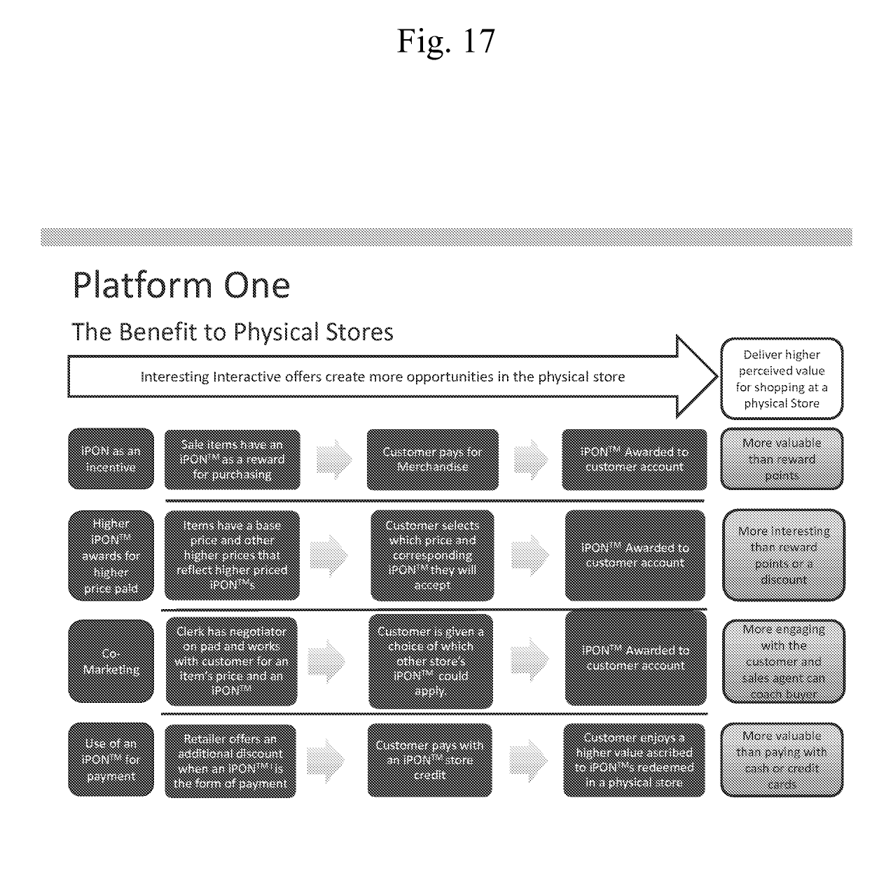

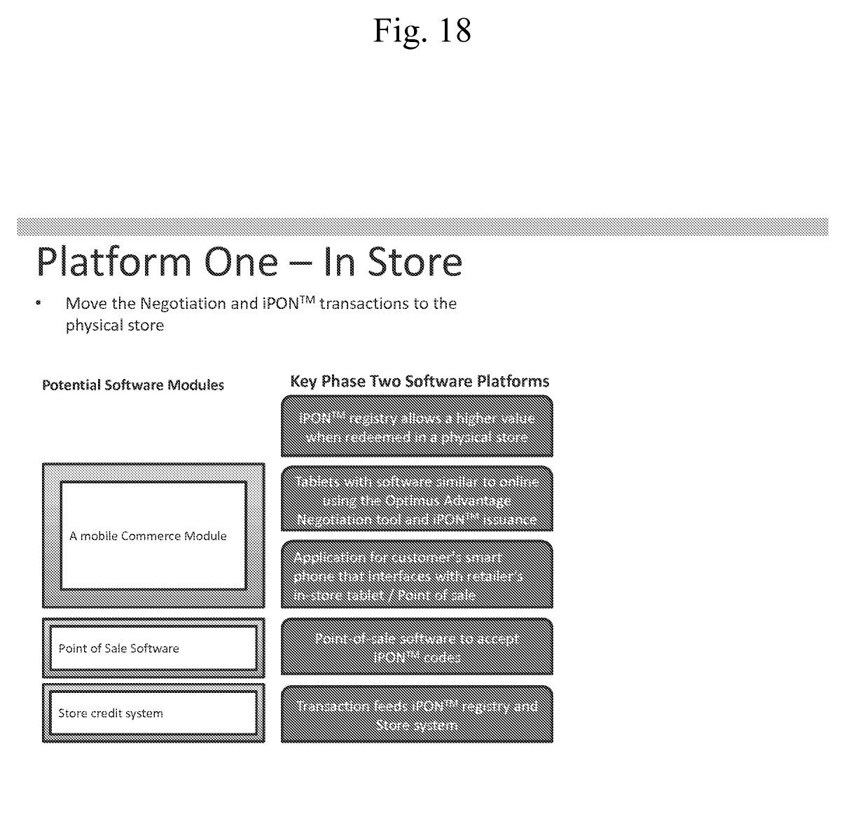

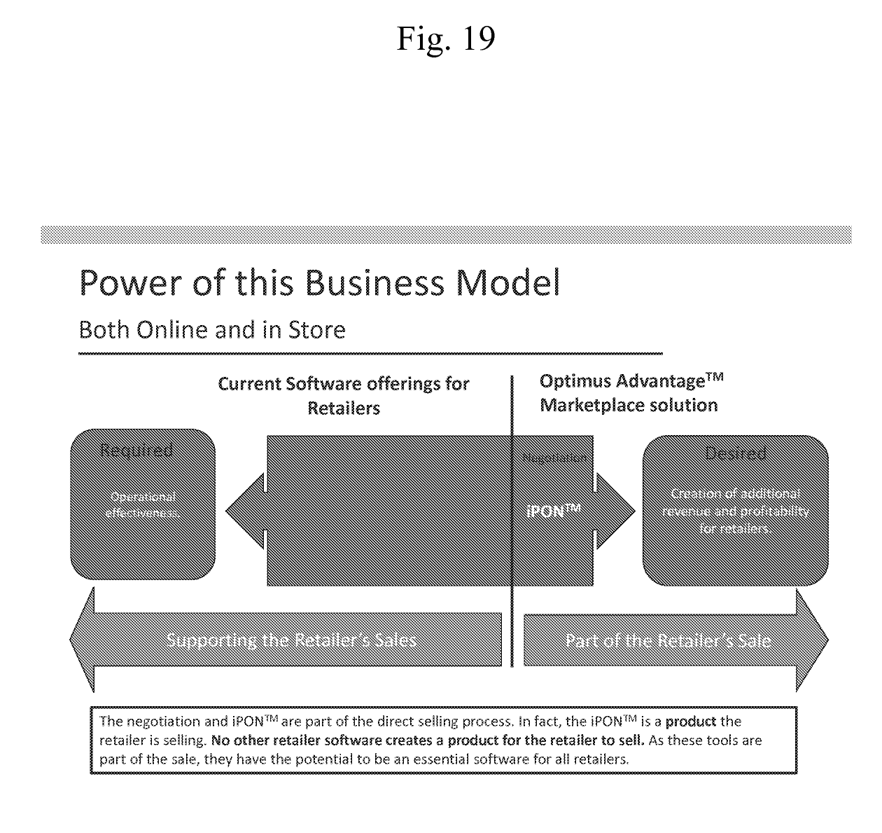

In one embodiment, the Negotiator and the iPON™ transact in the physical store (See FIG. 6). In this embodiment, the software is developed to move this online negotiation to the physical store. In this embodiment, as shown in FIGS. 14, 15, 16, and 17, employees would have computers or computer pads in the store, assist the customer in a negotiation similar to the online experience, and may also interface with the customer's smartphone, to complete a transaction with a negotiated price and an iPON™ issued. In this second embodiment, the physical store could also accept iPON™s at the POS (Point of Sale) and the store would have connected to a host computer that communicates with the store's iPON™ registry as well as the Marketplace registry. In concert with the store having connectivity for negotiation and iPON™ issuance and acceptance, the customer's smartphone or other similar device could be used to provide codes needed to complete a transaction of redeeming an iPON™ at the physical store. For example, in one embodiment, the retailer inputs information from the customer's iPON™ causing a text to be sent to the customer's phone, and the text is a confirming code the retailer enters to complete the transaction. In this embodiment the customer will be able to access his or her iPON™ account in their mobile device and see the account balance. Another method of providing the security at time of payment with a mobile device is the use of PKI and the Certificate of Authority as described below.

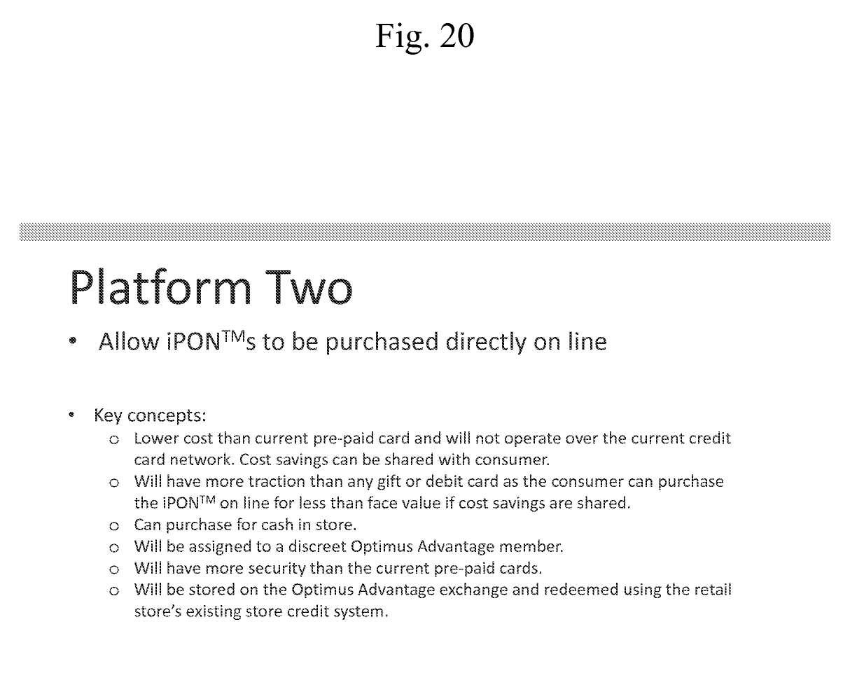

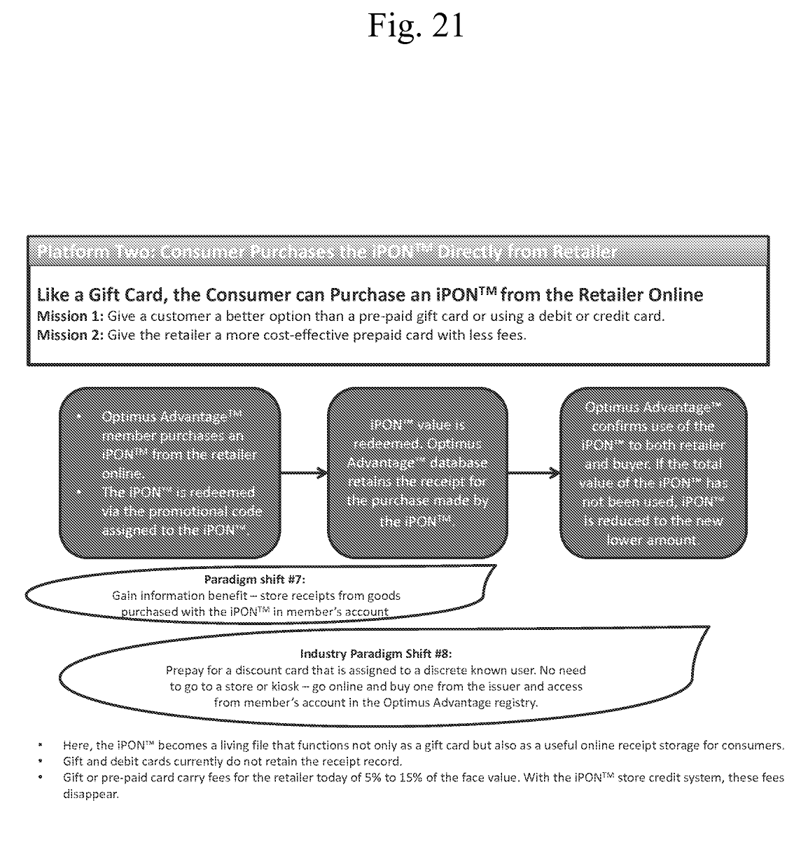

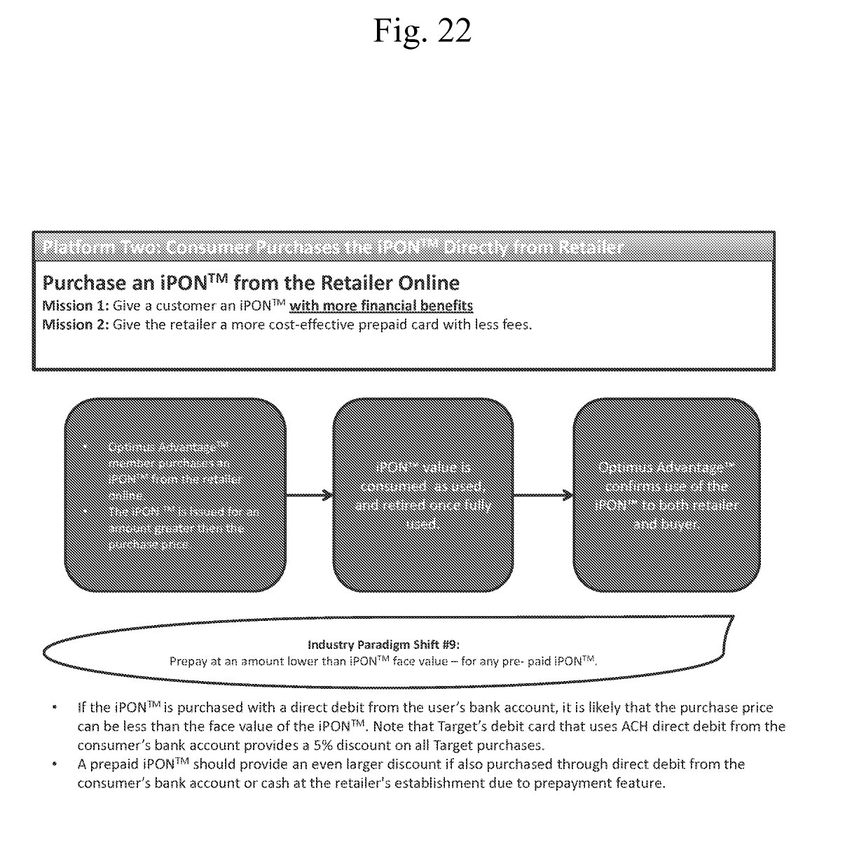

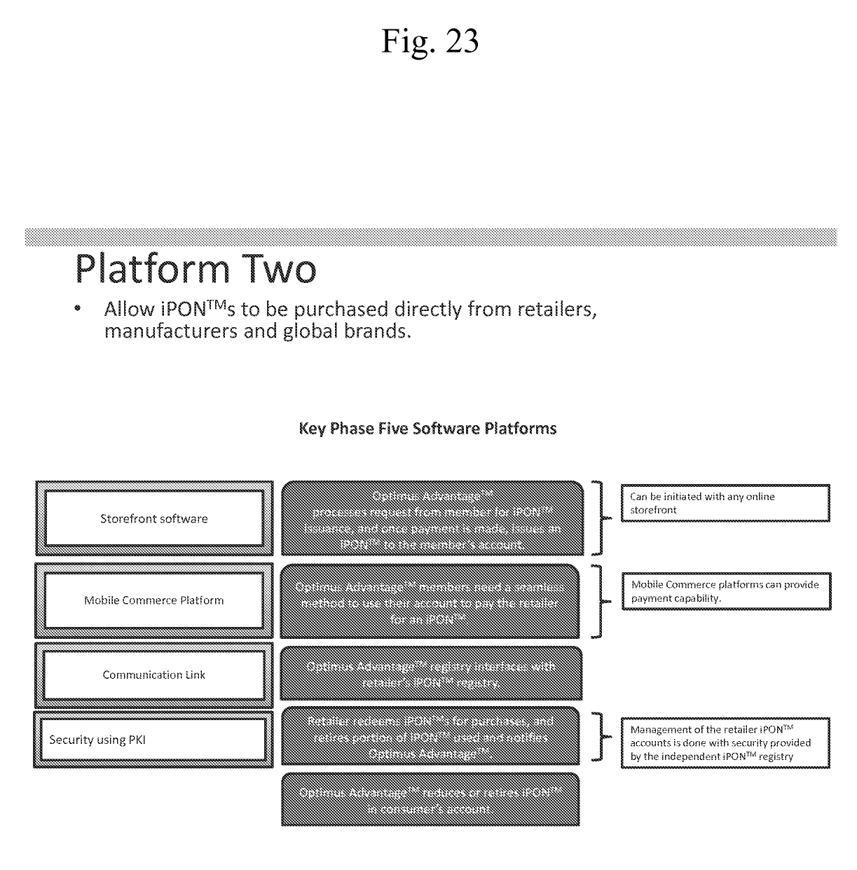

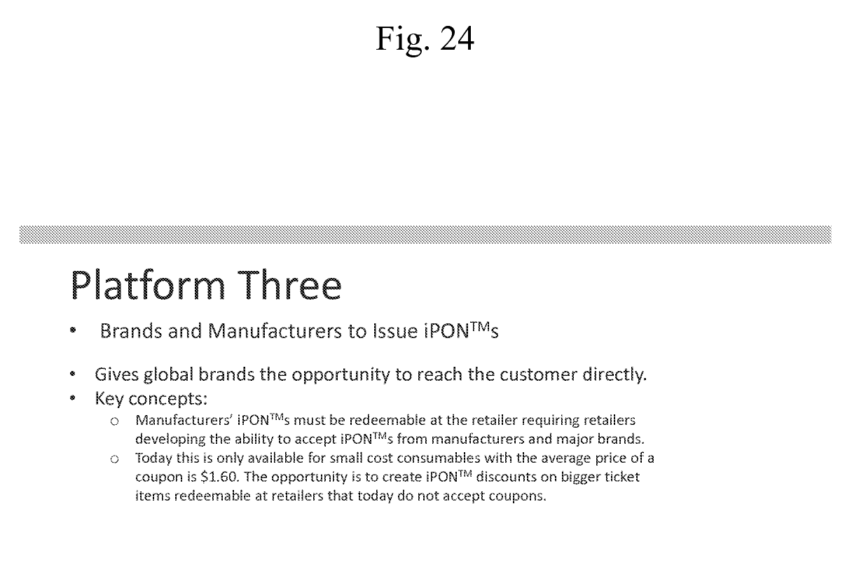

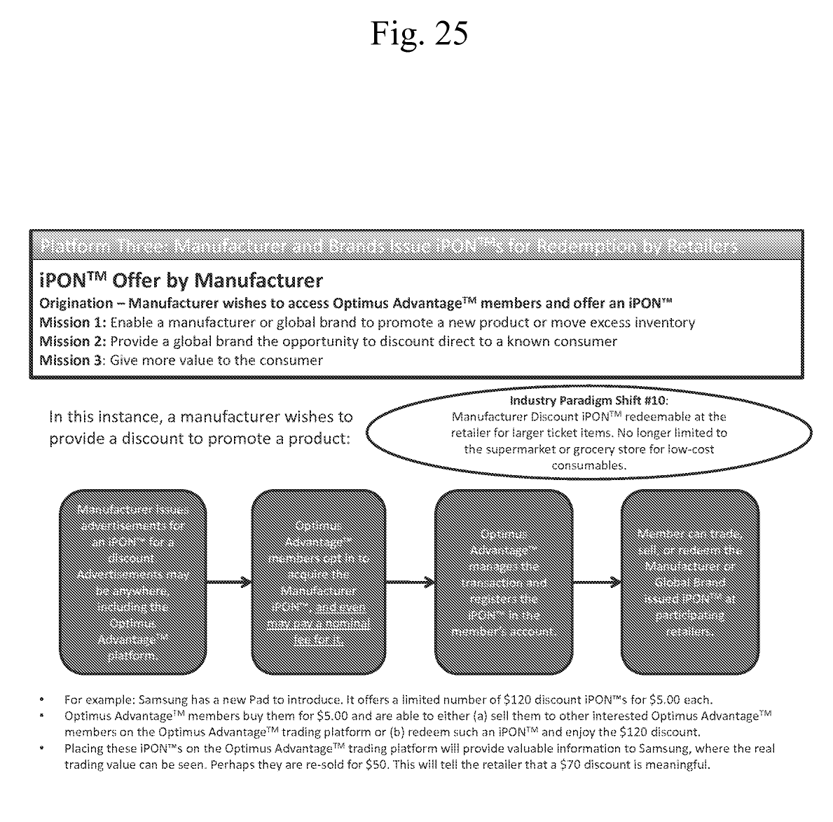

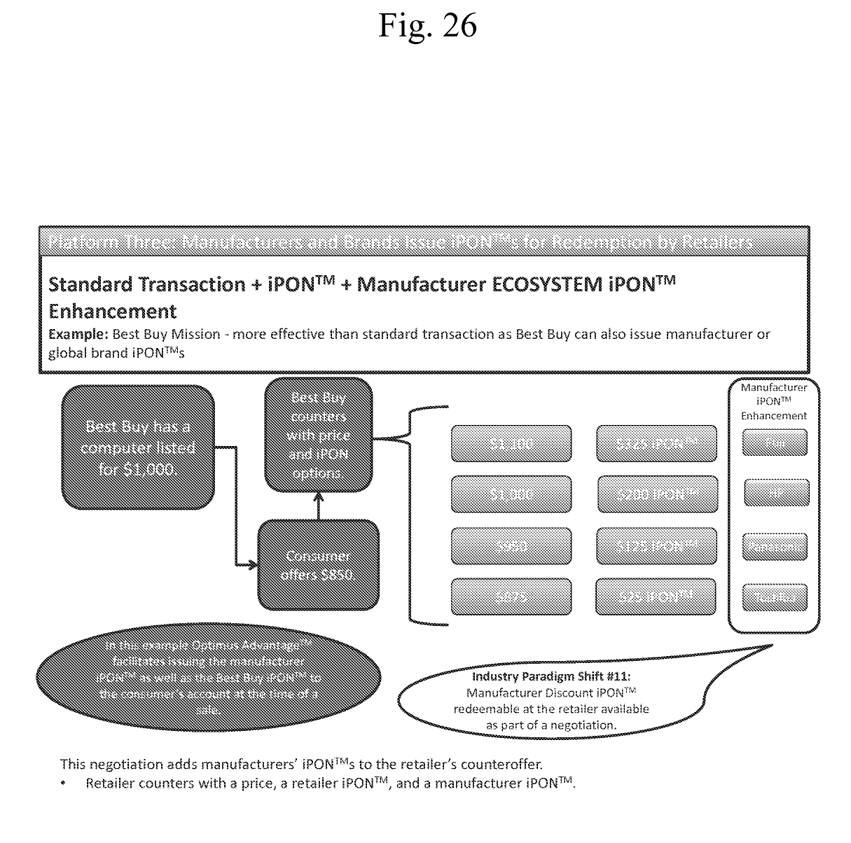

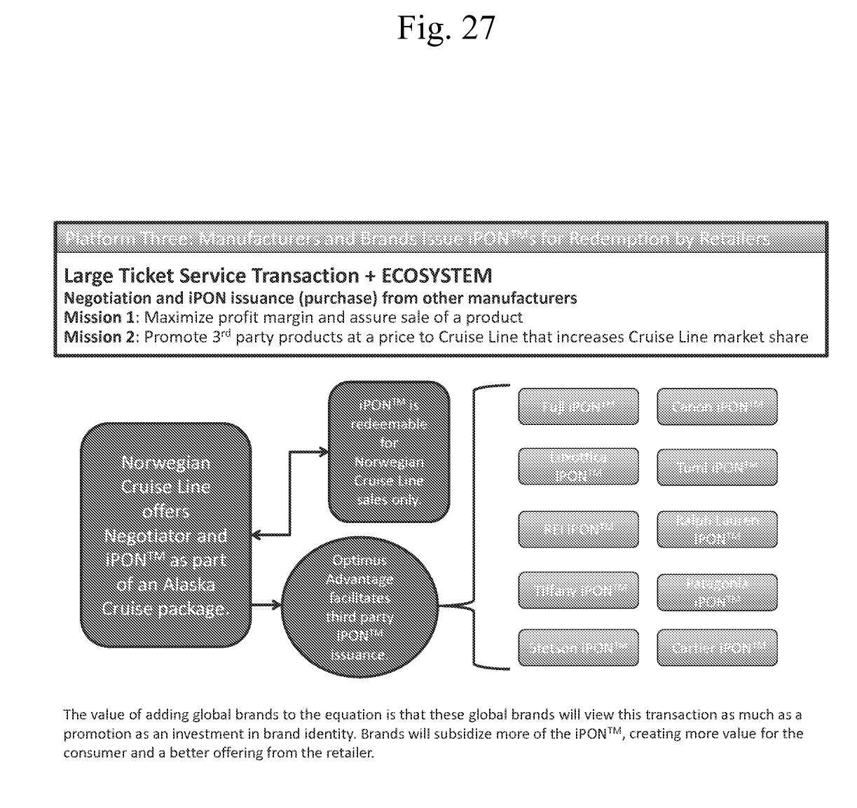

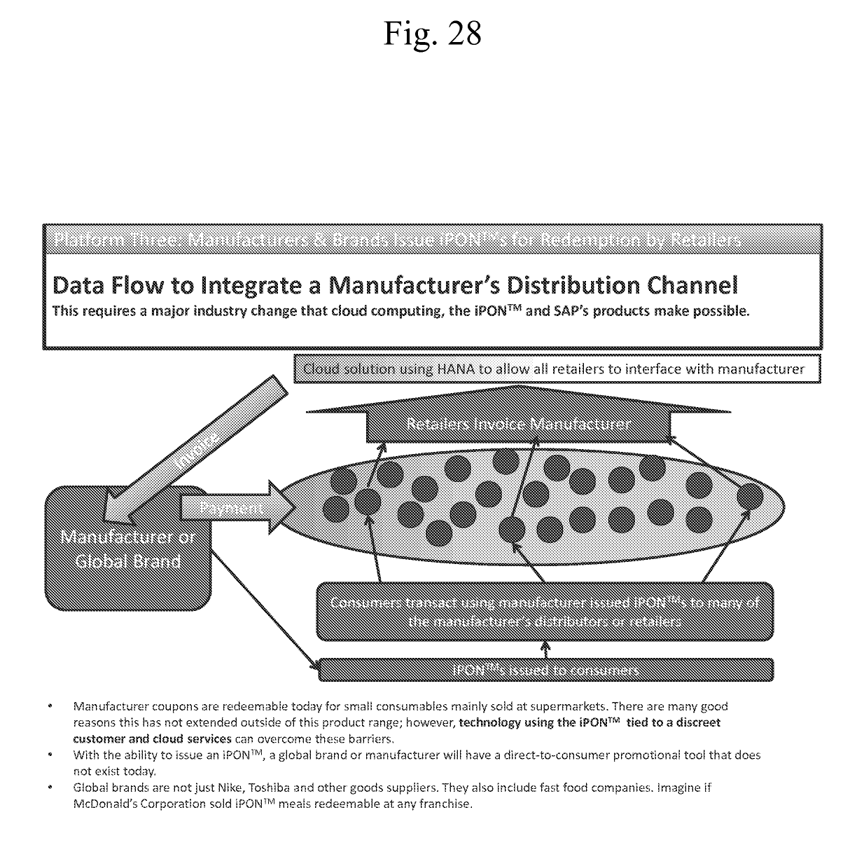

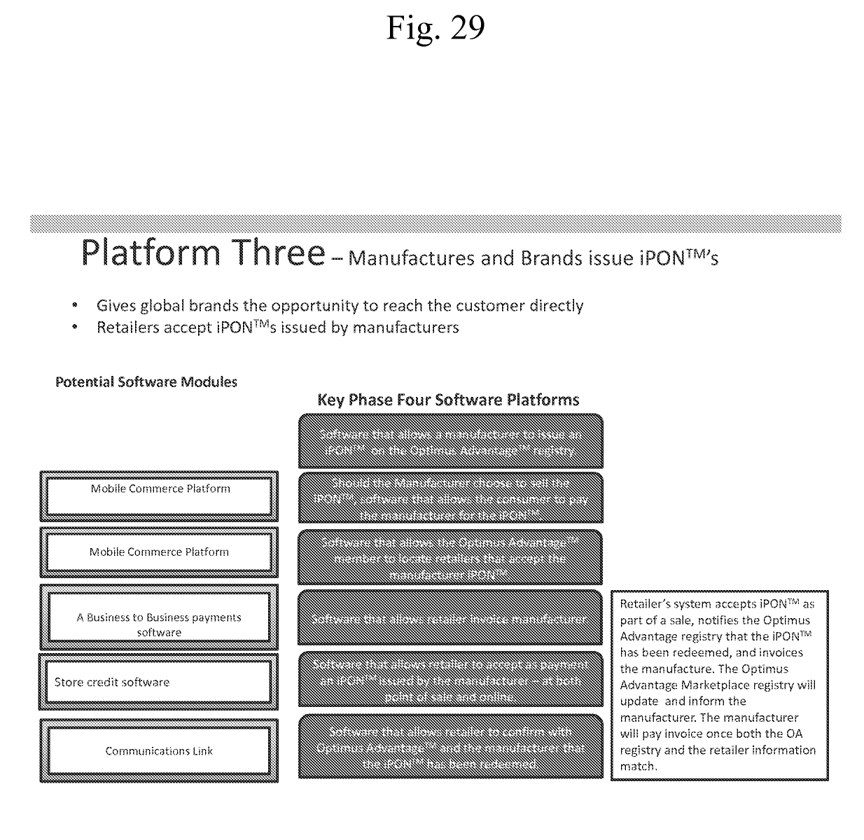

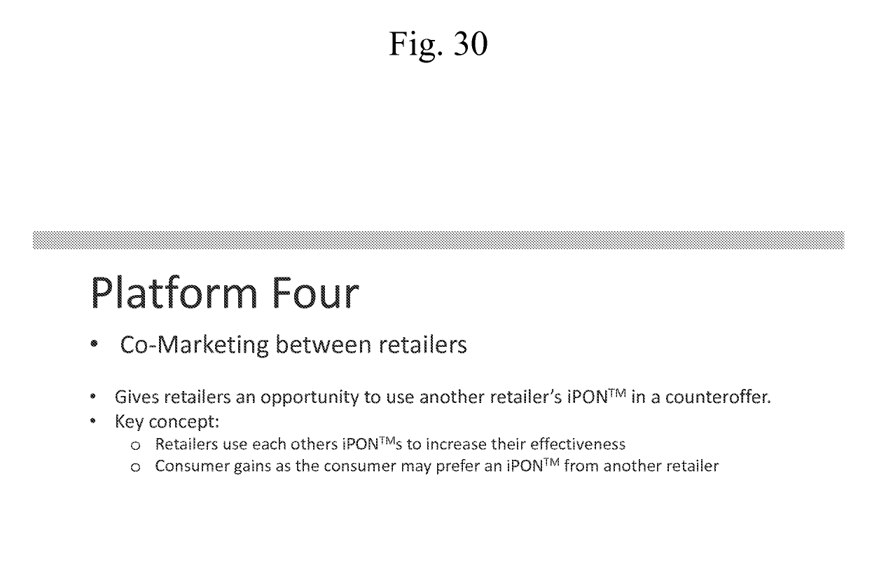

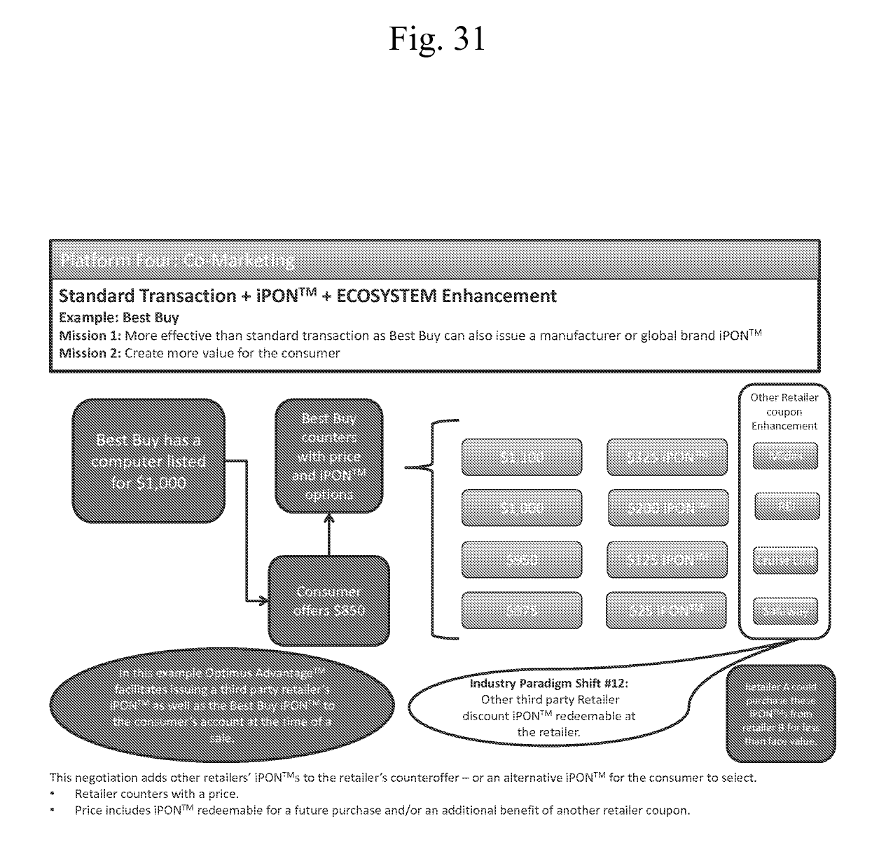

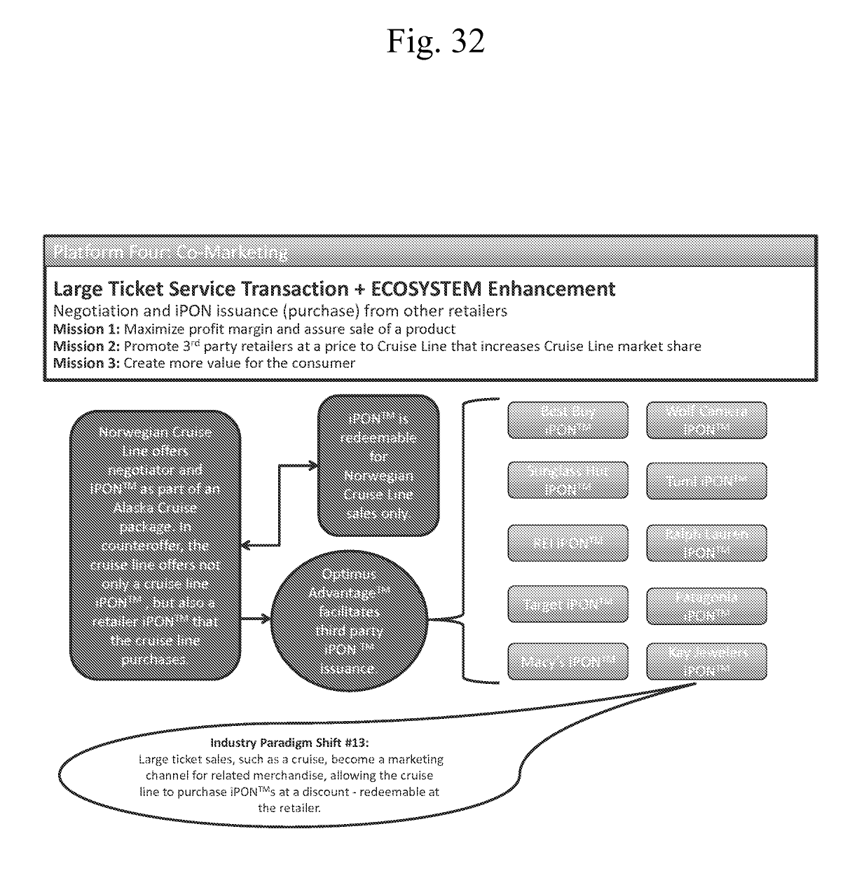

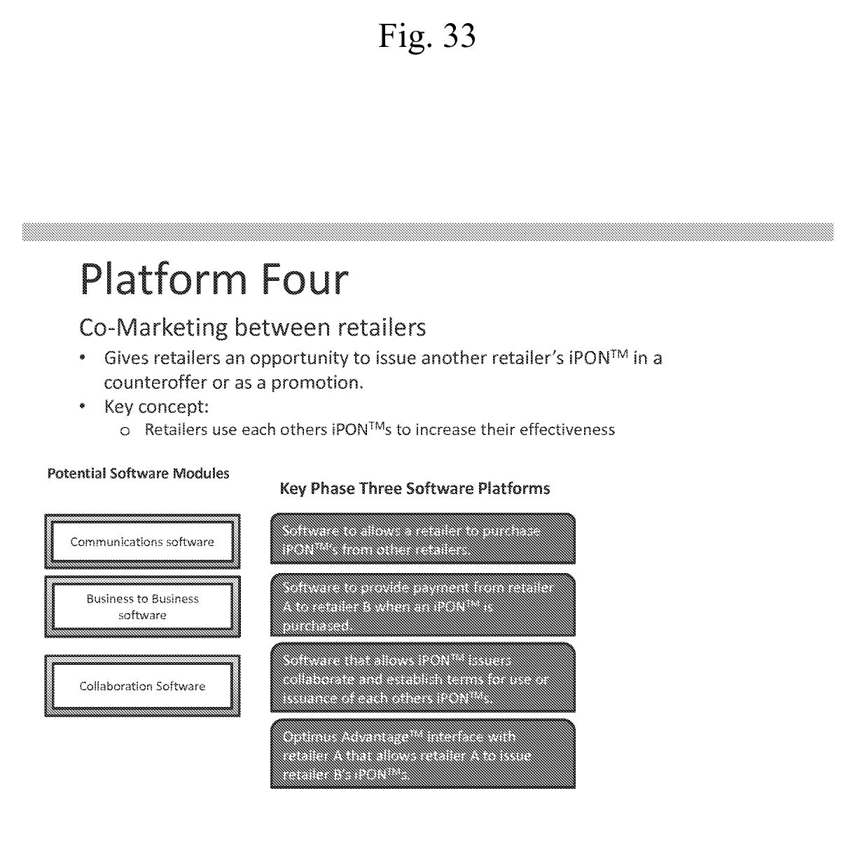

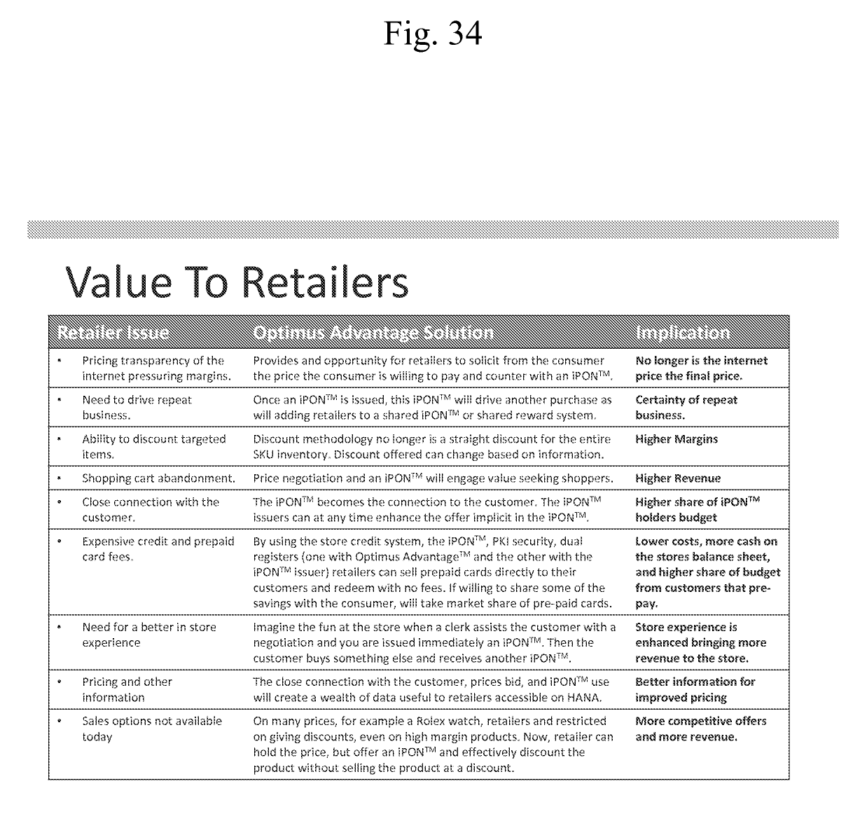

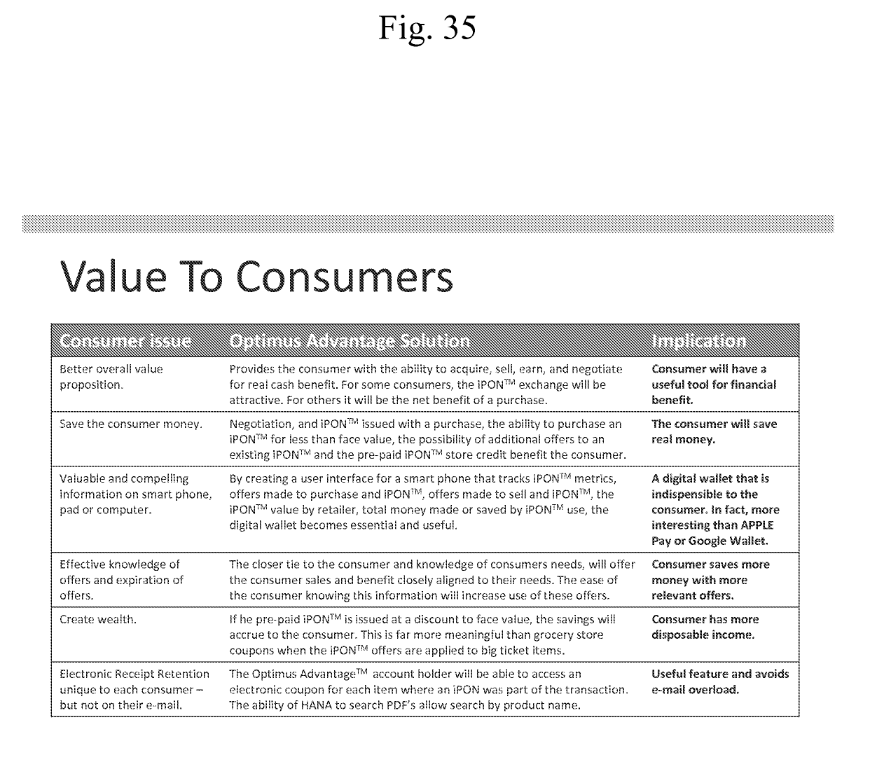

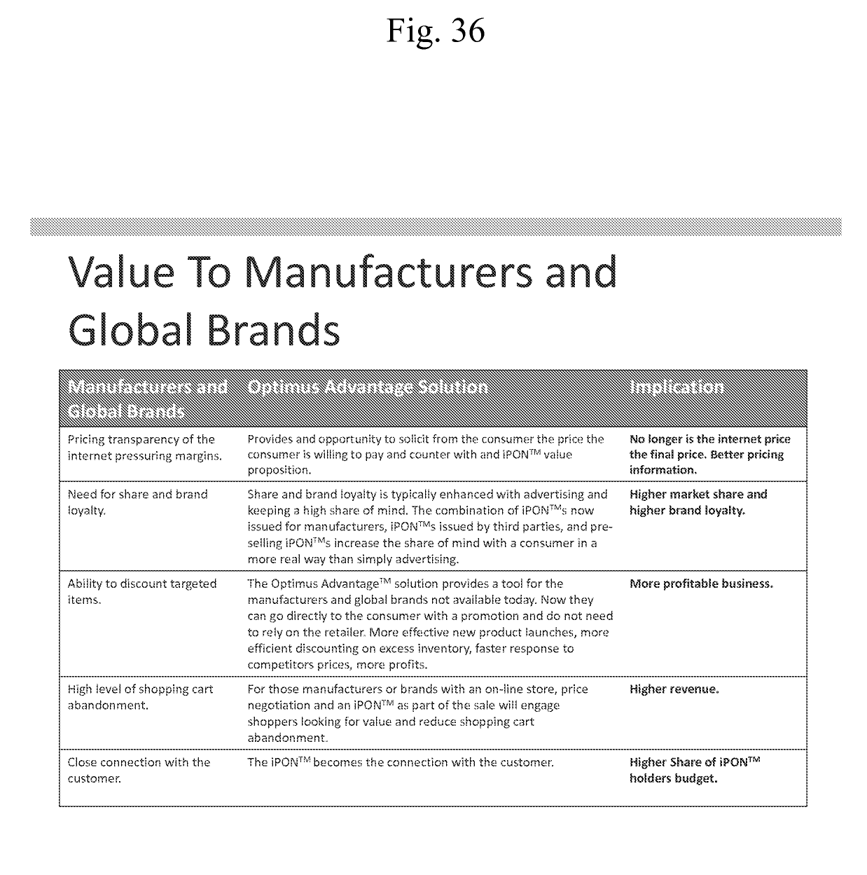

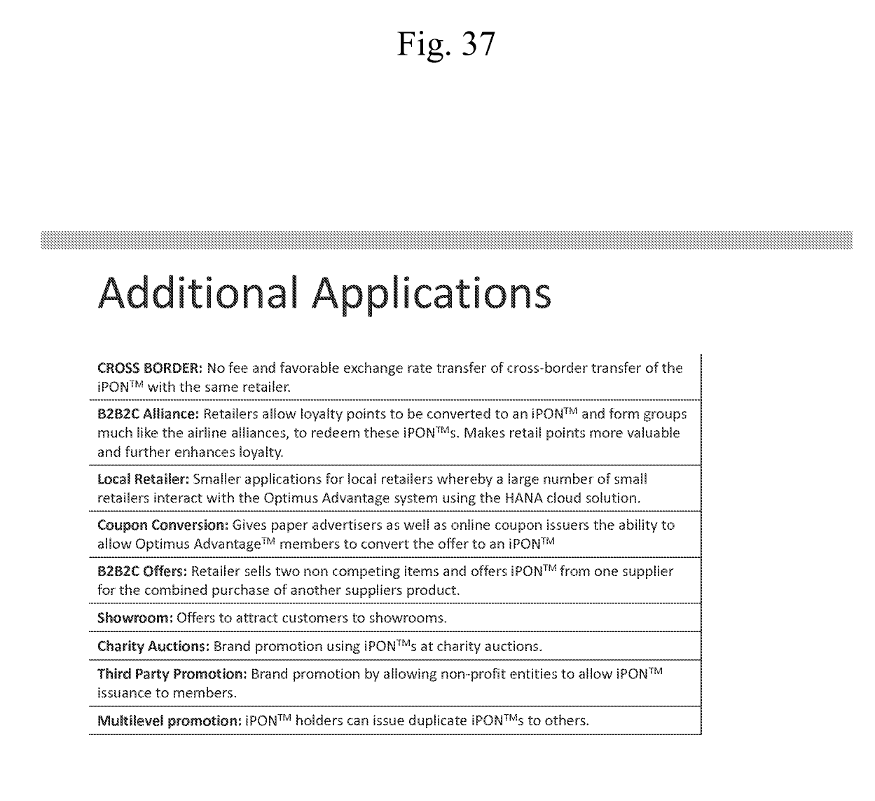

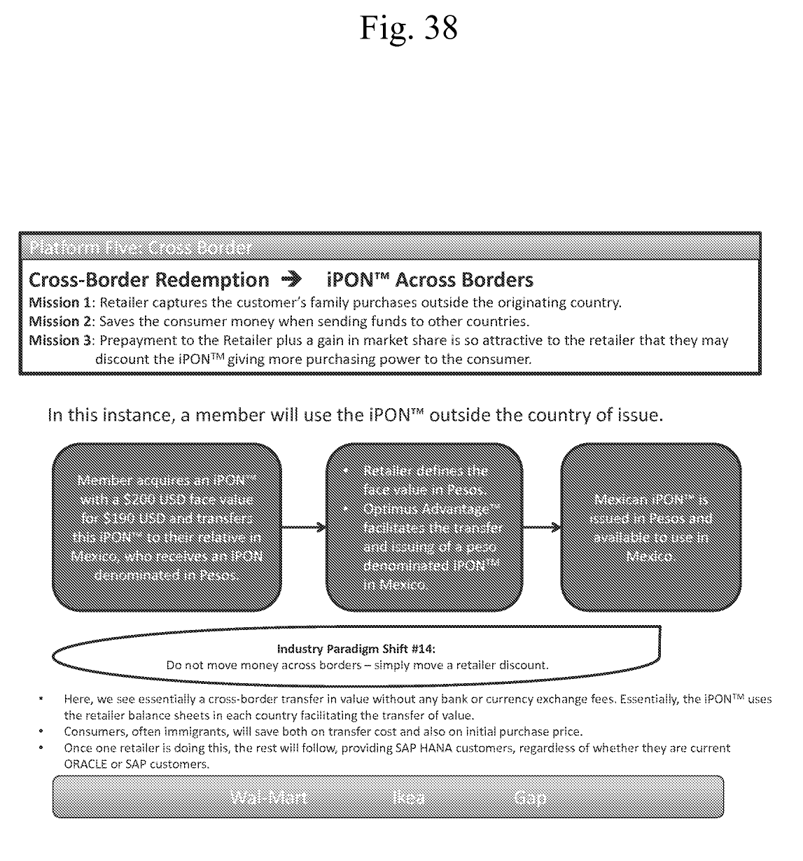

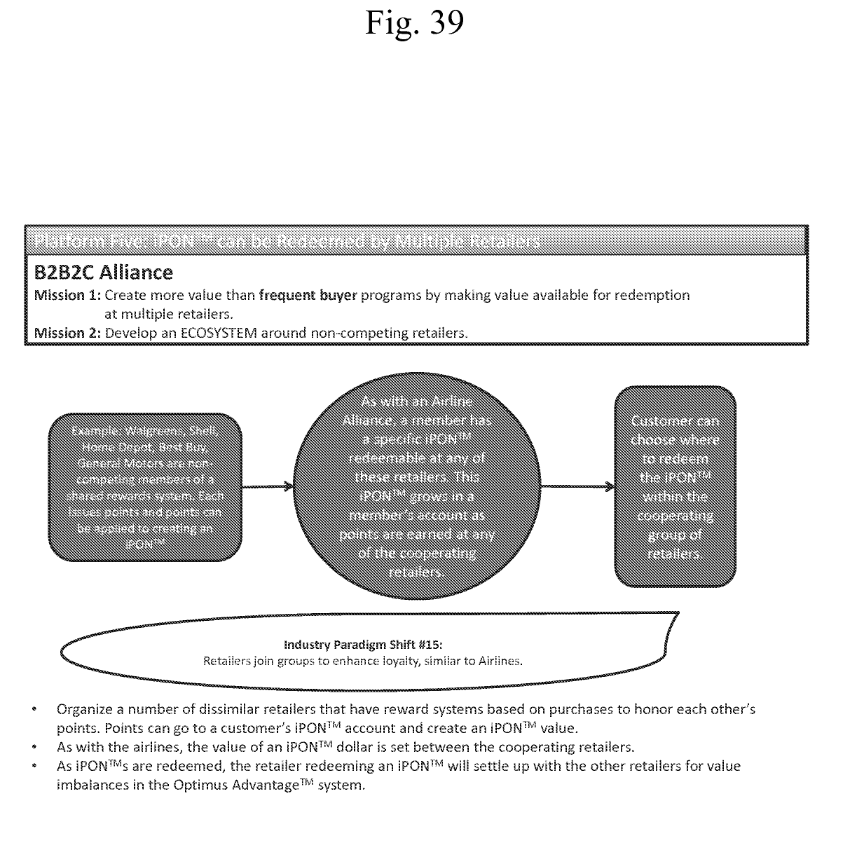

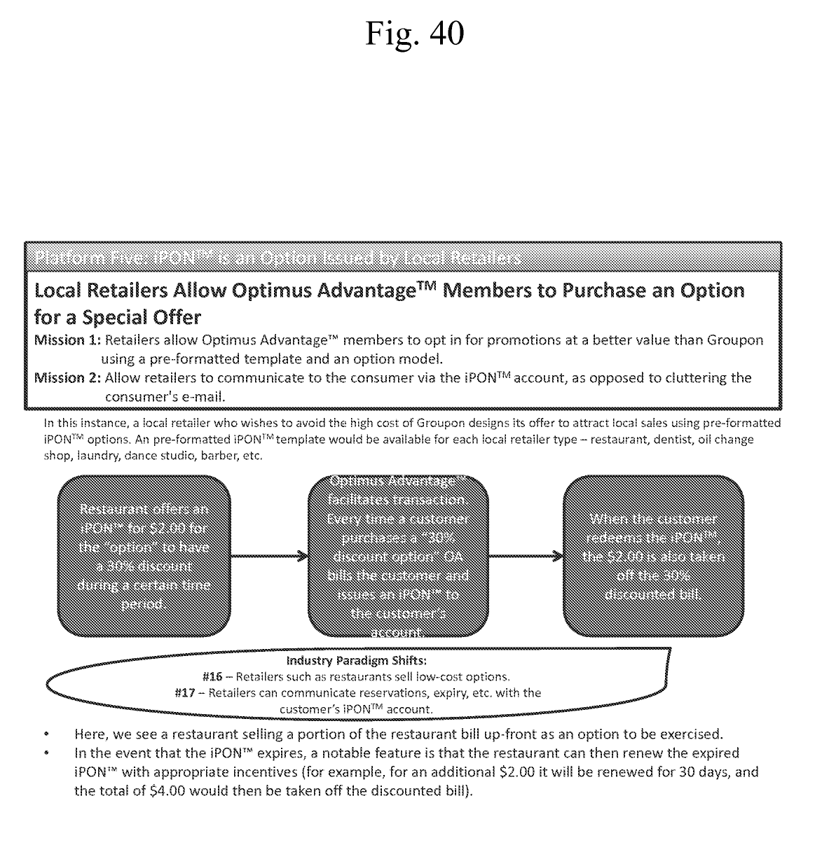

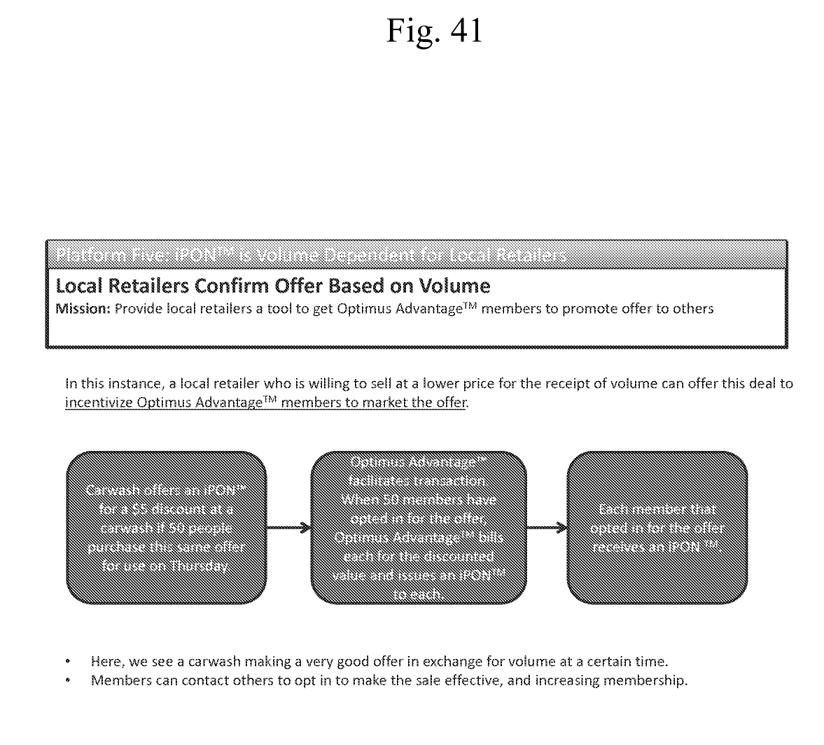

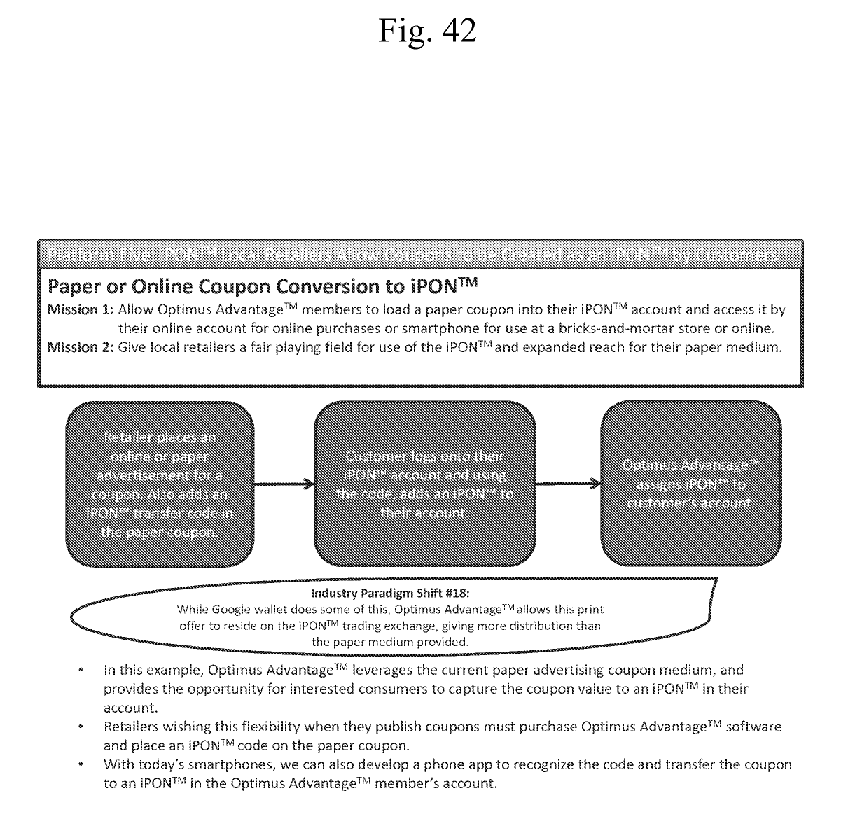

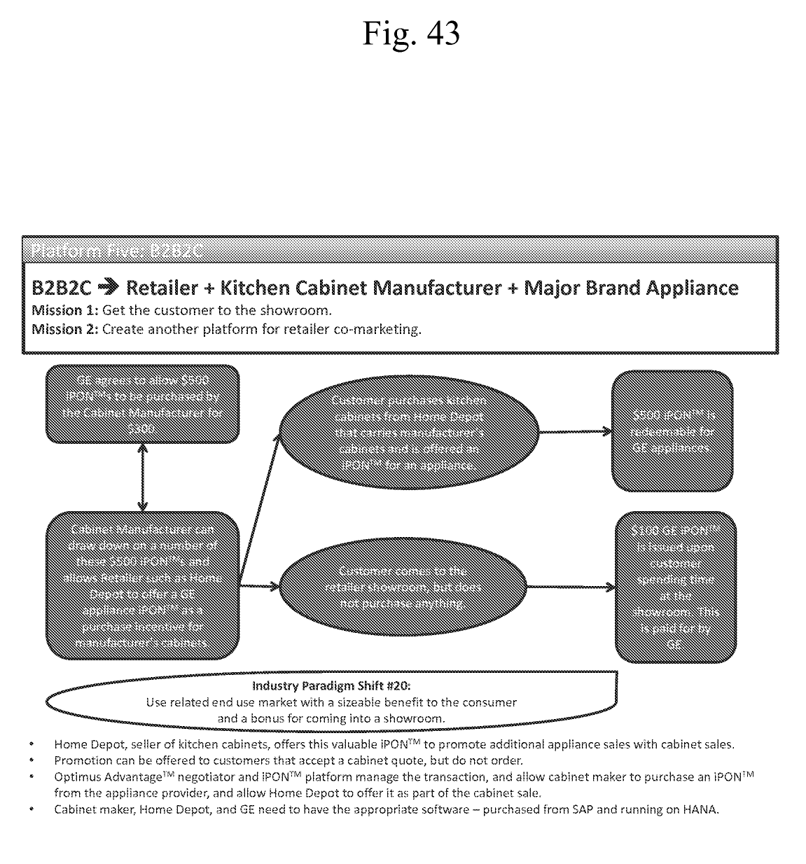

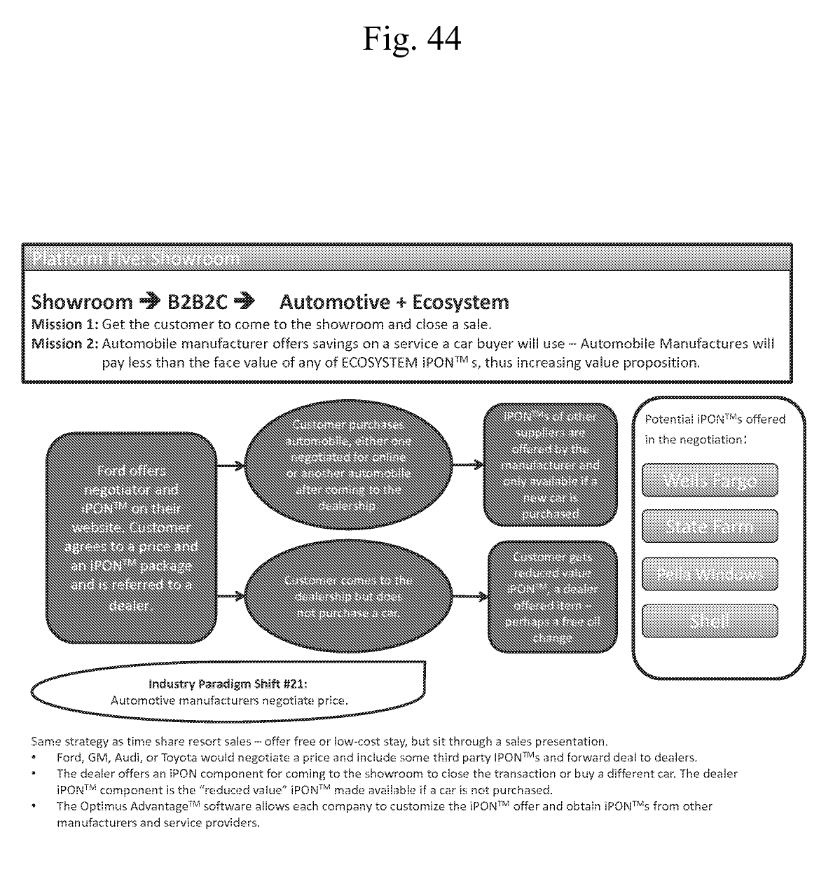

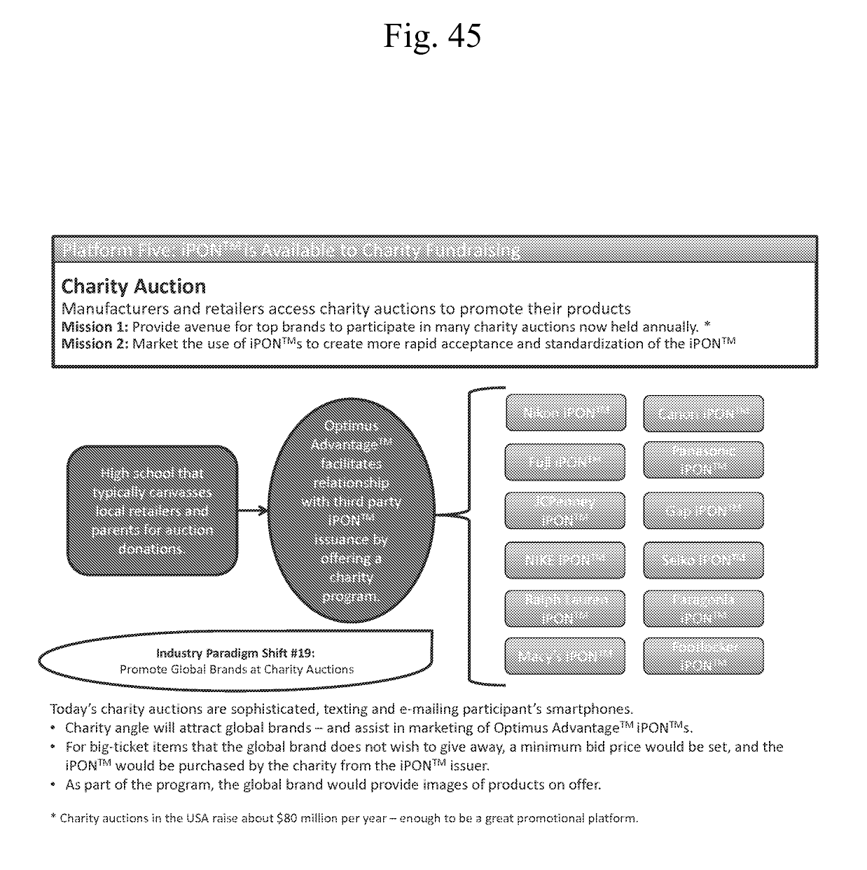

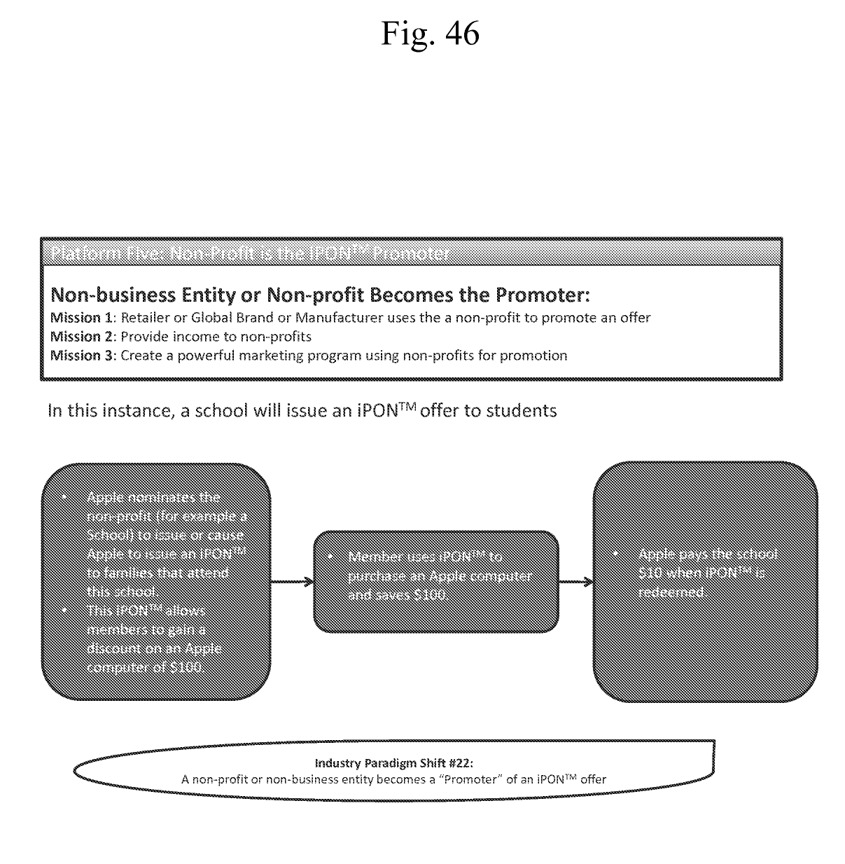

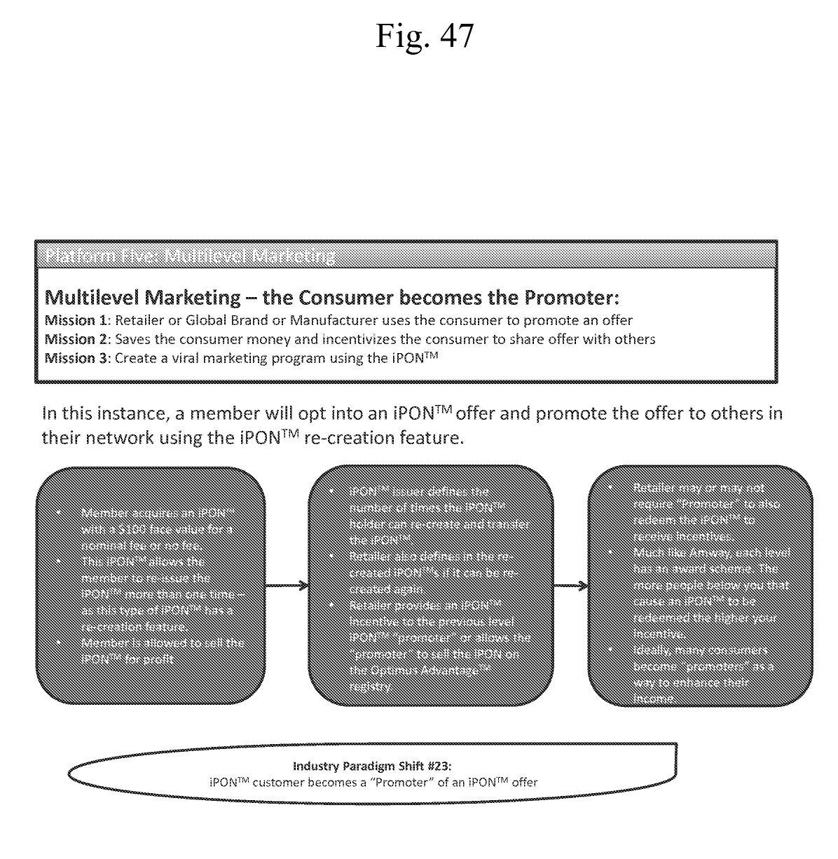

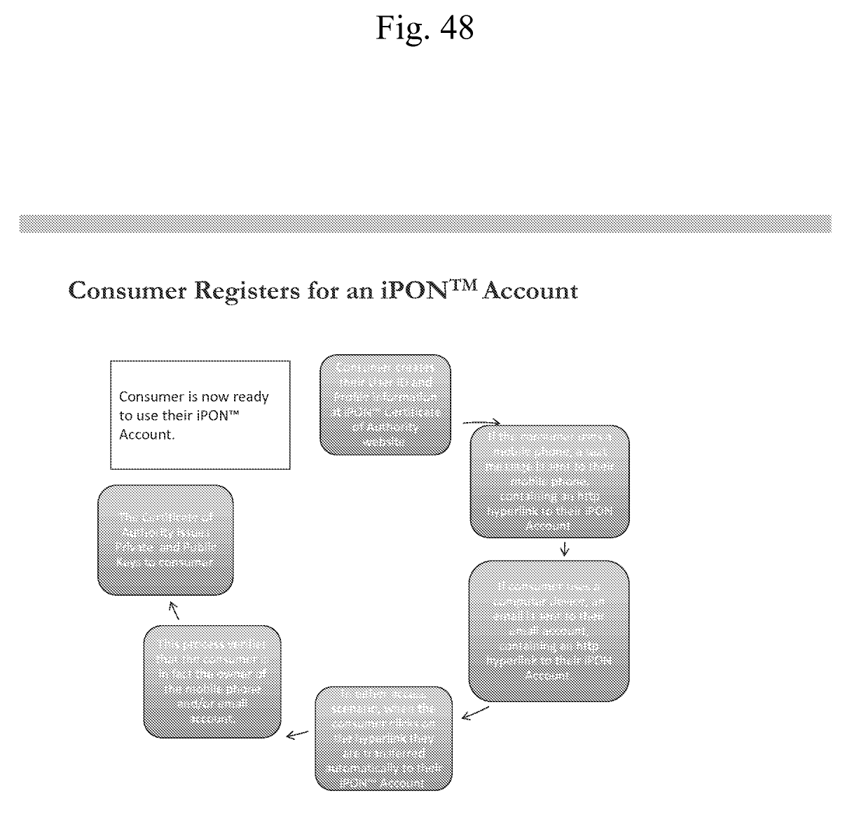

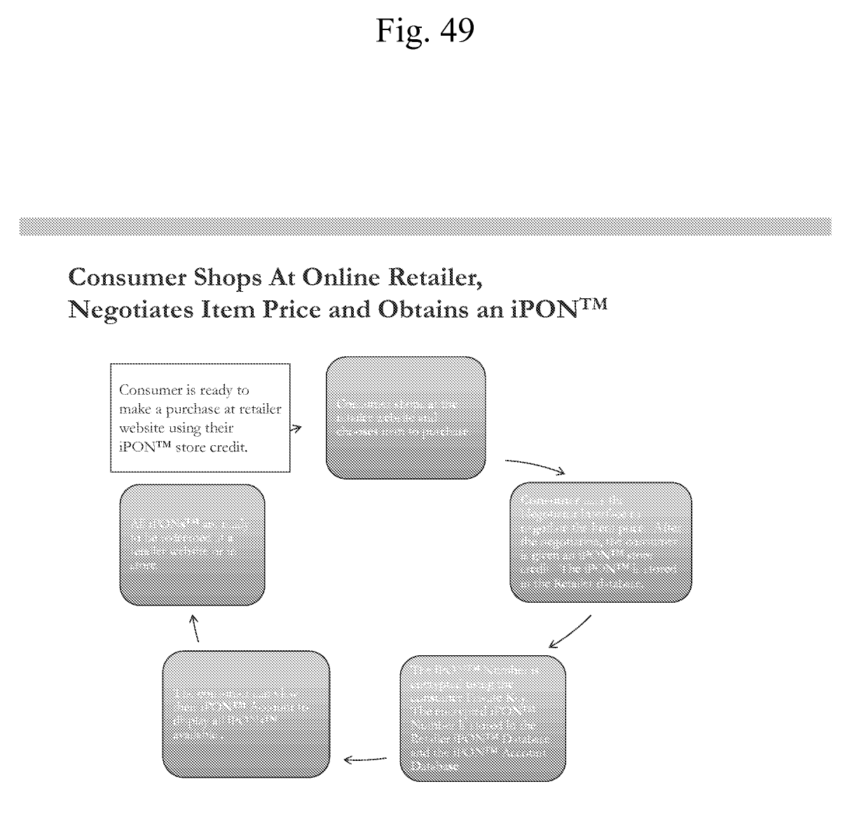

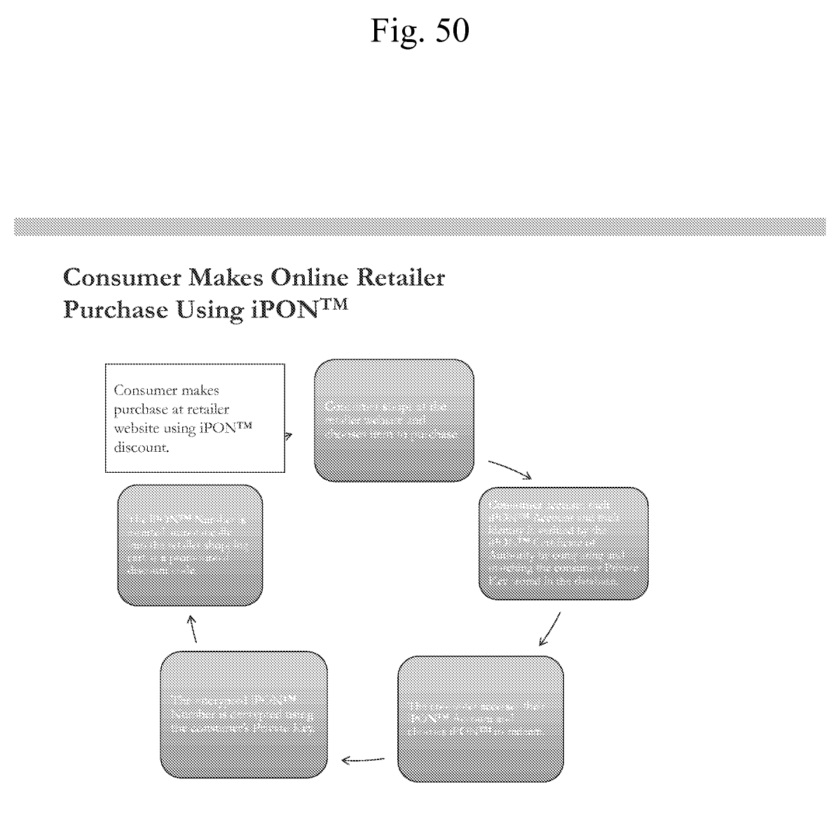

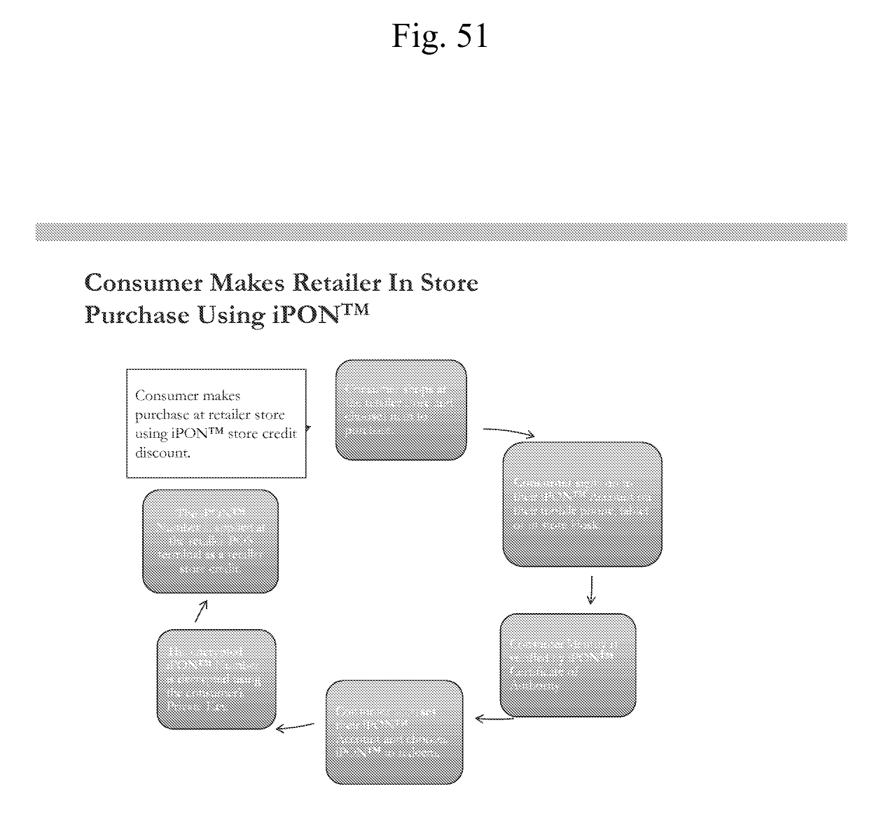

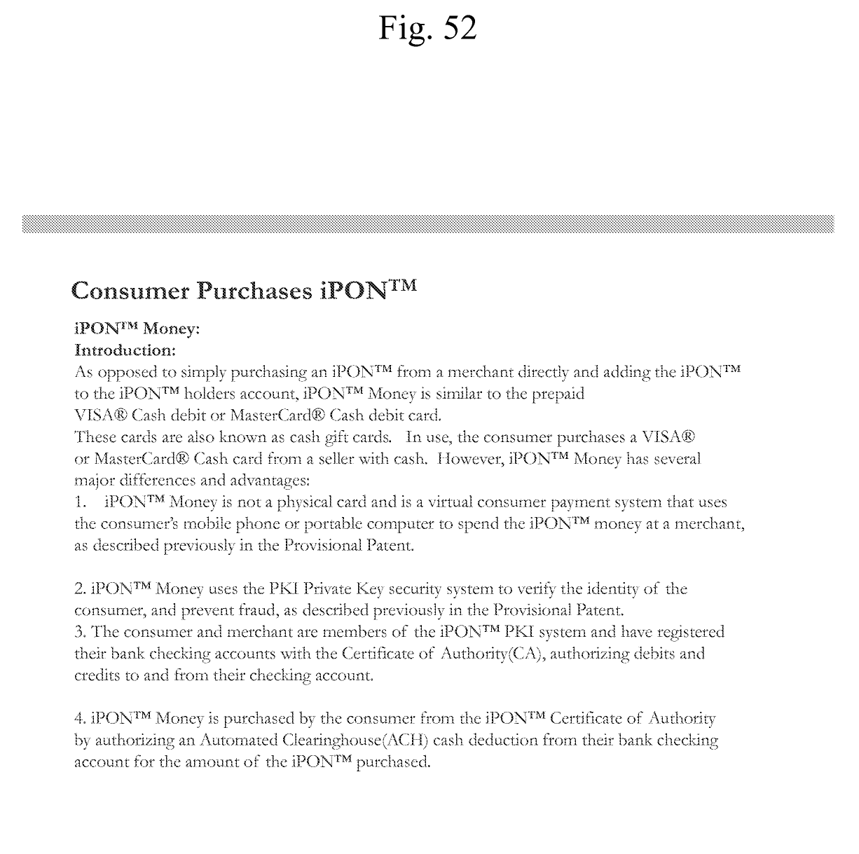

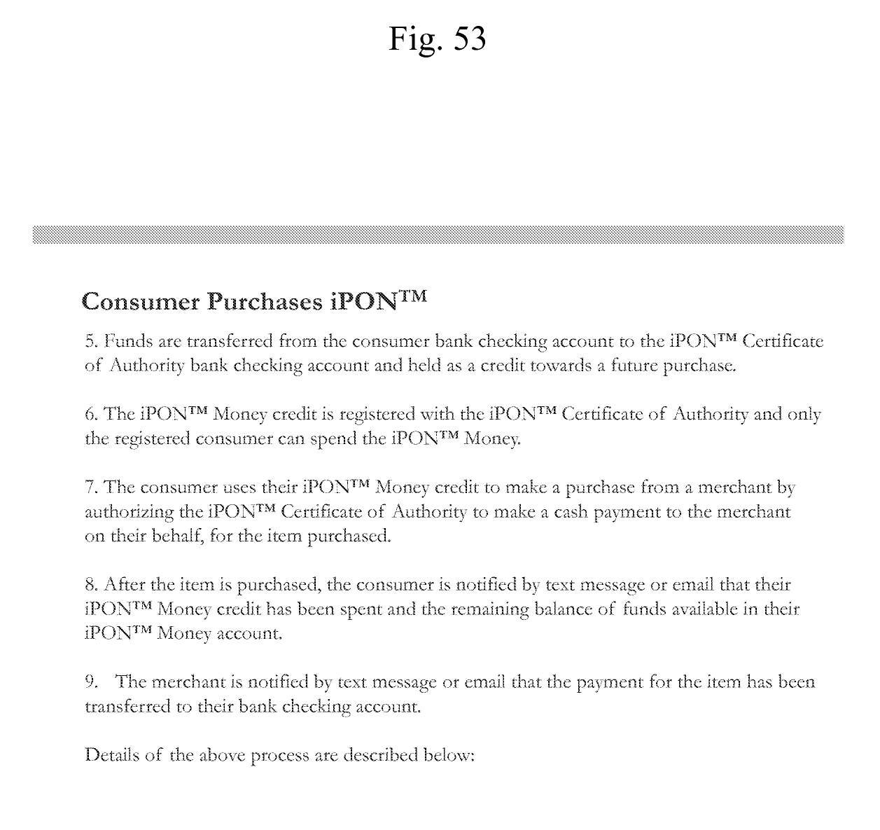

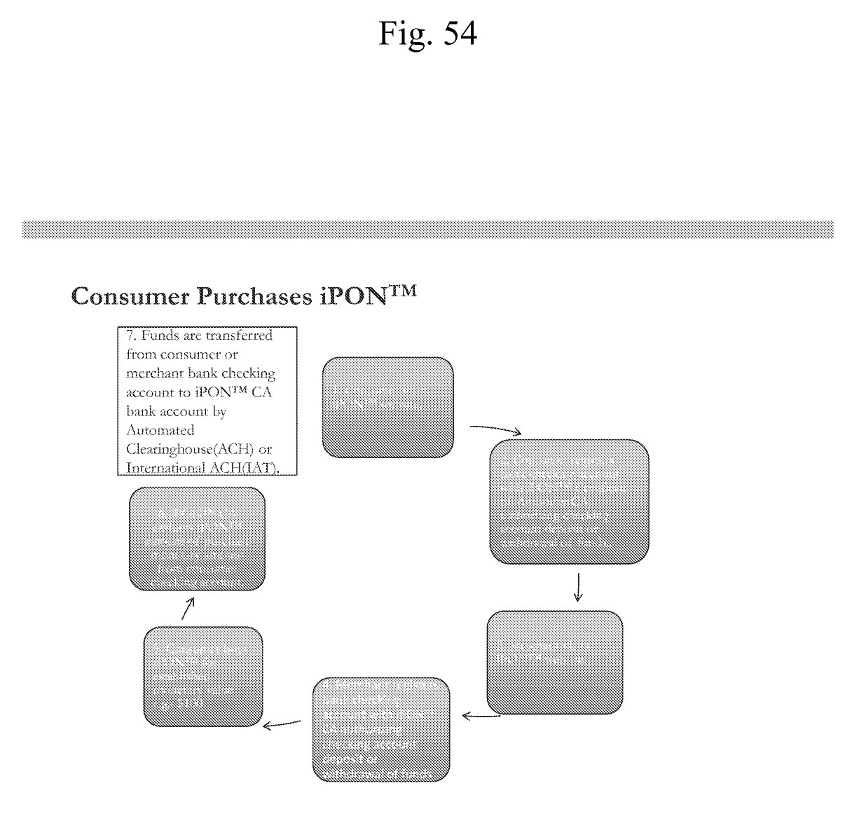

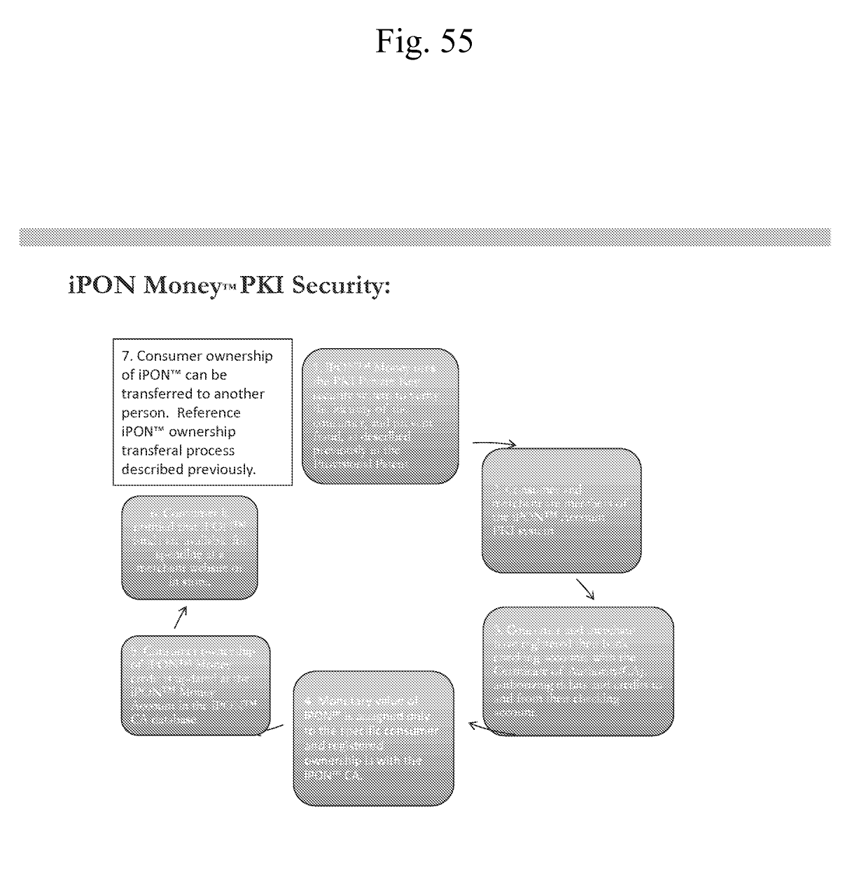

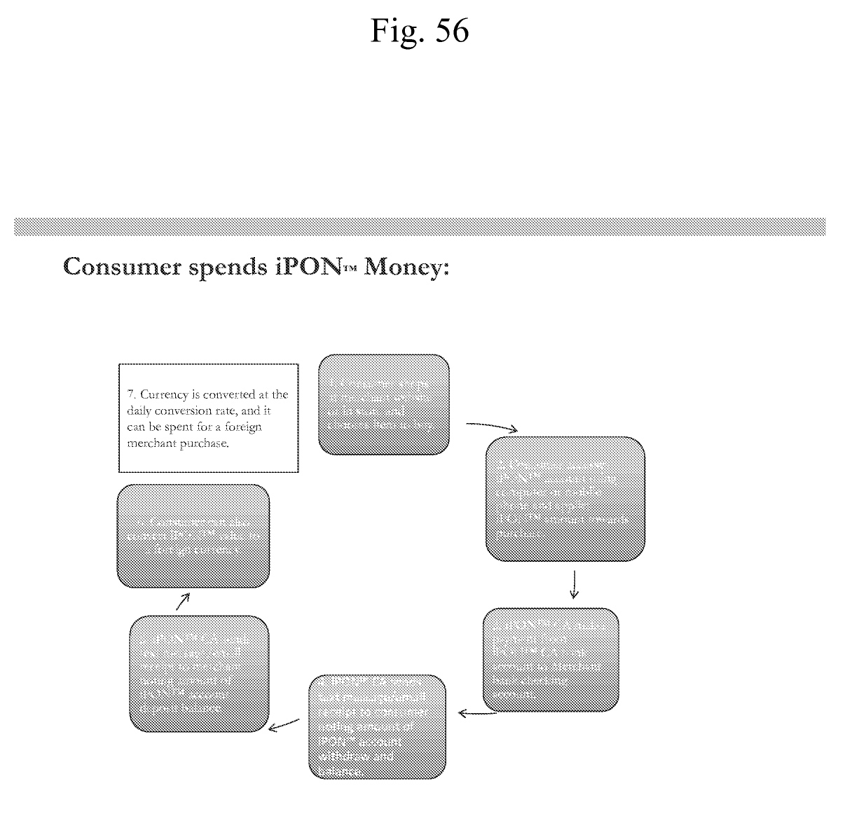

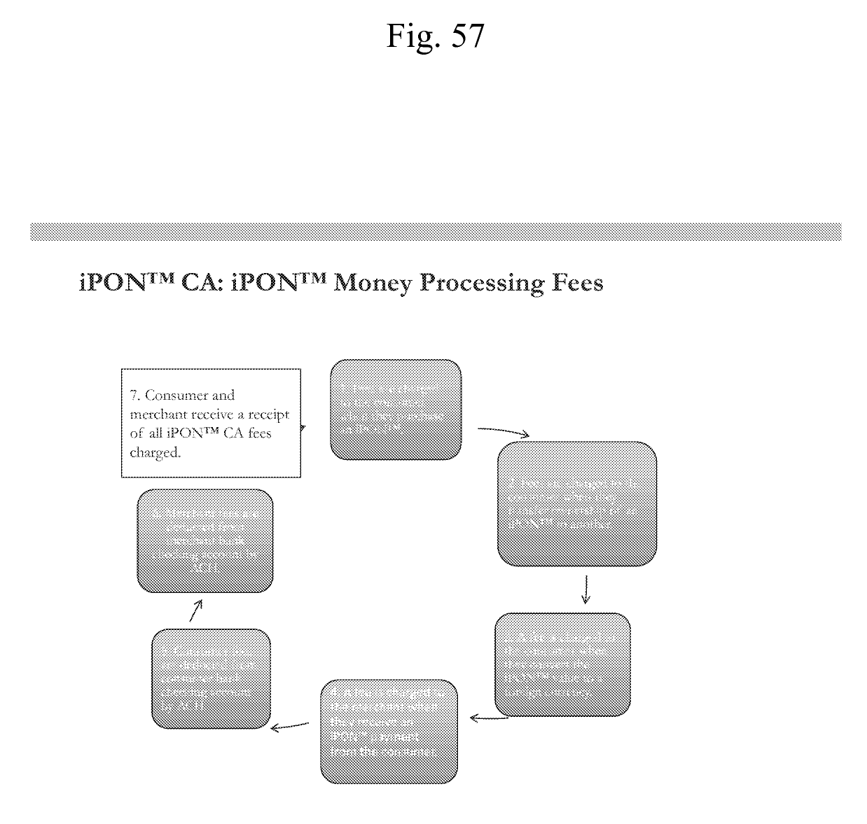

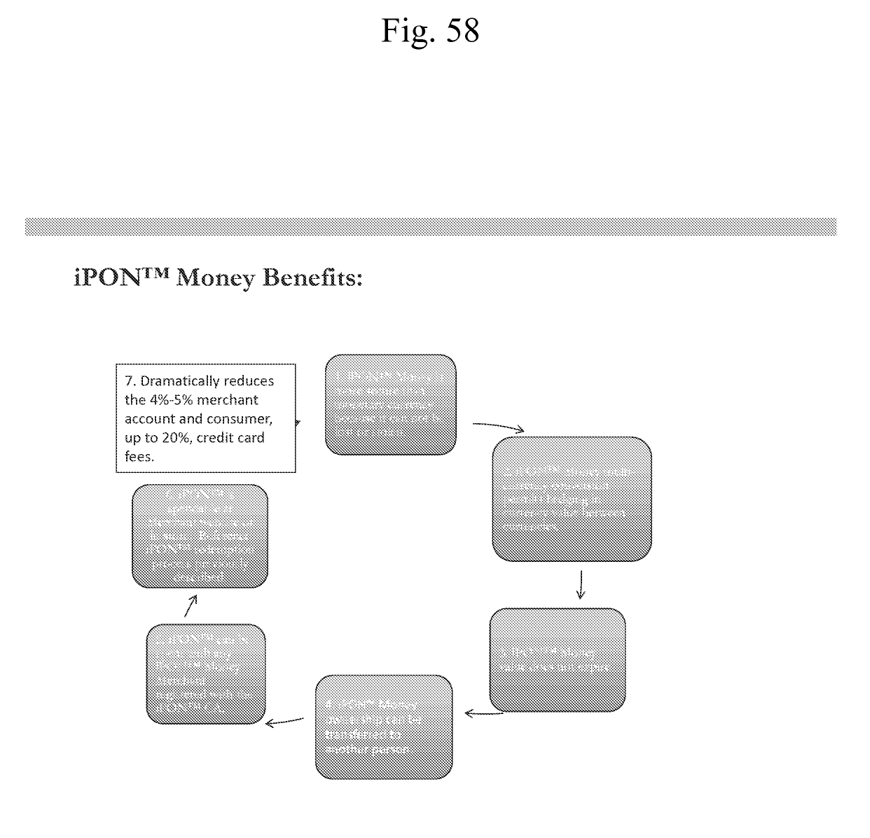

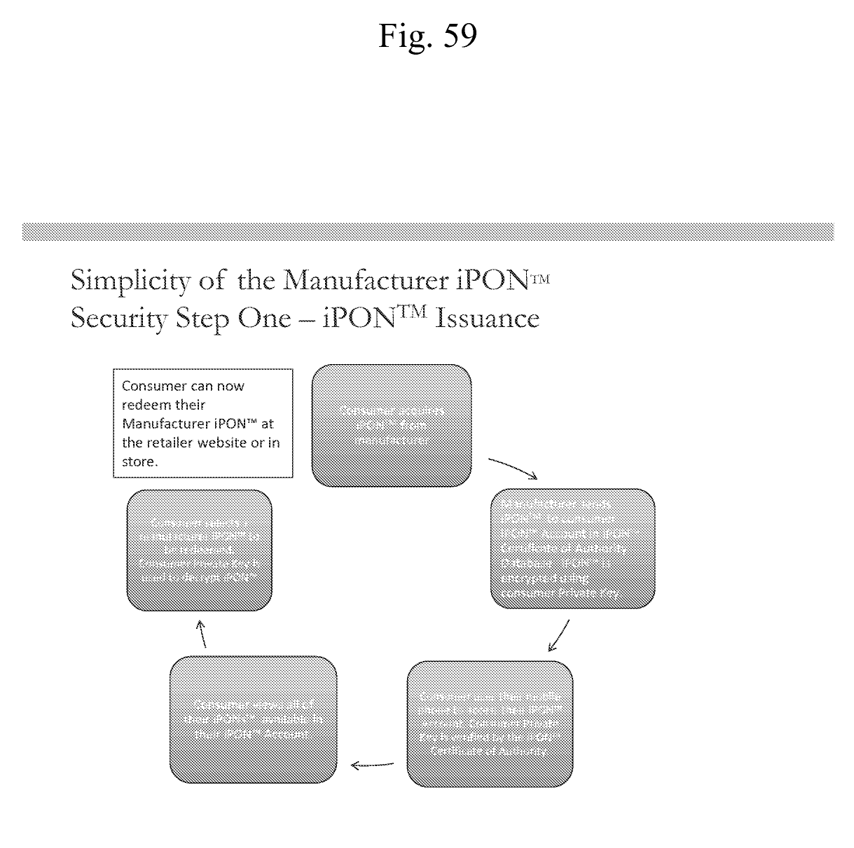

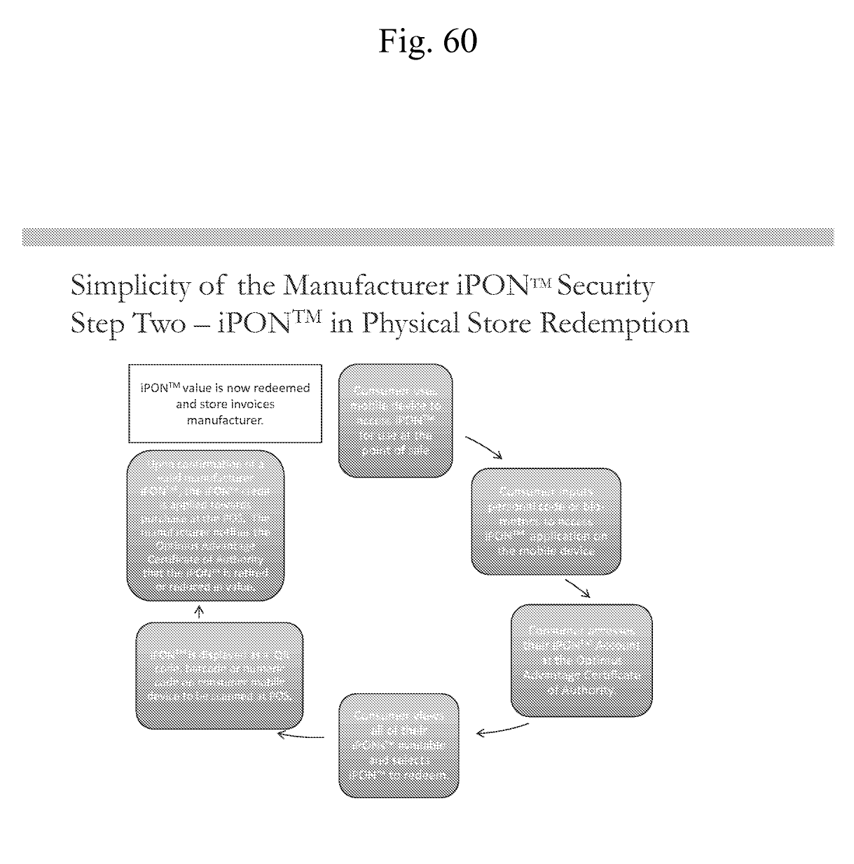

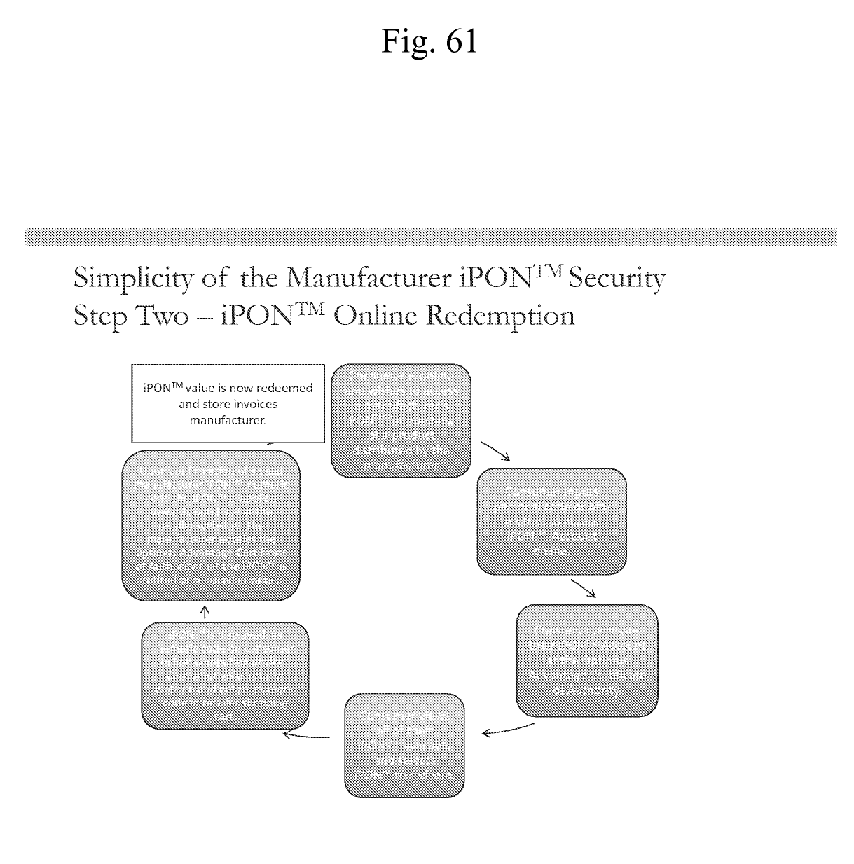

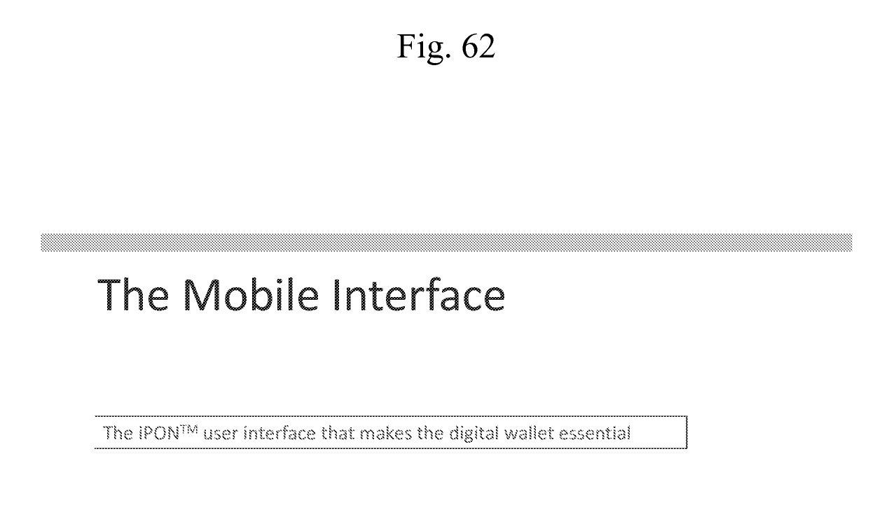

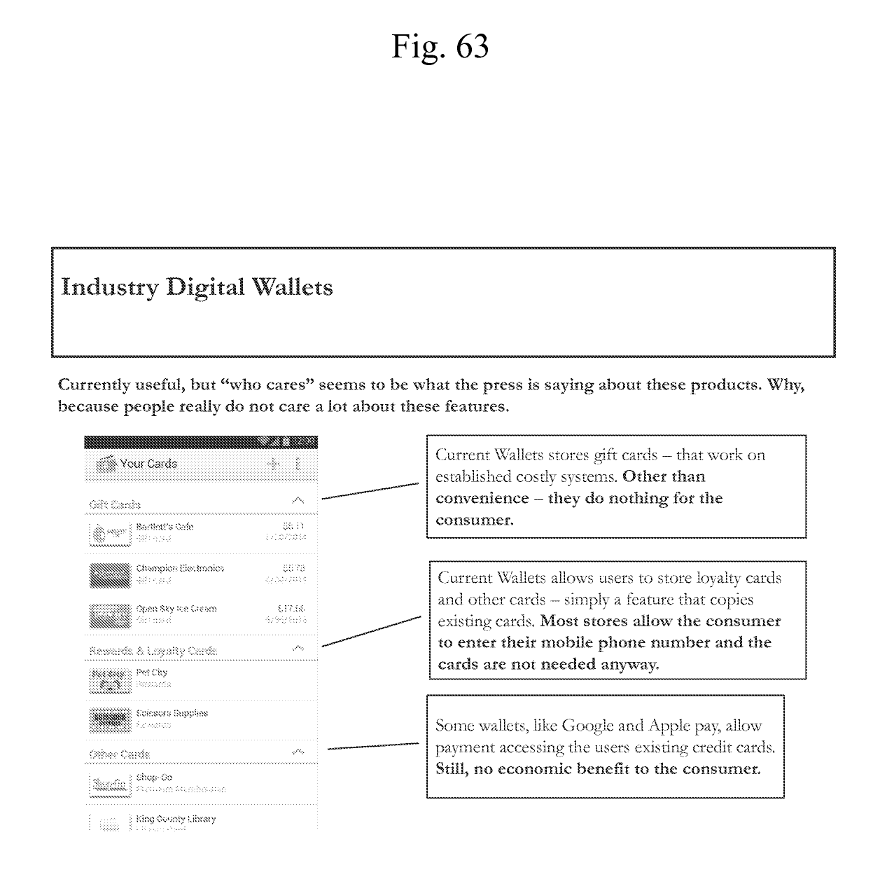

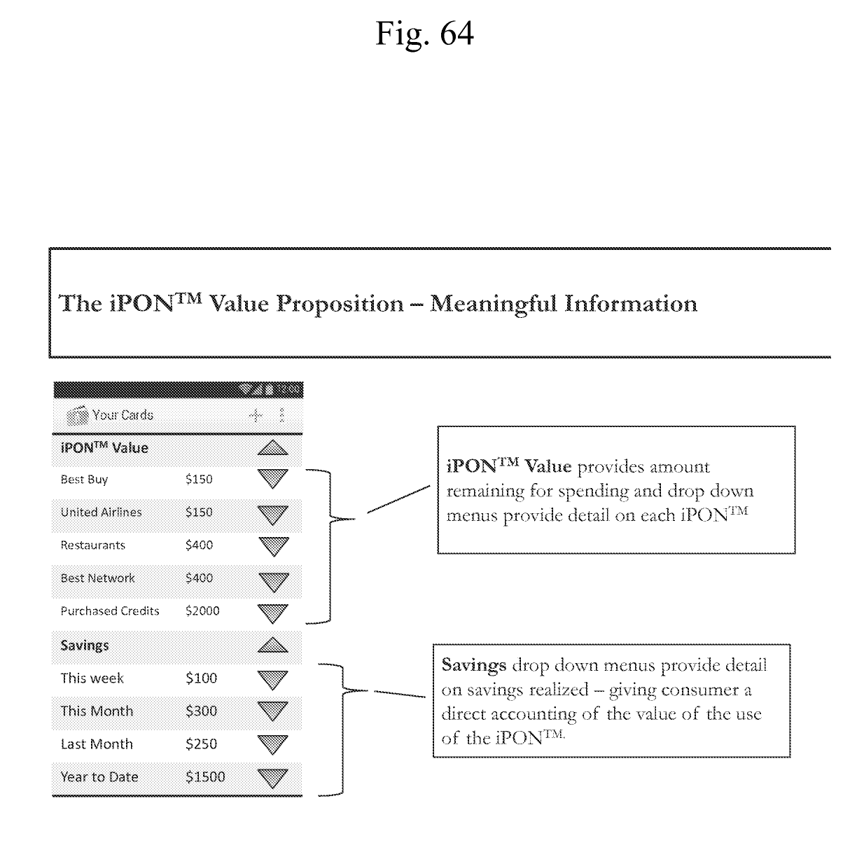

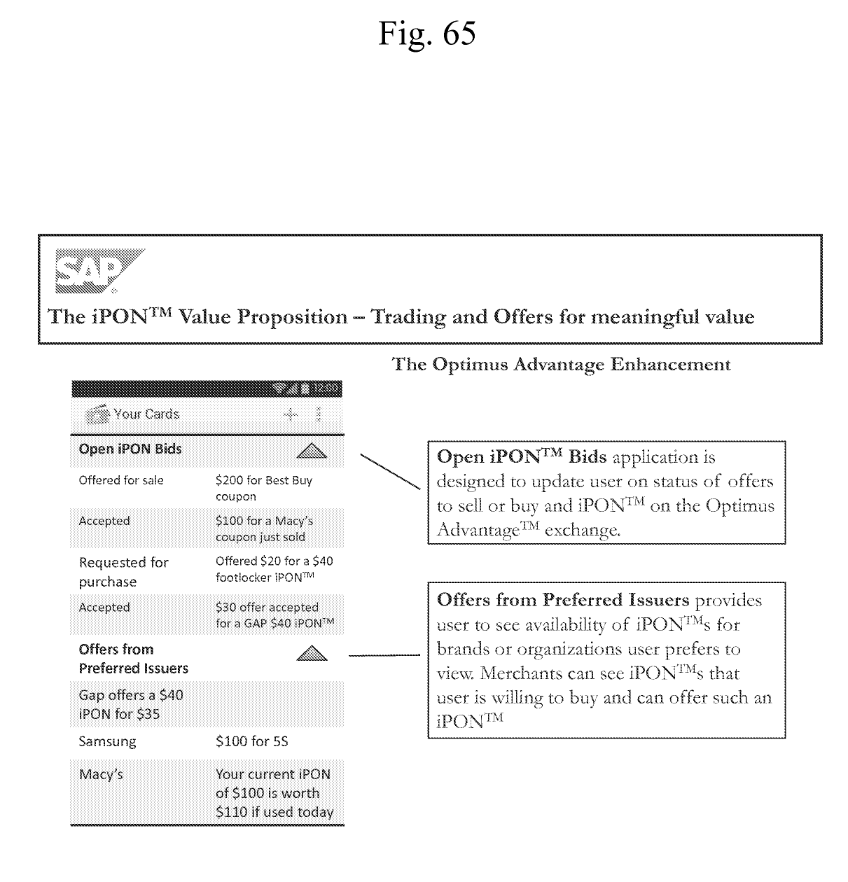

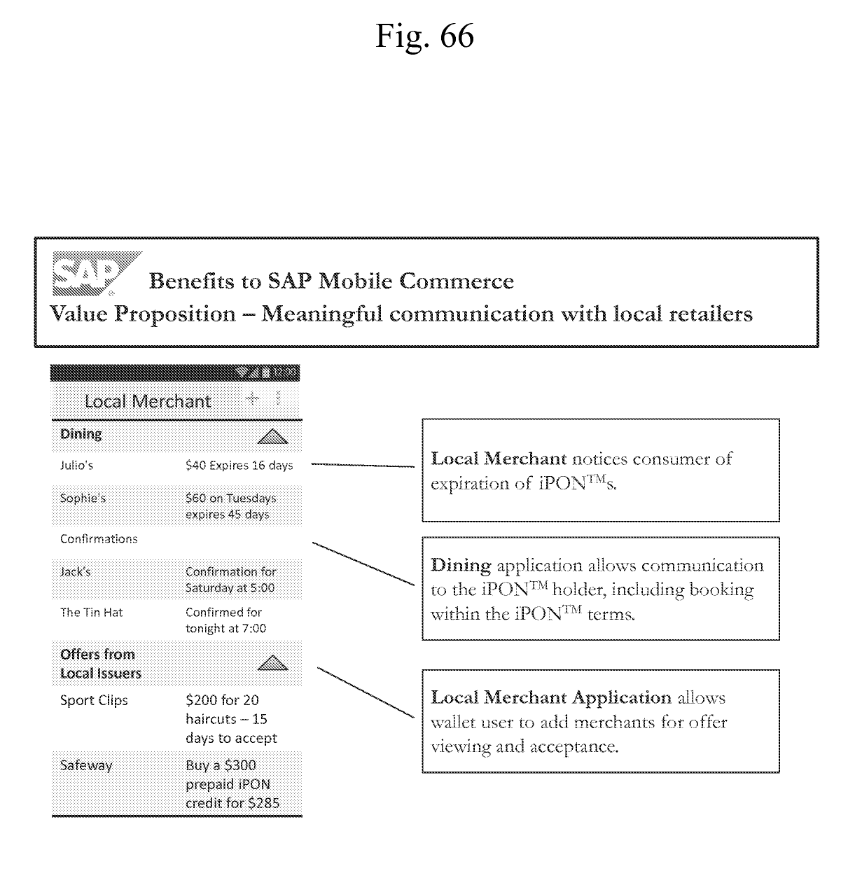

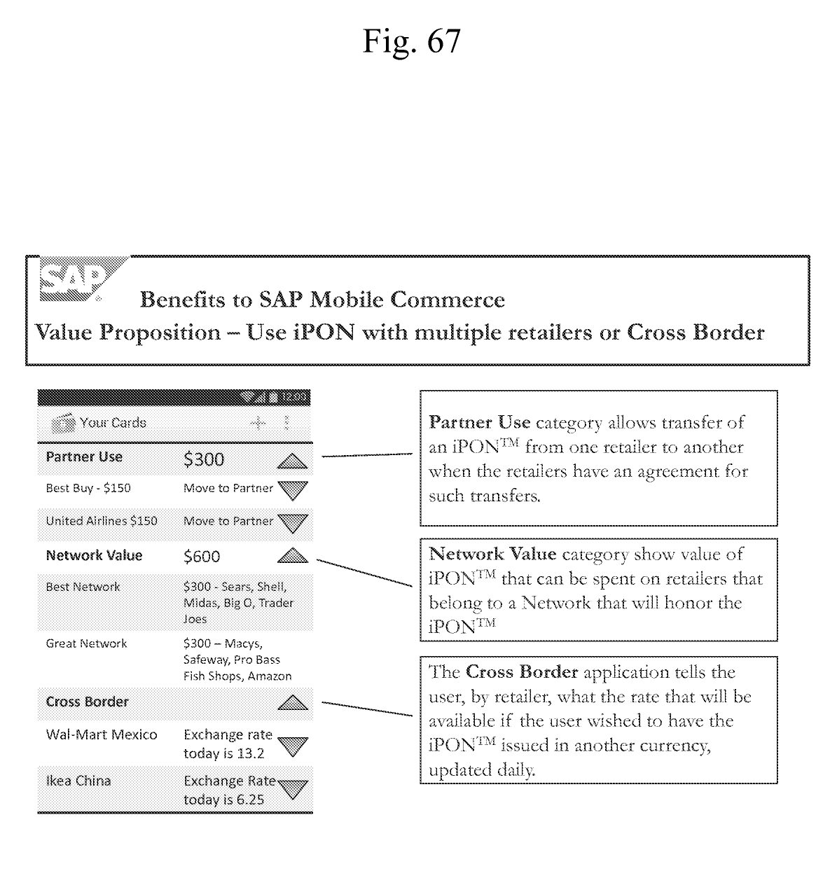

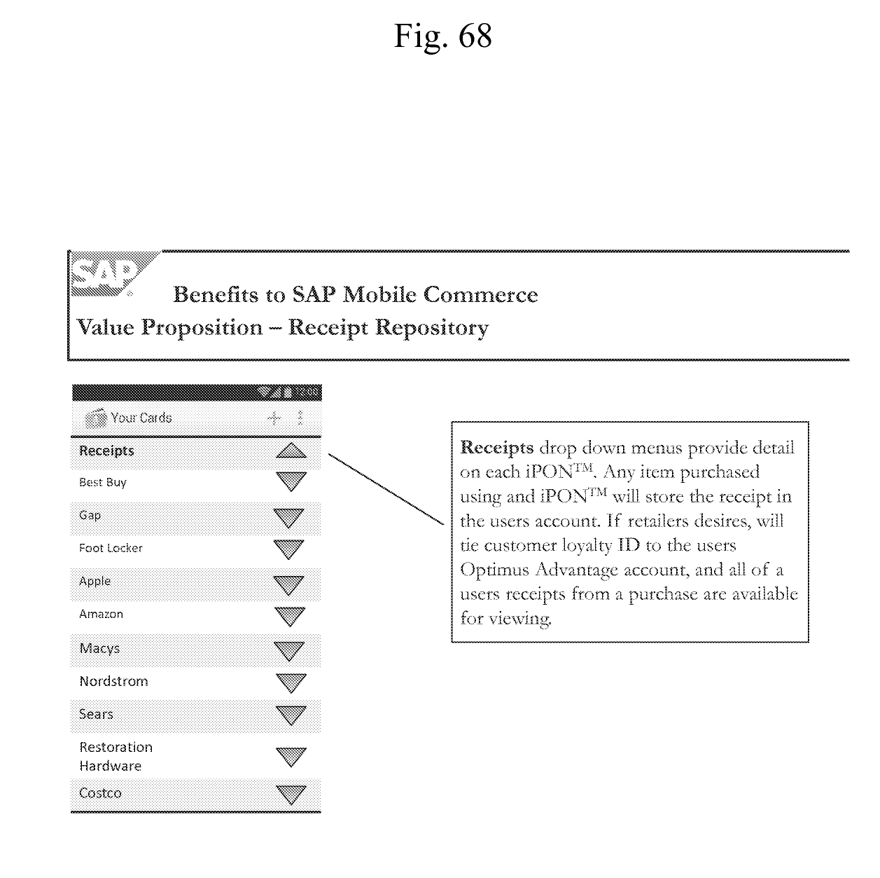

In one embodiment, as shown in FIG. 20, security is provided using the iPON™ Certificate of Authority Use of Public Key Infrastructure (PKI) The most unique and novel process that will be used to assure security is the methodology that this system uses in applying Public Key Infrastructure to redemption of the retailer iPON™. The security of using Public Key Infrastructure (PKI) is known to be very secure and extremely difficult to overcome. The iPON™ PKI based system will rely upon PKI to prevent fraud.

The novel method the Optimus Advantage Marketplace will use in applying the PKI to manage the registry of the user's iPON™s and to verify the identity of the user, before the user accesses the iPON™ residing in the Retailers iPON™ Database is as follows:
The security will be stronger than most PKI systems because access to the iPON™ is separate from the Retailer's iPON™ Database, and must be done through the security protocol of the Optimus Advantage Market place database and so hacking or breaching the Retailer iPON™ Database will not allow access to a specific iPON™ to transact with the Retailer's iPON™ Database.
Since the identity of the user is a necessary step to redeeming the iPON™ and this identity verification is done on the Optimus Advantage Marketplace Database before access is allowed to the retailer database. If the identity cannot verified by the PKI system, which is be resident on the Optimus Advantage Marketplace Registry, the transaction will be rejected.
By separating the iPON™ credits on one database (the retailers' data base for example) and access to the iPON™ through another database (the Optimus Advantage Marketplace Database or Certificate of Authority for example) the iPON™ that resides in the retailers' database remains very secure and simply hacking into the retailers' database will not allow use of the iPON™.

Examples of the use of an iPON™ and using Public Key Infrastructure To Manage Issuance of Retailer Store Credit and Customer Redemption include:

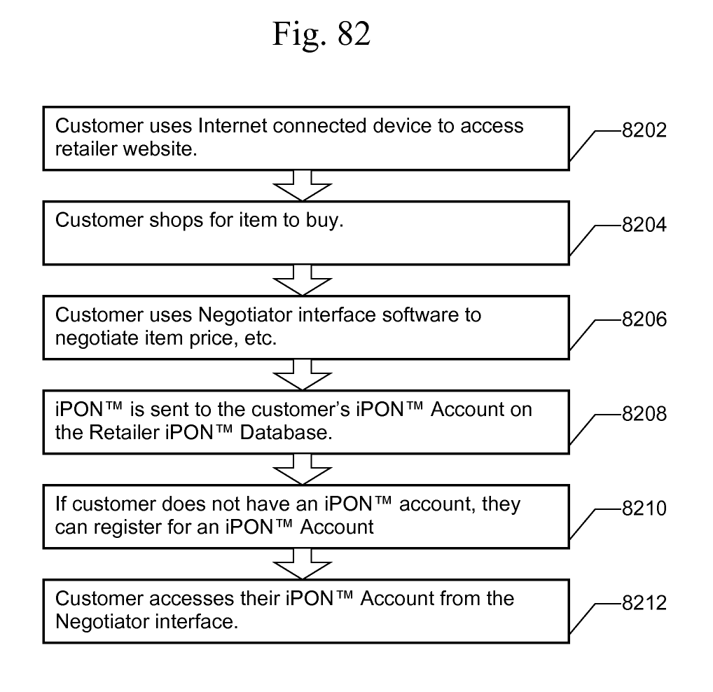

For example, in an embodiment shown in FIG. 82, a customer may shop at a retailer website. In block 8202, a customer uses Internet connected device to access retailer website. In block 8204, the customer shops for item to buy. In block 8206, the customer uses the Negotiator interface software to negotiate item price and receive intelligent coupon (iPON™); a store credit having a restricted monetary equivalent, such as a virtual gift card. In block 8208, an iPON™ is sent to the customer's iPON™ Account on the Retailer iPON™ Database. The iPON™ Number is converted to an Encrypted iPON™ Number using the customer's Private Key. This is accomplished using an algorithm hashing technique to transform the iPON™ Number into an Encrypted iPON™ Number. The iPON™ Number, Encrypted iPON™ Number and additional iPON™ information are all stored on the Retailer iPON™ Database. In block 8210, if the customer does not have an iPON™ account, they can register for an iPON™ Account with iPON™ Certificate of Authority. The Certificate of Authority resides in the Optimus Advantage Marketplace Registry and is responsible for issuing the public and private keys that are used by the PKI for establishing the identity of the user, verifying the identity of the user, and allowing only the issuer and the user to be able to encrypt and decrypt and iPON™ and any communication between the iPON™ issuer and the iPON™ holder. In block 8212, the customer accesses their iPON™ Account from the Negotiator interface.

The actions described in blocks 8208 and 8210 above also occur if the customer were to purchase and iPON™ or acquire an iPON™ from another source.

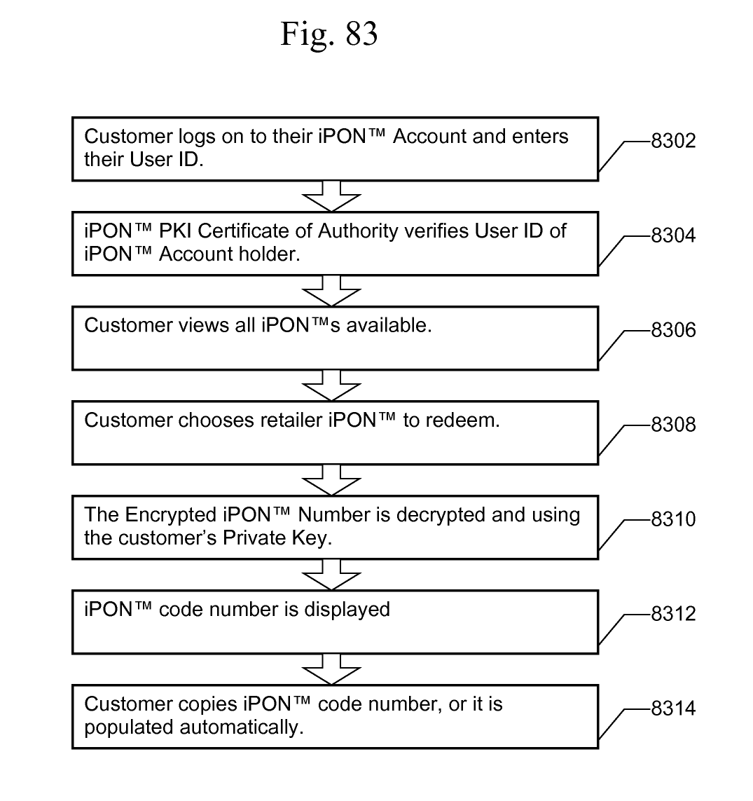

For example, in an embodiment shown in FIG. 83, a customer accesses their account to redeem an iPON™ using PKI to assure security. In block 8302, a customer logs on to their iPON™ Account and enters their User ID. Only registered users can access an iPON™ account. In block 8304, an iPON™ PKI Certificate of Authority verifies User ID of iPON™ Account holder. This is done in the Optimus Advantage Marketplace database communicating to the iPON™ holder's device. This is novel and a unique application of the PKI process as it is the Certificate of Authority that resides on the Optimus Advantage Marketplace database that communicates to the iPON™ holder's device. Once the Optimus Advantage Marketplace database confirms the device has the private key that matches the Certificate of Authority private key on file for that user, by commutating with the private key resident on the users device, access to the account is allowed. Only then can the iPON™ holder access the iPON™ that resides on the iPON™ issuer's database.

In the event more security is desired, then the following is available as well: a) If the customer is using a mobile phone, a text message is sent to their mobile registered phone number containing an http hyperlink to their iPON™ Account. b) If the customer is using a computer type device, an email is sent to their registered email account containing an http hyperlink to their iPON™ Account. c) In either access scenario, when the customer clicks on the hyperlink, or the software on their device automatically accesses this hyperlink, they are transferred automatically to their iPON™ Account.

In block 8306, the customer views all iPON™s available. In block 8308, the customer chooses a retailer iPON™ to redeem. In block 8310, the Encrypted iPON™ Number is decrypted and converted to an iPON™ Number using the customer's Private Key. In block 8312, the iPON™ code number is displayed. In block 8314, the customer copies the iPON™ code number or it is populated automatically into the retailer's shopping cart, and applied towards the item purchase. The customer the purchases the item and a receipt for the purchase is sent to the customer iPON™ Account.

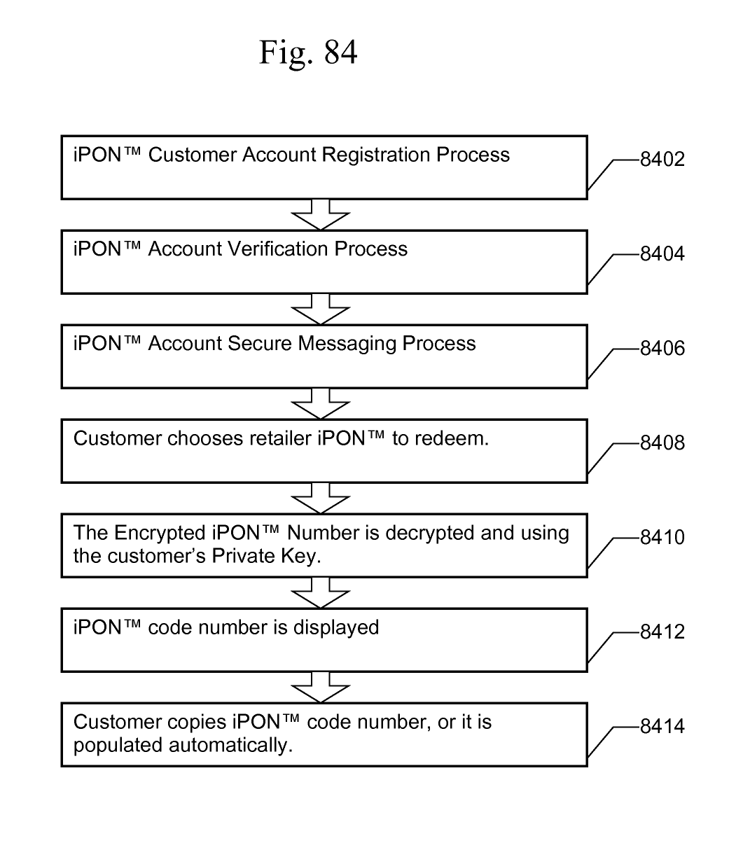

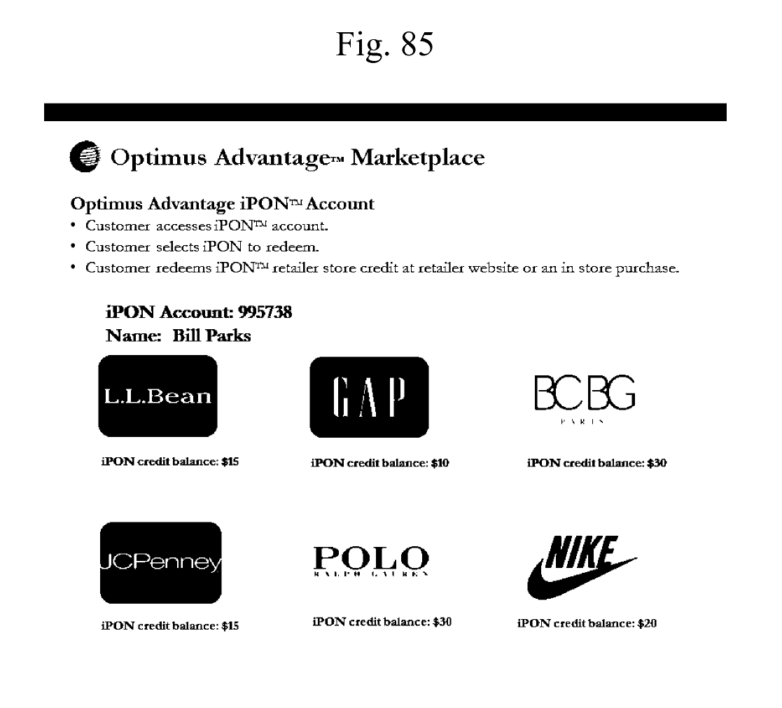

For example, in an embodiment shown in FIG. 84, an iPON™ Customer Account may be setup. It is best viewed in conjunction with FIG. 85. In block 8402, an iPON™ Customer Account Registration Process is performed. Only registered users can access an iPON™ Accounts. To register, the customer creates their User ID and Profile information at iPON™ Certificate of Authority website. The customer registers their mobile phone and email address. In block 8404, an iPON™ Account Verification Process is performed. If the customer is using a mobile phone, a text message is sent to their mobile registered phone number containing an http hyperlink to their iPON™ Account. If the customer is using a computer type device, an email is sent to their registered email account containing an http hyperlink to their iPON™ Account. In either access scenario, when the customer clicks on the hyperlink they are transferred automatically to their iPON™ Account. This process verifies that the customer is in fact the owner of the mobile phone and/or email account.

In block 8406, an iPON™ Account Secure Messaging Process is performed. The iPON™ Certificate of Authority issues the iPON™ Account customer Private and Public Keys. The Private Key is used by the Certificate of Authority to verify the identity of the iPON™ customer. The Private Key is also used by the customer to encrypt and send an email or text message and create a digital certificate. The digital certificate can be used by the recipient of the message to verify the identity of the sender, if they are part of the iPON™ Public Key Infrastructure.

The Private Key is stored on the customer computing device or mobile phone and is verified by the Certificate of Authority when the customer signs on to their iPON™ Account. If the Private Key matches the Private Key issued by the Certificate of Authority, then access to the iPON™ account is permitted. If the Private Key does not match, then access is denied to the iPON™ Account.

The Public Key is used to send an encrypted message by email or text message to the iPON™ Account holder. This is accomplished by the sender accessing the iPON™ Certificate of Authority website and clicking on the Public Key icon associated with name of the intended recipient. The sender composes their message and it is encrypted and sent to the recipient. The recipient uses their Private Key to decrypt the email or text message.

The iPON™ Certificate of Authority can also revoke an iPON™ customer Private and Public Keys to disable the iPON™ Account.

In block 8408, an iPON™ Public Key Infrastructure (PKI) Verifies iPON™ Customer is performed. The iPON™ System uses a Public Key Infrastructure to manage registration of retail customers to create an iPON™ Account. The following information may be created in an iPON™ Account by the iPON™ Certificate of Authority. a) iPON™ Customer ID: Customer creates their own unique Customer ID. b) iPON™ Customer Private and Public Keys: Unique Private and Public Keys are assigned to each iPON™ Account holder. c) Customer iPON™ Account Profile: Customer adds additional information such as name, shopping preferences, Facebook account, Twitter account, mobile phone number and/or email address etc.

The Private Key is stored on the customer computing device or mobile phone and is verified by the Certificate of Authority when the customer signs on to their iPON™ Account. If the Private Key matches the Private Key issued by the Certificate of Authority, then access to the iPON™ account is permitted. If the Private Key does not match, then access is denied to the iPON™ Account.

The Public Key is used to send an encrypted message by email or text message to the iPON™ Account holder. This is accomplished by the sender accessing the iPON™ Certificate of Authority website and clicking on the Public Key icon associated with name of the intended recipient. The sender composes their message and it is encrypted and sent to the recipient. The recipient uses their Private Key to decrypt the email or text message.

The iPON™ Certificate of Authority can also revoke an iPON™ customer Private and Public Keys to disable the iPON™ Account.

Definitions of some iPON™ System Terms are as follows.

Public Key Infrastructure (PKI): A secure communication system for sending and receiving encrypted information between customers and retailers using the PKI system. After the identity of the customer is verified by the Certificate of Authority, Public and Private Keys are issued by the Certificate of Authority to individual customers. Private information is encrypted using the Public Key of the recipient of the information. The recipient uses their Private Key to decrypt the message sent.

iPON™ Certificate of Authority: The agency issuing the Public and Private Keys to individual customers using the PKI. Only customers having Public and Private Keys can send/receive messages and redeem their iPON™s. The certificate of authority would reside at the Optimus Advantage Marketplace registry.

iPON™ Customer Number: A unique number assigned by the iPON™ Certificate of Authority to the customer.

iPON™ Customer Public Key: A unique pattern of alpha and numeric symbols associated only with an individual iPON™ Account holder. Used to encrypt information sent to the recipient.

iPON™ Customer Private Key: A unique pattern of alpha and numeric symbols associated only with an individual iPON™ Account holder. The Private Key is used to decrypt encrypted information received.

iPON™ Retailer: The retailer issuing an iPON™ as a store credit having a restricted monetary equivalent, such as a virtual gift card.

iPON™ Number: A unique number assigned to an iPON.

Encrypted iPON™ Number: A unique alpha/numeric pattern created after applying a Private Key algorithm to the original iPON™ Number and encrypting it into a new alpha/numeric pattern.

iPON™ Value: A restricted monetary equivalent, such as a virtual gift card.

iPON™ Redemption: After the iPON™ is redeemed by the customer at the retailer website, the iPON™ Certificate of Authority is paid a transaction fee by the retailer.

iPON™ Certificate of Authority Transaction Fee: After the iPON™ is redeemed by the customer, the iPON™ Certificate of Authority is paid a transaction fee by the retailer. This fee is a predetermined amount for redeeming the iPON™ and removing customer access to the iPON™.

Payment of Transaction Fee to iPON™ Certificate of Authority: Payment of the transaction fee to the iPON™ Certificate of Authority is via an electronic money service, such as Automated Clearinghouse (ACH), PayPal or other similar electronic monetary value system.

In one embodiment, there may be an iPON™ Certificate of Authority that resides in the Optimus Advantage Marketplace database. The customer accesses the iPON™ Certificate of Authority to use their iPON™ Account and to get their iPON™ and to redeem it at a retailer website. The iPON™ Certificate of Authority grants the customer access to their iPON™ Account stored on the Retailer iPON™ database. In this manner, the iPON™ Certificate of Authority is the 3^{rd} party security service to verify the identity of the iPON™ Account holder. The iPON™ Certificate of Authority enables the iPON™ Account holder to access their iPON™ Account on the iPON™ Customer Database. After the identity of the customer is verified by the iPON™ Certificate of Authority, they are connected to the Retailer iPON™ Database to view the details of their iPON™s stored on the Retailer iPON™ database. The value of this PKI based system is that computer hackers will not be able to correlate user sign-on information at the iPON™ Certificate of Authority Database, with iPON™ information stored on the Retailer iPON™ Database. Further, this system design permits the retailer to control the iPON™ in terms of issuing, updating, cancelling and other retailer specific maintenance of the iPON™.

In one embodiment, an iPON™ Customer Database may be Maintained by the iPON™ Certificate of Authority. The following database table describes the fields that are present in the iPON™ Account record of the iPON™ Customer Database. The unique personal Customer ID is used to identify the customer. The iPON™ Account record also contains additional personal information fields associated with the Customer ID. The Customer Private Key is used to encrypt the iPON™ number into an encrypted iPON™ number. This process associates the Customer ID with the ownership of the iPON™.

iPON™ Customer Database Table:

| | | iPON ™ | | | iPON ™ | |
|---|---|---|---|---|---|---|
| iPON ™ | iPON ™ | Customer | | | Number encrypted | |
| Customer | Customer | Profile | iPON ™ | iPON ™ | using Customer | iPON ™ |
| ID Number | Private Key | Information | Retailer | Number | Private Key | Value |
| 271555 | EOI28LSXT | Name | J. CREW | 8392 | 43973 | $25 |
| | | Phone | BCBG | 3766 | 397289 | $20 |
| | | Number | | | | |
| | | Email | GAP | 21988 | 38772 | $10 |
| | | address | | | | |
| | | Facebook | L. L. Bean | 5892 | 39286 | $25 |
| | | Account | | | | |
| | | Twitter | J. C. Penneys | 14298 | 95745 | $30 |
| | | Account | | | | |

In one embodiment, an iPON™ Number Encryption Process uses a unique Customer Private Key is used to convert the iPON™ Number to an Encrypted iPON™ Number using a mathematical hashing algorithm technique.

| iPON ™ | Customer Private Key | Encrypted iPON ™ |
|---|---|---|
| Number | Hashing Algorithm | Number |
| 837625 | 439976 | 1181077 |

One exemplary feature of the present invention is that only the customer can redeem the iPON™ stored on the Retailer iPON™ database, because only their Private Key was used to create the encrypted iPON™ number associated with the actual retailer iPON™ Number stored on the Retailer iPON™ Database. A hacker attacking the Retailer iPON™ database will not have access to the actual user Private Key and therefore the iPON™ cannot be converted and redeemed.

In use, the customer accesses their iPON™ Account on the iPON™ Customer Database where the iPON™ Certificate of Authority resides. The customer reviews their iPON™s available and chooses the iPON™ to redeem at the retailer website. This is where the user Private Key is applied to the iPON™ number using a hashing algorithm. When applied, if the encrypted iPON™ equals the encrypted iPON™ in the Customer Database, the iPON™ is valid and the user has permission to redeem it at the retailer website shopping. If the encrypted iPON™ Number is not the same, then the user is considered to be fraudulent and the iPON™ is not applied at the retailer shopping cart. The customer applies the actual iPON™ Number at the retailer's website by placing it in the retailer's shopping cart. When the actual iPON™ is redeemed at the retailer website, the Retailer processes the iPON™ value.

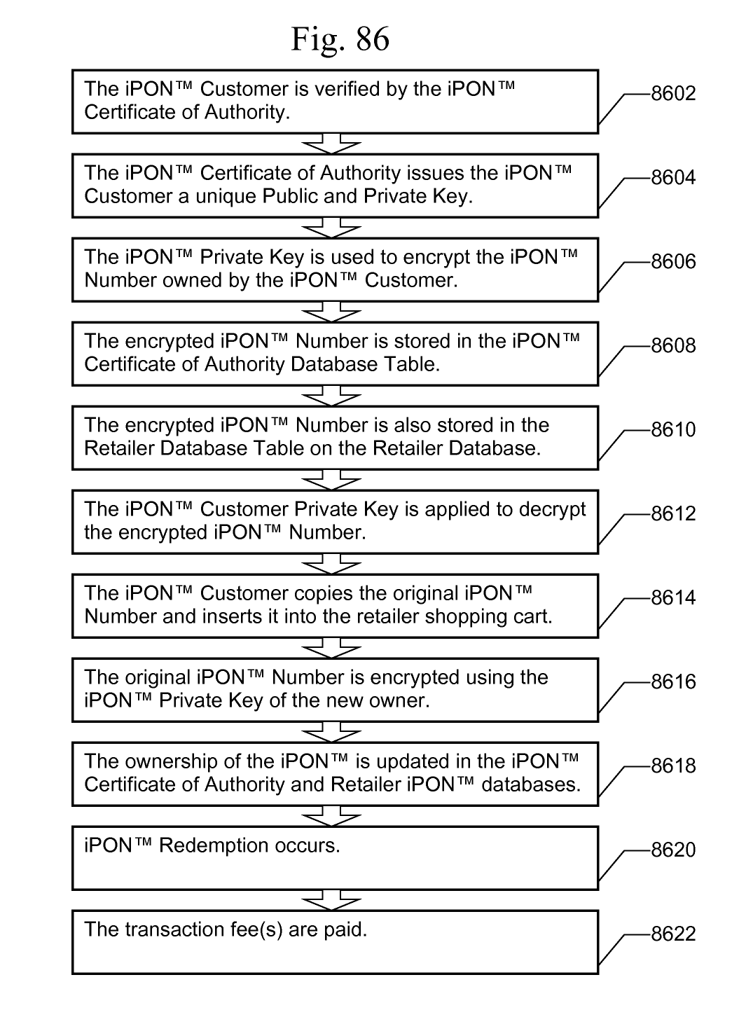

In one embodiment, an example of iPON™ Operation is shown in FIG. 86. In block 8602, the iPON™ Customer is verified by the iPON™ Certificate of Authority. In block 8604, the iPON™ Certificate of Authority issues the iPON™ Customer a unique Public and Private Key used to encrypt and decrypt information. Only an iPON™ Customer, whose identity has been verified by the iPON™ Certificate of Authority, can encrypt the iPON™ Number stored on the iPON™ Retailer Database. In block 8606, the iPON™ Private Key is used to encrypt the iPON™ Number owned by the iPON™ Customer. In block 8608, the encrypted iPON™ Number is stored in the iPON™ Certificate of Authority Database Table. In block 8610, the encrypted iPON™ Number is also stored in the Retailer Database Table on the Retailer Database. In block 8612, the iPON™ Customer Private Key is applied to decrypt the encrypted iPON™ Number and convert it to the original iPON™ Number. In block 8614, the iPON™ Customer copies the original iPON™ Number and inserts it into the retailer shopping cart as a promotional code or discount code. Ownership of the iPON™ can be transferred from one iPON™ Customer to another by giving or selling the permission to redeem the iPON™. In block 8616, after iPON™ ownership is transferred to another customer, the original iPON™ Number is encrypted using the iPON™ Private Key of the new owner. In block 8618, the ownership of the iPON™ is updated in the iPON™ Certificate of Authority database and Retailer iPON™ database. In block 8620, iPON™ Redemption occurs. After the iPON™ is redeemed by the new iPON™ owner at the retailer website, the iPON™ Certificate of Authority is paid a transaction fee by the retailer. In block 8622, the transaction fee(s) are paid. The Certificate of Authority Transaction Fee is a predetermined amount for redeeming the iPON™ and removing customer access to the iPON™. Payment of the transaction fee to the iPON™ Certificate of Authority is via an electronic money service, such as Automated Clearinghouse (ACH), or other similar electronic monetary value system.

In one embodiment, a Retailer iPON™ Database Table is as shown below. This database table contains fields describing the retailer iPON™ record. The retailer maintains the iPON™ as a store credit to be redeemed by the customer. The retailer maintains iPON™ parameters such as the monetary value, which items can accept an iPON™ store credit, how long the iPON™ is applicable etc. After the customer signs on to the iPON™ Account at the iPON™ Certificate of Authority, they can view all retailer iPON™s available. Note: The Encrypted iPON™ Number is created by using the customer Private Key. This protects the redemption of the iPON™. ONLY customers having the correct Private Key associated with an encrypted iPON™ can redeem the encrypted iPON™

| | | | Encrypted | |
|---|---|---|---|---|
| | | | iPON ™ Number | |
| iPON ™ | | | encrypted using | |
| Customer | iPON ™ | | iPON ™ | |
| ID | Retailer | iPON ™ | Customer Private | iPON ™ |
| Number | Name | Number | Key | Value |
| 271555 | J.CREW | 8392 | 43973 | $25 |
| | J.CREW | 3766 | 397289 | $30 |
| | J.CREW | 21988 | 38772 | $20 |
| | J.CREW | 5892 | 39286 | $30 |
| | J.CREW | 14298 | 95745 | $20 |

In one embodiment, operation of customer iPON™ redemption proceeds as follows.

The Retailer determines the original iPON™ Number and value.

The iPON™ may be redeemed by the iPON™ Customer after the price negotiation or price selection and corresponding iPON™ selection and issuing of an iPON™ to the customer.

The iPON™ Customer Private Key is applied to decrypt the encrypted iPON™ Number and convert it to the original iPON™ Number. If the decrypted iPON™ does not match the original iPON™ number, then the iPON™ is fraudulent.

The iPON™ Customer copies the original iPON™ Number and inserts it into the retailer shopping cart to apply the iPON™ value towards the item purchase price.

iPON™ Redemption: After the iPON™ is redeemed by the new iPON™ owner at the retailer website, the iPON™ Certificate of Authority is paid a transaction fee by the retailer.

iPON™ Certificate of Authority Transaction Fee: This fee is a predetermined amount for redeeming the iPON™ and removing customer access to the iPON™.

Payment of Transaction Fee to iPON™ Certificate of Authority: Payment of the transaction fee to the iPON™ Certificate of Authority is via an electronic money service, such as Automated Clearinghouse (ACH), PayPal or other similar electronic monetary value system.

In one embodiment, the Marketplace provides additional layers of security. In addition to the security the PKI system applied to the Marketplace data base and the iPON™ issuer database, the iPON™ holder can store their photograph, in their account and for a physical store purchase this photo can be reviewed by the retailer. This simple application of a photo is an additional layer of security that would be available if a user wished to access this feature. If the iPON™ holder wished, they could also limit this iPON™ from being used online, and mandate it be used in a physical store, or even to a specific store location. It is highly unlikely that a thief or hacker would want to attempt to hack into the iPON™ and load the thief's photograph on order to use the iPON™, as this photograph would be a record of the lawbreaker's identity. What is novel and unique about this application is that the iPON™ system can choose where to store this photo. It can be on the Optimus Marketplace user database, or it can be on the retailer's server or in can be imbedded in the iPON™ file.

Additional features of an embodiment of the present invention allow further layers of security in addition to the method of the PKI application, such as using photograph or even physical encryption key assigned to the iPON™ holder. This encryption key would be held by the iPON™ holder and would need to be inserted in the device, such as a point of sale device or computer to complete an iPON™ transaction. It could even be a special chip in a special card that was needed in conjunction with redeeming an iPON™.

In one embodiment, the Marketplace provides iPON™ Customer and Retailer Use of iPON™ PKI for Secure Communication. Customers and retailers can use the iPON™ PKI system for secure communication about iPON™s such as: iPON™ redemption, sale of iPON™, purchase of iPON™.

Customer to Retailer Communication: iPON™ customers can communicate information with retailers securely using the iPON™ PKI system over a private network or the Internet. Private information is encrypted using the Public Key of the recipient of the information. The encrypted information is sent over the Internet or private network as an email or text message. The recipient uses their Private Key to decrypt the sent information.

Customer to Customer Communication: iPON™ customers can communicate information with other iPON™ customers securely using the iPON™ PKI system over a private network or the Internet. Private information is encrypted using the Public Key of the recipient of the information. The encrypted information is sent over the Internet or private network as an email or text message. The recipient uses their Private Key to decrypt the sent information.

In one embodiment, the Marketplace provides for purchasing the iPON™ from a Physical Store and the Store offering a Higher Value if Redeemed in a Physical Store. Other exemplary features may include (a) customers can come into the store, buy an iPON™ as an alternative to depositing funds in a bank and (b) the retailer can provide a higher value to an iPON™ when redeemed in the physical store as opposed to online as a means of incentivizing traffic to come to the physical store.

In one embodiment, the Marketplace provides for using Standard Internet Platforms to Enhance the Usefulness and Convenience of the Software System. In this embodiment of the present invention is the potential use of the existing Internet platforms that provide services to enhance the effectiveness of this invention. This embodiment can be enhanced with the tools available such as Google Wallet, Amazon Wallet or Apple Pay or other wallet applications developed for mobile devices.

For example, the Google Wallet or Facebook secure membership can be the membership used to accept members to access an iPON™ account securely. Then these members would also be able to transact on Optimus Advantage database or the iPON™ registry. The payment capabilities on Google Wallet, Amazon Wallet, and Apple Pay can also be used for members to purchase an iPON™ from either the issuer or other members. Payment technology using ACH direct debit or direct credit can also be made available to the account holders so that they may make a payment to purchase an iPON™ from their bank account for minimal or no fees. Google+ and Google Circles can be used to identify friends and family for transferring an iPON™ free of charge. Both Google and Amazon can provide pricing information to be used in the negotiation. Google Maps and other mapping programs can be used to identify proximity of retailers that will transact with a member's iPON™ credits. Lastly, since some purchases may be a portion in iPON™ credit and a portion in actual payment, these electronic wallets can make the cash payment securely in concert with an iPON™ redemption. All of these functions are a part of this invention, and may be developed as part of the invention or incorporated from third parties.

In one embodiment, the Marketplace may provide Co-Marketing a Third Party Retailer Offers as an Incentive an iPON™ from Another Retailer, Brand or Manufacturer. This embodiment allows a third party retailer to agree to purchase an iPON™ from another retailer and offer it in a transaction. This is essentially co-marketing where one retailer promotes the use of another retailer's products. Currently we see this co-marketing working between grocery stores and gas stations. These two entities have dedicated computer systems that work with each other, and when customers buy gasoline using their grocery store membership card, they can use loyalty points to save on gasoline. The embodiment of our invention allows retailers to use each other's iPON™ in a co-marketing fashion, without dedicated computer systems between each retailer. They simply have to agree on a price of each iPON™ when sold to each other.

Software these features may include: (a) software that allows retailer A to purchase and iPON™ from retailer B; (b) software that allows retailer A to notice retailer B that an iPON™ should be issued to a member; (c) software that allows retailer B to bill retailer A for the agreed upon price of the iPON™ issued; and (d) if needed, software that allows retailer A to pay retailer B for the iPON™ either (i) immediately after issue or (ii) when it is redeemed by the customer who acquired the iPON™. In this fourth embodiment of the invention, promotion of the co-marketing programs may use third party Internet applications, such as AdWords by Google and other similar applications and various search and map applications to alert customers to where these opportunities exist.

In one embodiment, the Marketplace may provide access to the iPON™ to Global Brands and Manufacturers that have No Coupon Capability Today and Allow this Group to Access Customers Individually. In this embodiment of the present invention, manufacturers and global brands currently unable to use manufacturer coupons gain access to an iPON™ Currently manufacturer coupons are small, averaging $1.60 each, and are typically used in grocery stores, supermarkets, and pharmacies. These systems, which discount at the cash register, log in the coupon tied to the sale item, and invoice the manufacturer, are well established.

In addition, there is a need for systems to handle bigger ticket items that are sold to a variety of re-sellers. Often the re-sellers do not have the systems or scale to accept a manufacturer coupon, and given the dollar value of larger coupons that would be required, fraud is a real concern. In this embodiment of the invention, manufacturers or global brands can issue an iPON™ to individual members through the Optimus Advantage database or registry. The issuance of the iPON™ may be by an offer advertised in any medium, that Optimus Advantage members can: (a) opt into; (b) purchase; or (c) apply and wait for acceptance. In the case of a manufacturer- or global-brands-issued iPON™, retailers will need to have software to accept the manufacturer or global brand iPON™ and additional software to communicate to the global brand or manufacturer through the Optimus Advantage database or directly to the manufacturer to whom the iPON™ is being tendered. They will need further software to invoice the manufacturer or global brand for payment. A manufacturer or global brand iPON™ may be issued in a negotiation for purchase of a manufacturer's product on the manufacturer's website, or issued or sold directly to Optimus Advantage members. In this embodiment of the invention, since not every retail outlet will be connected to the manufacturer for acceptance of the iPON™, an application with Google maps or similar application would be developed to assist members to use their manufacturer- or global-brand-issued iPON™ and a retailer that can accept the iPON™. This embodiment of the invention will also give retailers the ability to acquire and offer a manufacturer iPON™ as part of a negotiation or incentive in addition to the retailer's own issued iPON™.

In one embodiment, the Marketplace may utilize the iPON™ as a Prepayment Method. This embodiment of the invention is for a retailer to sell an iPON™ to function, similar to a prepaid gift card. In this case a member simply buys the iPON™ and uses this iPON™ for an offset to purchase price of an item. Prepayment via an iPON™ costs much less than using current credit cards and the processing cost of a store credit system is lower as well. Much smaller pre-paid amounts may be accepted for later redemption, as can larger pre-paid amounts that are reduced as the balance is used. As the iPON™ is used, the store communicates to the Optimus Advantage database or Market Place registry and the amount redeemed is recorded. In this embodiment the purchased iPON™ is assigned to the buyer and can only be transferred through the database to another member and operates on the stores credit system.

In one embodiment, the Marketplace may provide a Pre-Formatted iPON™ platform for Small Local Retailers. This embodiment may service local retailers, who typically do not have the scale of manufacturers or global brands to participate in using the iPON™ for discounts. In this embodiment, the local retailers may or may not use the negotiator and simply make an offer that includes redeemable iPON™. In this embodiment the retailer may develop offers using pre-formatted templates provided by the system to the retailer.

Such pre-formatted templates may include an option-pricing model where the customer purchases the iPON™ for a nominal amount as an option to exercise by redeeming the iPON™ when purchasing goods or services from the local retailer. Or the iPON™ offered to the customer may only be valid when a specific number of Optimus Advantage members agree to acquire the iPON™. Or the Optimus Advantage members may acquire the iPON™ for full value of the offered price or at a price that is likely discounted for a product or service and redeem this iPON™ for the deal that this offer represents. As with prior embodiments, the issued iPON™ is to a specific, known customer, and the retailer can communicate to the iPON™ holder, gather information from the iPON™ account, and enhance the iPON™ itself. Such communication may include enhanced offers, and delay expiry of the iPON™, or even confirm a dinner reservation.

A feature of this embodiment is that the Negotiator and iPON™ system provides customers and retailers a method to communicate with each other. For example a customer may purchase an iPON™ from a local restaurant. Imbedded in the iPON™ is a feature that allows the reservation of a specific time for a dinner. The iPON™ holder then selects a specific time allowed by the iPON™ and through the iPON™ holder's account, either through the iPON™, the account, or another method specified by the holder, perhaps as e-mail or cell phone text, the restaurant confirms the reservation.

In one embodiment, the Marketplace may provide a feature known as from Paper to an iPON™. This embodiment may allow other coupons to be converted to an iPON™ and reside in the iPON™ holder's account. Currently coupons are (a) issued in paper form or (b) can be accessed on various Internet sites where a customer prints the coupon to take to the store or (c) the customer can simply use an advertised coupon code. The iPON™ in this embodiment would allow coupon issuers to provide a code on the coupons that allowed Optimus Advantage account holders to input the code and have the coupon issued to their accounts as an iPON™. In this embodiment the iPON™ holder captures the coupon in his or her account where it is easily stored and used, and to the coupon issuer gains and advantage whereby the iPON™ holder may transfer the iPON™ to other holders, giving the retailer larger distribution, something current online coupon sites do not provide.

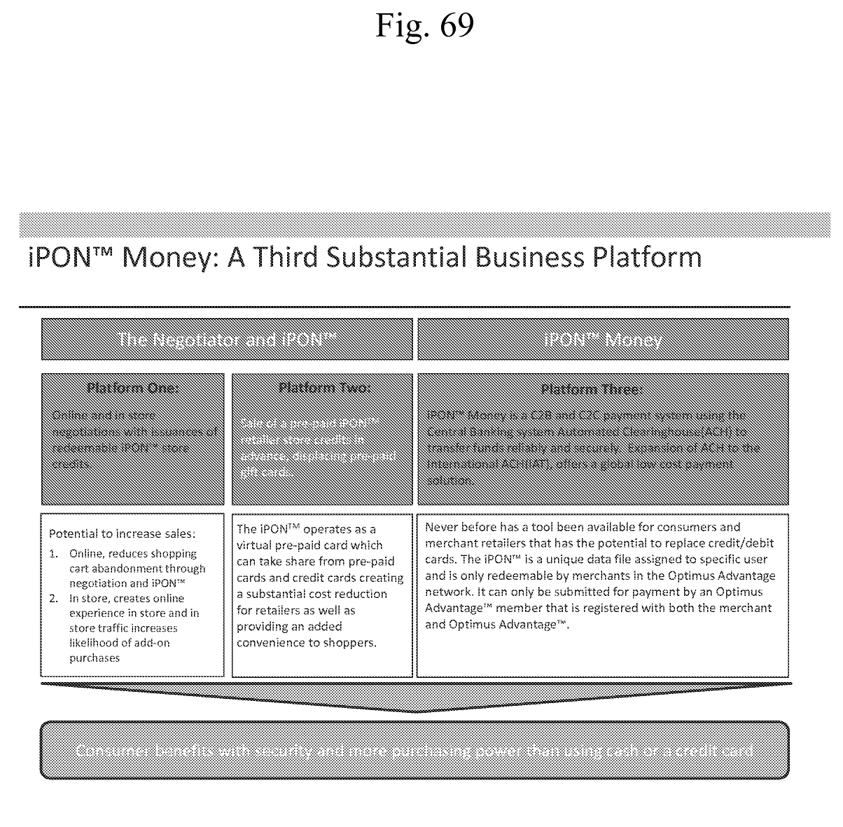

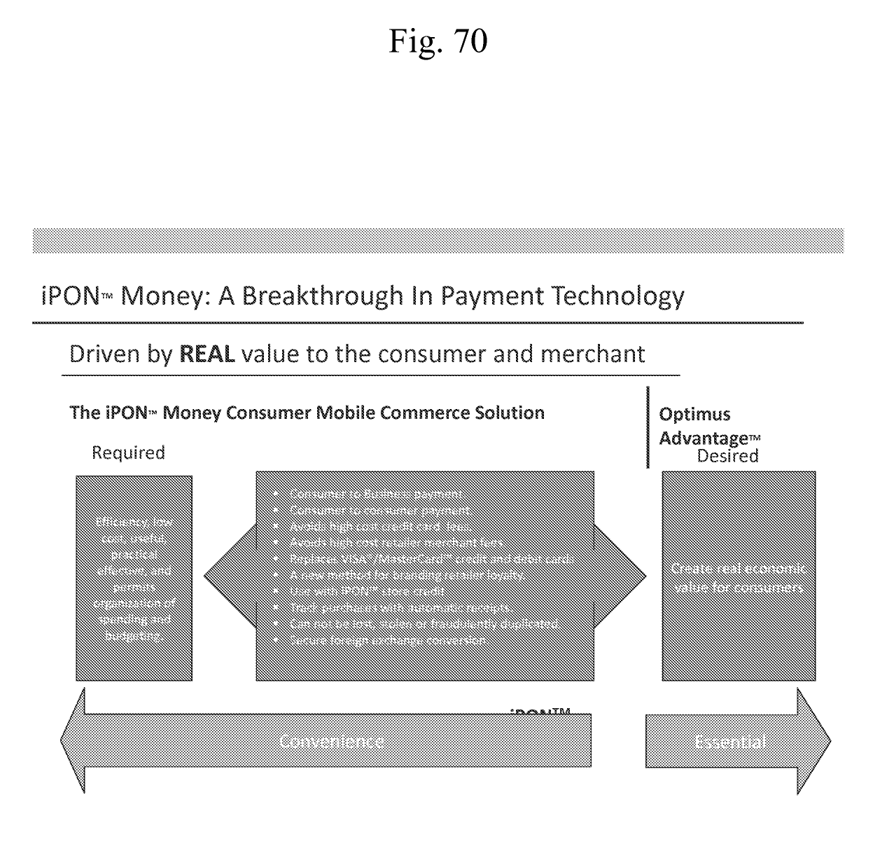

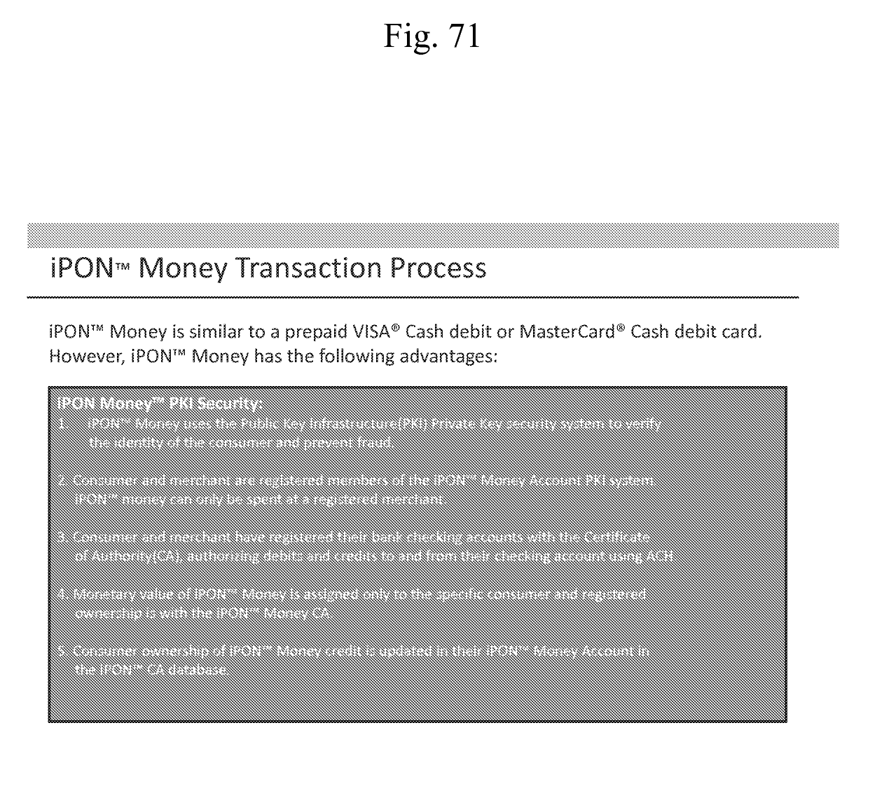

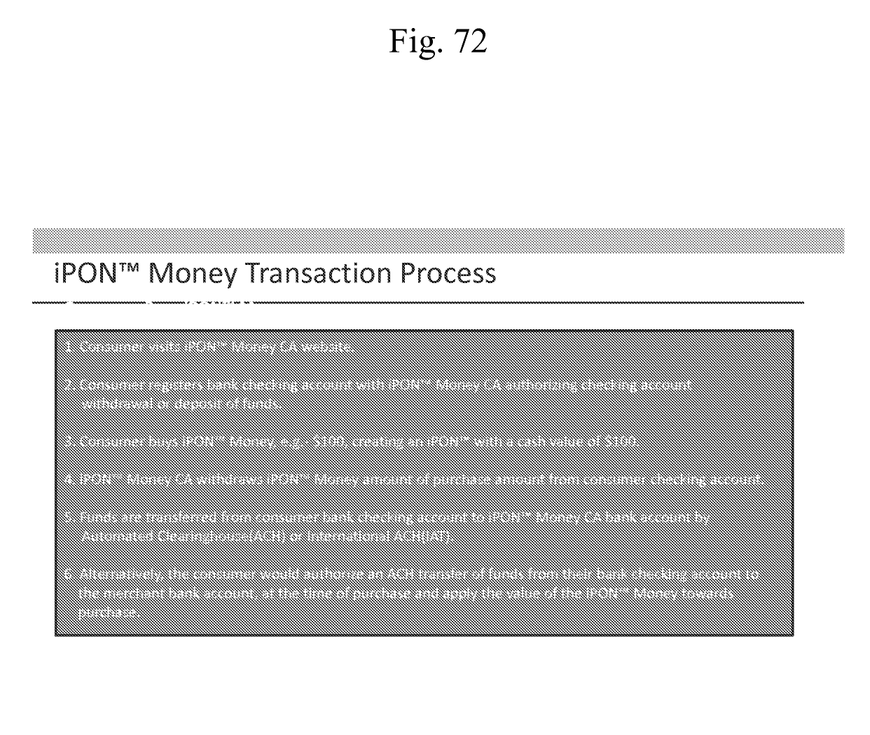

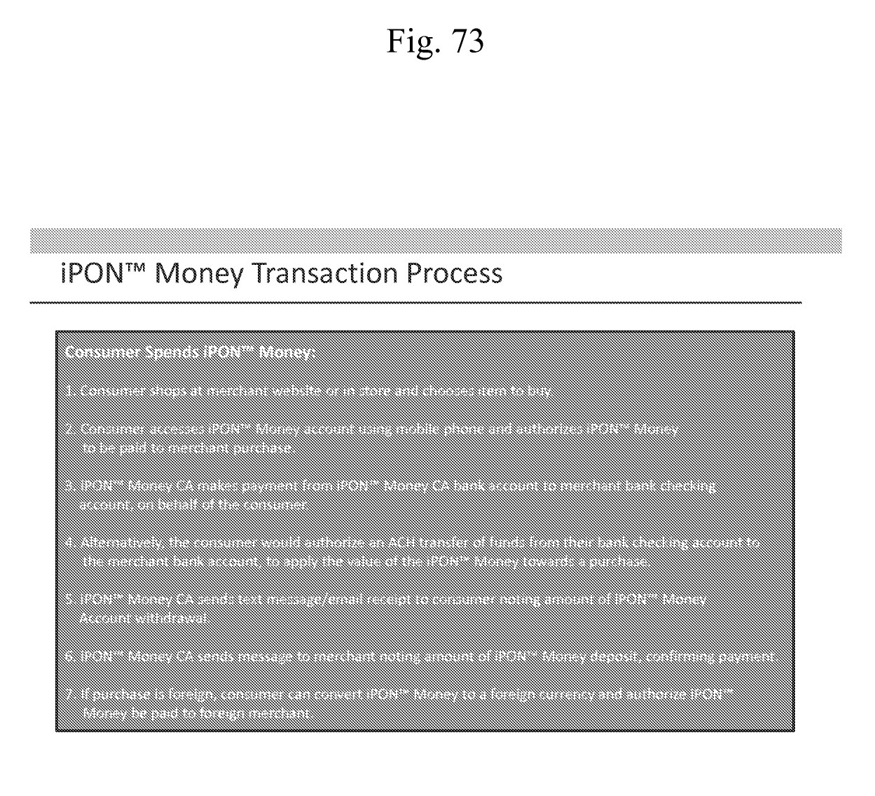

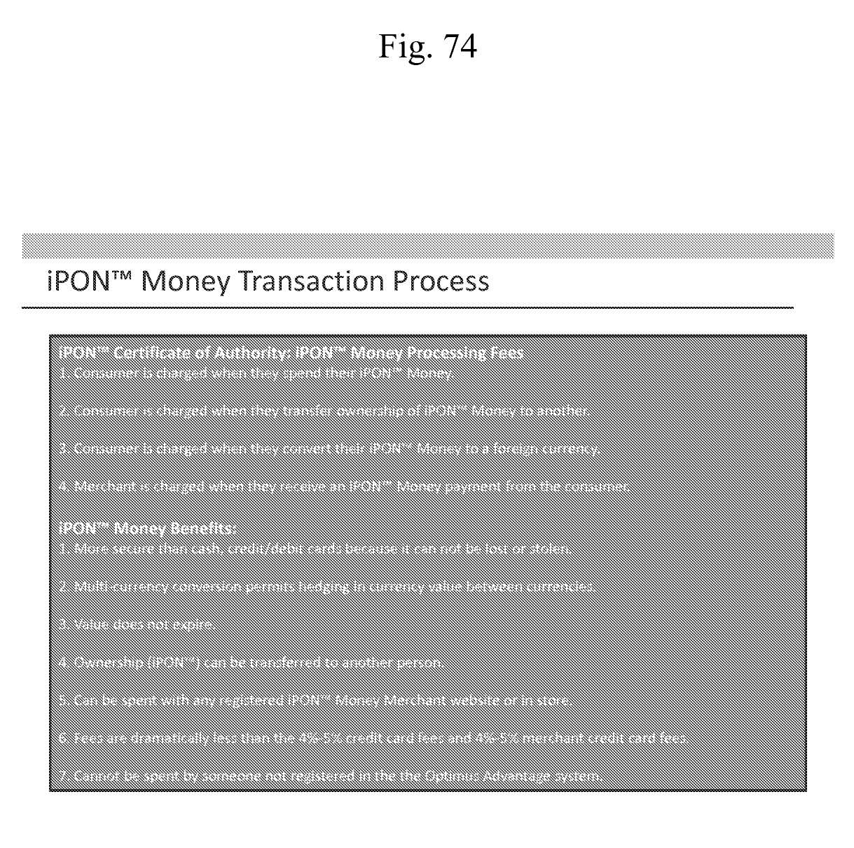

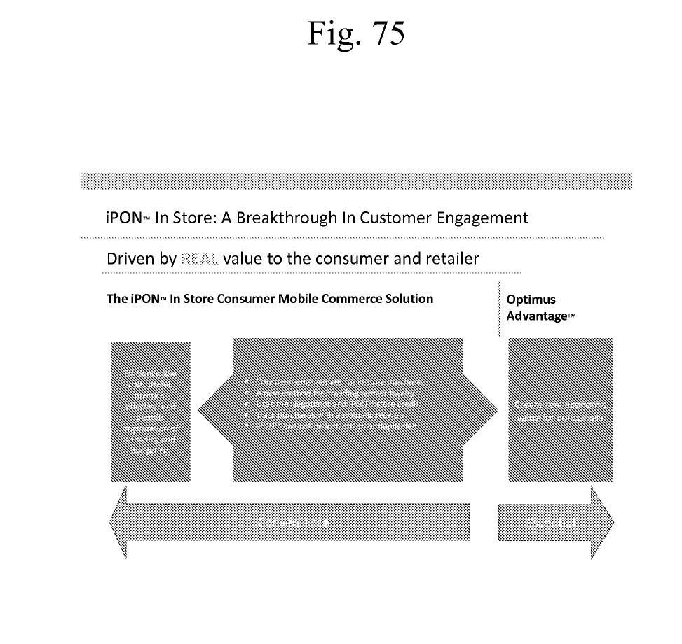

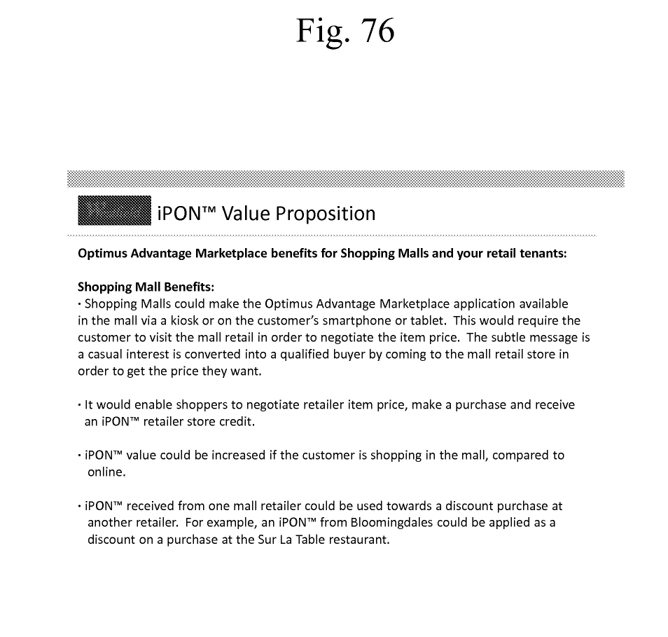

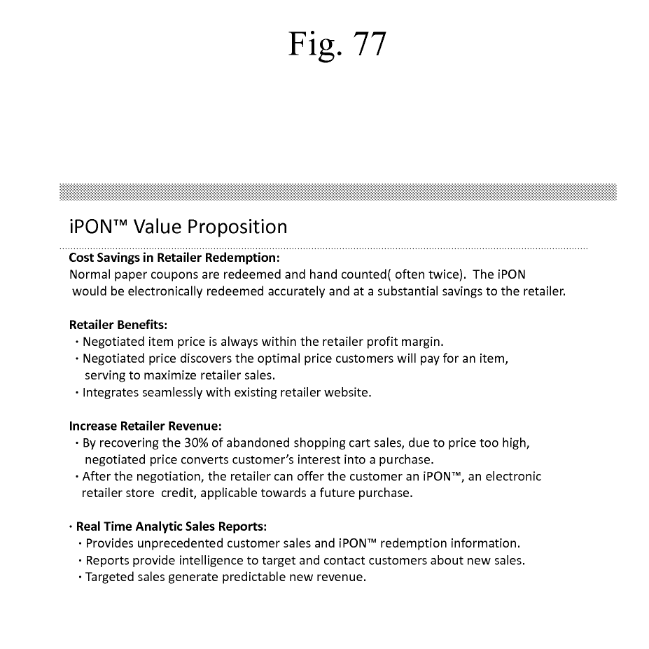

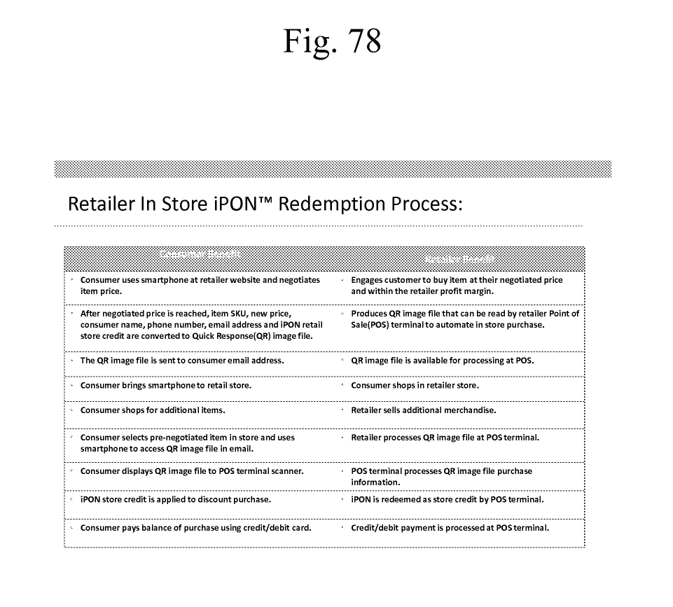

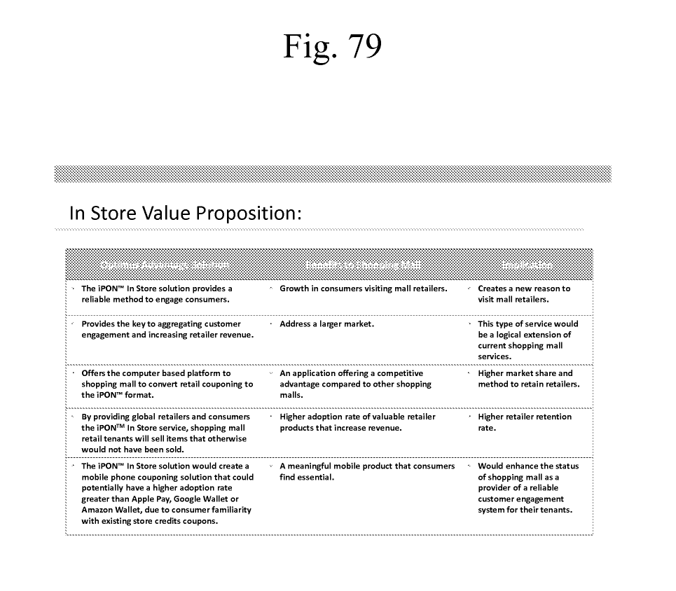

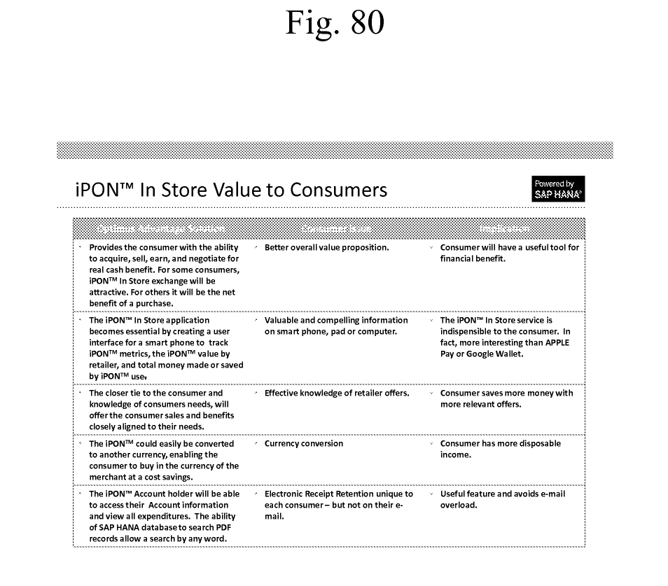

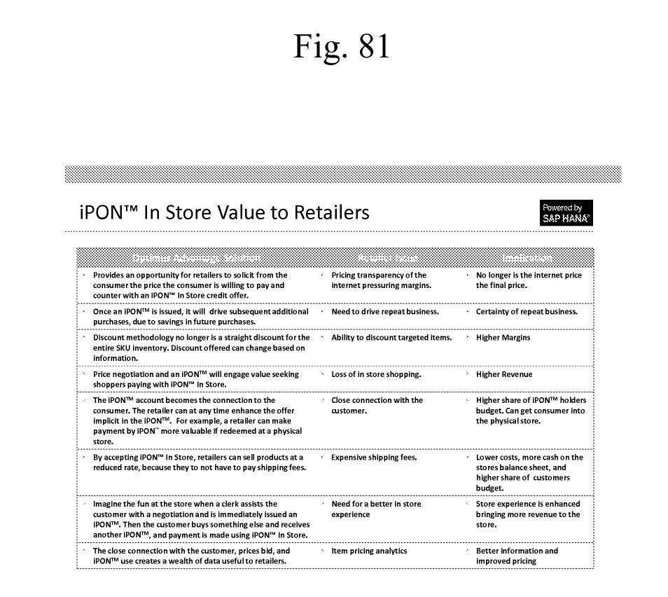

Further details are shown in FIGS. 69, 70, 71, 72, 73, and 74.

In one embodiment, the Negotiator and iPON™ System may provide for the negotiation of the total price. In this embodiment, the consumer accesses the retailer website and chooses all of the items to purchase. After the items are placed in the retailer shopping cart, they can negotiate the total price using the Negotiator. After the negotiation reaches a final price, the consumer receives an iPON™ store credit from the retailer. The consumer selects a link or control, such as a hypertext markup language (HTML) link, which directs them to a payment page to pay for the purchase.

In one embodiment, the iPON™ game may be hosted by the Marketplace. The game begins when the retailer customer sends a message to their friends and challenges them to get a better price Offer to Buy for the same item, within a fixed time period. The friends then use the Negotiator at the same or different retailer to negotiate a better value or lower price for the same item. Communication by text or email continues among the friends to get the best offer for the same item. The game is won by the person getting the best value or lowest price for the same item within the allotted time period. The prize for winning the iPON™ Game is an iPON™ of a set value, redeemable at a retailer member of the Marketplace. After the game is complete and the retail customer has successfully negotiated an item price and iPON™ Offer to buy, they will be able to send a message by text or email to their friends in the Optimus Advantage Marketplace notifying them of their accomplishment.

In one embodiment, the Negotiator and iPON™ System may provide Dynamic Currency Conversion. In this embodiment, the consumer accesses the retailer website and chooses an item to purchase. After the item(s) are placed in the retailer shopping cart, they can negotiate the total price using the Negotiator. After the negotiation reaches a final price, the consumer receives an iPON™ store credit from the retailer. The consumer selects a link or control, such as a hypertext markup language (HTML) link, which directs them to a payment page to pay for the purchase.

The consumer can pay for the item in the currency of their choice. A dynamic currency conversion process permits the consumer to choose which currency to pay the retailer for the negotiated item price. The process consists of selecting the currency to pay for the item and it will dynamically be converted into another currency, such as converting dollars to euros. In this case, the buyer selects to pay for the item in dollars. The currency is converted to euros by a currency conversion service and the merchant receives payment in euros. The advantage of this process is the consumer can pay in their local currency and the retailer is paid in their respective local currency, offering a cost savings to both.

In one embodiment, the Marketplace may provide Enhanced Distribution of iPON™ Offers. In this embodiment of the invention, retailers, manufacturers, and global brands can have the option to issue iPON™s that the iPON™ holder is permitted to duplicate and share by the iPON™ with other members of the iPON™ Optimus Advantage system. For example, Sony might issue a manufacturer's iPON™ for $100 off of a Sony camera. Part of the value of this iPON™ is that the holder will be allowed to transfer this iPON™ to up to three friends. Other iPON™s may allow an unlimited number of transfers. This feature provides an option that no current coupon provides and creates for the iPON™ issuer greater reach and broader distribution for the offer, effectively making the iPON™ holder a marketing channel. Further, the iPON™ issuer can also provide an incentive for the member distributing the iPON™.

In one embodiment, the Marketplace may provide the capability for Multiple Retailers to Convert Loyalty Points to an iPON™ and Accept each other's iPON™s Created from the Loyalty Points to Enhance Value of Loyalty Programs. In this embodiment, multiple retailers use the iPON™ as a loyalty reward system alliance. In this embodiment, a group of retailers would agree to accept an iPON™ that has been issued by a conversion of any one of the retailer's loyalty reward points to an iPON™. Much like an airline miles program, where miles on one airline can be redeemed at another airline in an alliance, each retailer would establish the value of reward points that can be converted to a discount iPON™ redeemable at any of the retailers in an alliance among those retailers. As with the airlines, imbalances due to redemption tendencies would have to be settled on a regular basis among the retailers.

In one embodiment, the Marketplace may provide Multiple Acceptances of iPON™s from Many Retailers in an Alliance. In this embodiment, multiple retailers agree to participate to accept each other's iPON™s and a retailer could sell an iPON™ to an iPON™ holder who could then redeem the iPON™ at any number of retailers. Much like the above Multiple Retailers Convert Loyalty Points embodiment of this invention (above), there would need to be settlement for any imbalances.

In one embodiment, the Marketplace may provide Cross-border Acceptance of an iPON™. In this embodiment, an iPON™ can be transferred across borders for those retailers that have stores in countries outside of the country of the iPON™ issuance. In this embodiment, the iPON™ holder would request re-issuance of the iPON™ in another currency. In the iPON™ issuance in another currency, no cash would cross borders, and the retailer would settle the redemptions with an intercompany transfer or other type of reconciliation between the operating divisions in each country. The exchange rate is established by the retailer and may very likely be favorable when compared to transferring funds across borders, to enhance the attractiveness of the transaction. In this embodiment the initial holder of the iPON™ may also transfer the iPON™ to another person in the other country.

In one embodiment, the Marketplace may be used to Promote Products, Brands, and Retailers at Charity Auctions. This embodiment takes advantage of charity auctions, and provides an avenue for retailers and global brands for promotion of their products in the vast myriad of charity auctions. The Optimus Advantage system and database provides a charity auction platform that embodies this invention and provides an inventory database that stores the iPON™s that a company wishes to offer and allows various charity auctions to register for offering and offer the iPON™s to bidders. Once registered with the Optimus Advantage site, the particular charity auction selects the iPON™ offers it wishes to display, and information on the registration and selection is sent to the iPON™ issuer for acceptance. After acceptance, a code for each iPON™ is provided to the charity auction, as well as any amount that the iPON™ may require to be paid. Once a winner of the auction of the iPON™ has paid, the charity auction provides the code for the iPON™ as well as other security information that allows the winner to download the iPON™. If a payment is due, the iPON™ is only activated as a live iPON™ once the charity auction has paid the required amount.

In one embodiment, the Marketplace may be used for Automobile Negotiation and Offers. In this embodiment, the negotiator and the iPON™ can be used to allow automobile manufacturers to negotiate price and provide incentives for the purchase of an automobile and forward the deal to the dealer that would offer additional incentives to come into the dealer showroom and purchase it. What is novel in this embodiment is the fact that the automobile company cannot close the transaction and sell the car because current dealer networks do not permit this, however the automobile company can make offers contingent on an automobile purchase. The automobile manufacturer would negotiate iPON™ deals from other third party retailers, and when the dealer closes a transaction and sells an automobile, these iPON™s would issue.

In one embodiment, the Marketplace may provide Accumulation of Value as a Loyalty reward. This embodiment may include an iPON™ may be used to create more awareness of the value of an earned discount. In one such embodiment, an iPON™ would be issued with a face value that has yet to be earned. This is expected to be particularly useful in customer loyalty rewards. One method of enhancing the value of customer loyalty rewards, for example, would be a $20.00 iPON™, being issued to a customer, and as purchases are made the value grows from zero to eventually $20.00. Once it hits $20.00, it becomes actionable and the customer can spend it. The customer's account can be viewed on a smartphone or other computer device; the customer will be able to see the iPON™ grow in value, thereby making the savings more tangible. In another such embodiment to create more awareness, the customer would receive updates to his or her account weekly, monthly and annually summarizing the total amount of money saved by use of the iPON™.

In one embodiment, the Marketplace may provide Co-Promotion by Third Parties. In this embodiment, the iPON™ allows co-promotion from channels other than retailers. Today, we see retailers, such as Apple offer $100 discount if a computer is purchased for education. In this embodiment we allow non-retailers, such as schools, to enter into an agreement with the iPON™ issuer whereby the school would issue an iPON™ to students for a $100 discount on a computer, and when redeemed the school would be paid a success fee. In this embodiment a non-retail channel becomes a promoter and beneficiary of the use of an iPON™ and purchase of a product. The Optimus Advantage system would allow non-retailers to register as iPON™ issuers of third party iPON™ discounts.

The system would allow the third party to nominate the non-retailers for issuing such an iPON™, and such a nomination would define: (a) the terms of the iPON™ to be issued; (b) the term of time period the non-retailer would be allowed to issue the iPON™ credit; and (c) the promotional fee that would be paid to the third party distributing this iPON™.

In one embodiment, the Marketplace may provide Receipt Retention. In this embodiment, when the iPON™ that is stored in the customer's account is redeemed, the receipt that is generated can be stored in the iPON™ file that was used for purchase. The novelty of this invention is that even though the iPON™ is redeemed and may have no cash value, the data from the receipt can be assigned or stored on this retired iPON™ and allow the customer to fine receipts easily.

In one embodiment, the Marketplace may provide a Negotiator Voice Speech Interface. The retail customer may use the “Negotiator” to negotiate the item price and iPON™ Offer to buy, ordinarily using a device keyboard to interact with the Negotiator Interface.

In this embodiment, the customer may choose to use a voice-to-text/text-to-voice conversion software solution permitting the customer to interact with the Negotiator by speaking input to the Negotiator. The process consists of a customer choosing to interact by voice with the Negotiator Interface. After being chosen, the customer speaks all commands and the Negotiator responds to the customer. In one scenario, a voice-to-text/text-to-voice software solution is used.

Negotiation between the customer and the Negotiator proceeds until the customer accepts the final price counteroffer and chooses to buy the item. At the end of the negotiation, the customer is issued a promotional code associated with the negotiated price. The customer uses the retailer website to apply the promotional code and buys the item.

In one embodiment, the Marketplace may provide a Speech-to-Speech/Text-to-Text Multi-Lingual Interface. The retail customer may use the “Negotiator” to negotiate the item price and iPON™ Offer to buy, ordinarily using a device keyboard to interact with the Negotiator Interface in the English or other language. In this embodiment, the customer may choose to use a multi-lingual interface voice-to-text/text-to-voice translation software solution permitting the customer to interact with the Negotiator by speaking input to the Negotiator in the customer's native language. The process consists of a customer choosing to interact by voice with the Negotiator Interface in a specific language such as Spanish. The customer speaks all commands in Spanish and the Negotiator responds to the customer in Spanish. Negotiation between the customer and the Negotiator proceeds until the customer accepts the final price and chooses to buy the item.

In this embodiment, the customer may also choose to use the multi-lingual interface in text mode permitting the interaction between the customer and the Negotiator to be in any of a variety of languages, such as German. A text/text translation software solution permits the customer to interact with the Negotiator by typing in his or her native language and sending it to the Negotiator Interface. The Negotiator Interface responds to text commands in the language chosen by the customer.

Negotiation between the customer and the Negotiator proceeds until the customer accepts the final price counteroffer and chooses to buy the item. At the end of the negotiation, the customer is issued a promotional code associated with the negotiated price. The customer uses the retailer website to apply the promotional code and buys the item.

In one embodiment, the Marketplace may provide Negotiation of Business-to-Business Transactions Using Variable Parameters to Sell Products or Services. In this embodiment, during a business-to-business transaction, the seller will use the Negotiator Interface to store pre-determined parameters to set negotiation limits. In operation, the seller records in its account the parameters to be used by the Negotiator in real-time buyer negotiations. Pre-determined values registered for use in the negotiation may be: price, expiration time period of offer to sell, value of iPON™ issued, terms of delivery of sold item.

For example, a wholesaler of leather goods registers pre-determined parameters of the price of the leather ($30-$50 per yard), the time of the offer to sell the leather goods (Jan. 1, 2015 to Mar. 30, 2015 time period), the value of an iPON™ to apply a discount towards a future purchase ($20-$50), terms of shipping the leather goods to the buyer (by land, sea or air).

During the real-time negotiation using the Negotiator, the buyer offers to buy the leather goods at $20 per yard, during the Jan. 1, 2015 to Mar. 30, 2015 period, an iPON™ value of $50, and delivery of the leather goods by air. Using the pre-determined criteria of the seller, the Negotiator makes a counteroffer to the seller of the leather goods: $35 per yard, during the Jan. 1, 2015 to Mar. 30, 2015 period, iPON™ value of $50, and shipment of the leather goods by land.

The Negotiator manages the negotiation between the seller and buyer in real time until the buyers accepts the terms of the counteroffer from the seller.

In one embodiment, the Marketplace may provide Negotiation between Computer-to-Computer Negotiator Interface Software Using Variable Parameters to Automate Online Buying and Selling of Products or Services. A number of problems arise in the context of human to human negotiation. For example, human to human negotiation is very slow. Computer to computer interaction over a network is much faster when compared to humans negotiating by voice, email, or text messaging. In addition, there are errors in communication. Computer to computer interaction over a network removes human misinterpreted information, because computer communication uses network error checking protocols and computer file matching protocols.

In this embodiment, during a computer-to-computer negotiation, the human seller programs the Negotiator Interface software to store pre-determined parameters setting negotiation limits. Parameter values used in the negotiation may be: price, expiration time period of offer to sell, value of iPON™, a store credit having monetary value, terms of delivery of sold item, etc.

Similarly, during a computer-to-computer negotiation, the human buyer programs the Negotiator Interface software to store pre-determined parameters setting negotiation limits. Parameter values used in the negotiation may be: price, expiration time period of offer to sell, value of iPON™, a store credit having monetary value, terms of delivery of sold item, etc.

For example, a retailer of women's clothing programs the Negotiator Interface software with parameters of the clothing item price ($60), the time of the offer to sell the clothing (Mar. 1, 2015 to Apr. 30, 2015 time period), the value of an iPON™ store credit applicable to a discount towards a future purchase ($20-$50), terms of shipping the clothing to the buyer (by surface mail or overnight).

In operation, the buyer Negotiator Interface software interacts online over a network, such as the Internet or Virtual Private Network, with the seller Negotiator Interface software. During the real-time negotiation, the buyer Negotiator Interface software offers to buy the clothing item in a range of $60 to $100 during the Mar. 1, 2015 to Apr. 30, 2015 period, accepting an iPON™ store credit value of $50 or less, and delivery by surface mail.

One feature of this embodiment is that both the buyer and seller program their respective Negotiator Interface software to interact in a negotiation by exchanging computer files containing parameters, representing the respective buyer and seller. Parameters of each respective Negotiator Interface software are exchanged between the respective Negotiator Interface software by transferring files over the network. When a parameter of the seller, such as item price, does not match the parameter of a buyer, then the buyer Negotiator Interface software sends a modified price parameter to the seller Negotiator Interface software as a counteroffer and waits for a response if it is acceptable. Offer and counter offer parameters are sent between the buyer and seller Negotiator Interface software until all of the parameters match, within an acceptable range of deviation.

When the parameters of the buyer Negotiator Interface software match the parameters of the seller Negotiator Interface software, or within an acceptable range of parameter deviation, then the negotiation is complete and the respective human buyer and seller are notified by electronic communication, such as voice message, text, email, that the negotiation is complete and the purchase process can then be evaluated.

In one embodiment, the Marketplace may provide Participatory Social Observation of a Customer Using the Negotiator Interface and iPON™ issuance. In this embodiment, while a buyer is using the Negotiator Interface to negotiate the price of an item and receive an iPON, the actual real-time event can be broadcast and observed by selected contacts. The purpose of this embodiment is for the buyer to share with selected contacts the experience of using the Negotiator and receiving an iPON™ when buying an item.

In operation, the buyer designates contacts in an Optimus Account who may observe the use of the Negotiator in real time to make a purchase. The buyer uses an Optimus Account to send an alert message to the list of contacts who are permitted to monitor a negotiation to purchase an item. This alert message could be sent by email, text, or phone call. The buyer designates the names of the contacts permitted to observe. Notified contact observers sign on to their Optimus Accounts and select “Observe”. The buyer's computer, pad, smartphone screen is then displayed to each contact observing the buyer actions. The buyer's screen may be broadcast and viewed by contact observers using their computers, pads, smartphones, or other similar Internet devices.

Buyers' interactions with the Negotiator may be displayed to all observer contacts in real time. The buyer negotiates to buy the item by offering a price and then receives a counteroffer in real time that includes an iPON™ store credit. During the negotiation, observer contacts may send messages to the buyer via text, phone, or email commenting on the negotiation. When the buyer accepts the counteroffer from the Negotiator that includes an iPON™ and buys the item, all contacts observing the negotiation will be able to comment until the buyer discontinues broadcasting the screen display.

In one embodiment, the Marketplace may provide an Augmented Reality Negotiator Interface. In this embodiment, the retail customer may use the “Negotiator” to negotiate the item price and iPON™ Offer to buy, and use a device to interact with the Negotiator Interface. The customer may choose to use the “Augmented Reality” software mode to interact with the Negotiator. The process consists of a customer choosing the Augmented Reality mode of the Negotiator Interface. This interface mode permits the customer to use the smartphone camera, point it at an item for sale, and negotiate a price and iPON™ Offer to buy.

In this embodiment, the customer may point a smartphone camera at an item for sale by a retailer. The item may be displayed in the store, online at a website or another source of item for sale information. The Negotiator Augmented Reality Interface permits the Negotiator software to scan a graphic code displayed on the item for sale, such as a QR, barcode or other graphic image containing retailer item information. The graphic code is associated with the retailer item information. The Negotiator software and camera interprets the graphic image code and displays the item picture, name, price, size, and other related retail item information. The customer proceeds to negotiate the item price and iPON™ offer.

The customer interacts with the Negotiator Interface by entering Offer information in the form of text or using voice and sending it to the Negotiator Interface. The Negotiator Interface responds to text or voice command in the language chosen by the customer.

Negotiation between the customer and the Negotiator proceeds until the customer accepts the final price counteroffer and chooses to buy the item. At the end of the negotiation, the customer is issued a promotional code associated with the negotiated price. The customer uses the retailer website to apply the promotional code and buys the item.

In one embodiment, the Marketplace may provide Conversion of a paper coupon to an iPON™. In this embodiment, the issuer of a paper coupon wishes to make paper coupons, or on-line coupons transferrable to an iPON™ member's account. The retailer must be part of the Platform Retailer Network to enable conversion of a paper coupon to an iPON™. The issuer of the coupon provides either a code on the coupon that can be scanned, an alpha numeric code, QR code, barcode or a simple numeric code and the member may choose to: (a) add a paper or online coupon as an iPON™ to the member account, accessing it through a computer or smartphone or tablet computer and entering the paper coupon code that transform this coupon into an iPON™ in the member's account; or (b) use the “Negotiator Augmented Reality” software mode or a similar mode that uses a camera to interact with the retailer via the Internet, cell phone network, or other communication medium to add this coupon as an iPON™ to the member account.

In using the “Negotiator Augmented Reality” software mode or a similar mode using a camera, the process consists of a customer choosing the Augmented Reality mode of the Negotiator Interface or a similar mode that uses a camera. This interface permits the customer to use a smartphone or computer camera to scan a code associated with an item for sale, such code is specifically designed for a member to access this coupon and create this same offer as an iPON™ in the customer account.

In this embodiment, the customer uses a smartphone or computer camera to scan an item for sale by a retailer. The retailer must be part of the Platform Retailer Network to enable conversion of a paper coupon to an iPON™. The item may be displayed in the store, at a website or a paper coupon displayed in a medium such as a newspaper, magazine, or mailed advertisement.

The Negotiator Augmented Reality Interface or similar mode using a camera permits the Negotiator software to scan a graphic code associated with the item displayed, such as a QR, barcode or other graphic image containing retailer item information. The Negotiator software and camera interpret the graphic image code and displays the item picture, name, price, size, and other related retail item information on the customer's smartphone or computer.

The item coupon is then converted to an iPON™ and stored in the member's database account that the retailer will accept and apply towards a purchase.

In one embodiment, the Marketplace may provide Customer Proactive Retailer Negotiation of Item Price and iPON™. In this embodiment, the Marketplace will offer a customer the ability to make a pre-negotiated offer to buy a retailer item not included in the Marketplace. This feature will operate similarly to negotiate the item and iPON™ price, however, the difference is the retailer is not currently part of the Marketplace.

In one exemplary operational method, the customer may use the Marketplace dual screen display interface to navigate to a retailer website of choice. Because the retailer is not part of the Marketplace system, base rules of item price and iPON™ negotiation will be used to permit the customer to negotiate within an established price range (e.g.—up to a 20% discount). To use this service, the customer chooses an item at the retailer's website and negotiates the price and iPON™ value, and offers a final “Buy” price. The item, iPON™ and buy price information will be sent by text or email to the retailer from the Marketplace. The retailer will then have the option to respond to the customer via the Marketplace, by accepting, rejecting, or making a counteroffer to the customer's offer. The retailer will also have the opportunity to join the Marketplace.

In one embodiment, the Marketplace may provide Other Online Security features. Such features may include Physical Address Verification. The buyer will be registered as a member having an iPON™ account. When using a registered iPON™, a ship-to address is registered on the iPON™ when issued. This physical address stays with each iPON™. When the buyer redeems the iPON™ online, if the ship-to address is not the same as on the iPON™, then the transaction will not be allowed until confirmation can be made.

Such features may include iPON™ Account Verification. In one embodiment, any time an iPON™ is used or transferred, a message regarding the transaction may be sent to the iPON™ customer's phone and registered e-mail. To use an iPON™, the customer must first log into his or her account. An iPON™ cannot be applied to an online sale unless the customer is logged into his or her iPON™ account. The retailer accepting the iPON™ will also confirm the customer's ID.

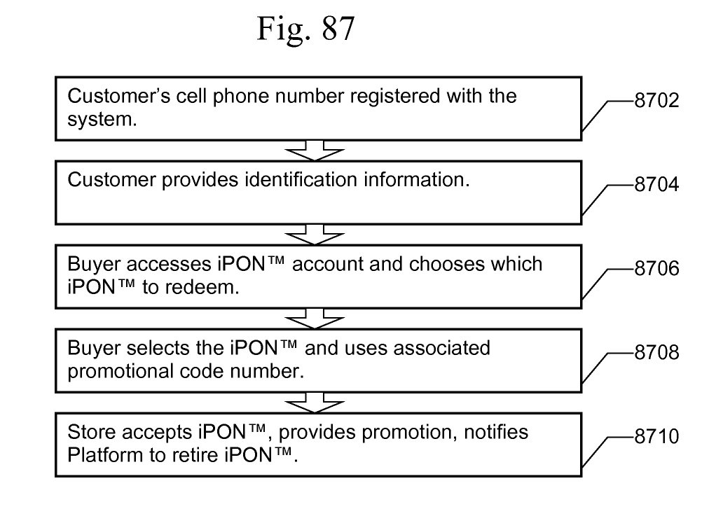

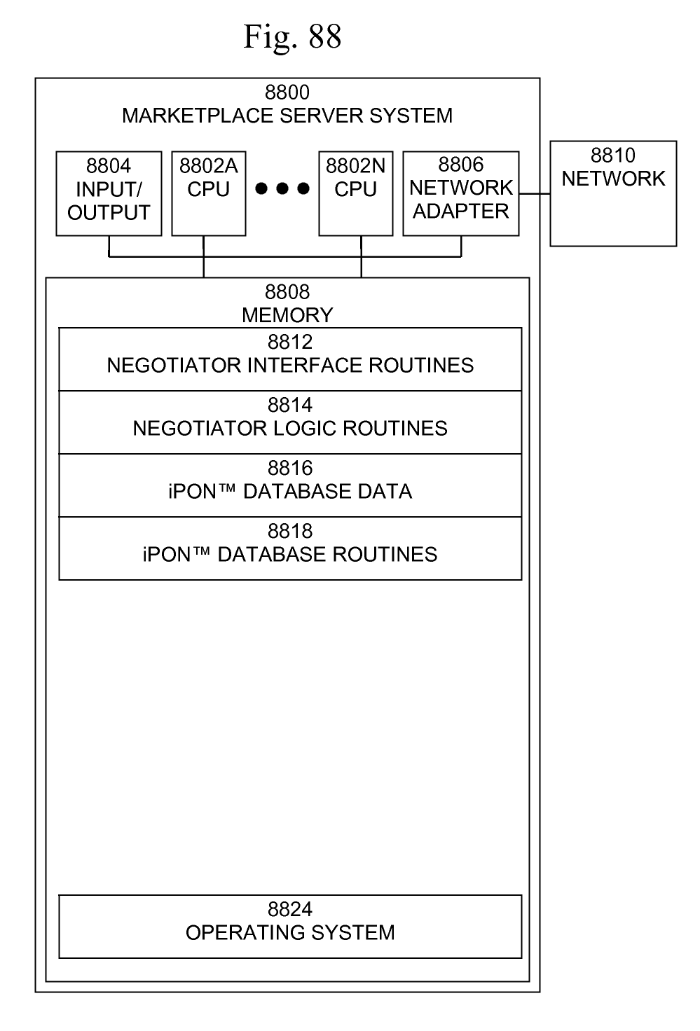

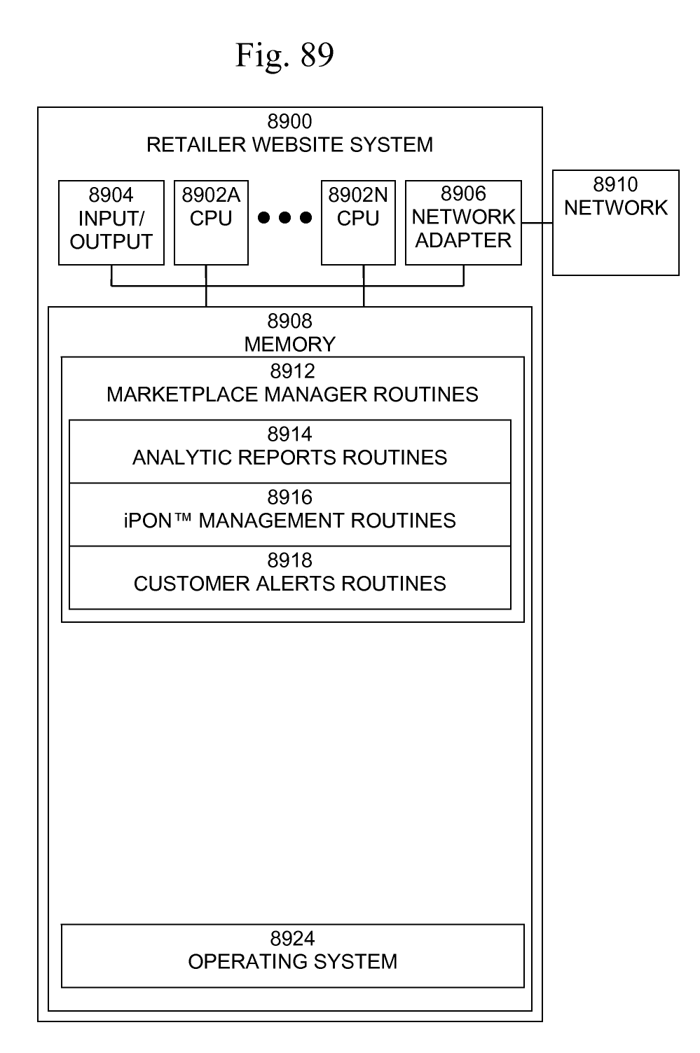

In one embodiment, the Marketplace may provide redemption of an iPON™ at physical store location. In embodiments where the iPON™ is used at a retail store, the customer may need to access an iPON™ promotional code, in the form of a barcode or Quick Response(QR) code or serial number that can be used with the store's POS devices. This code will work similarly to the promotional coupon codes now used by the store. For instance, the exemplary method may include, but is not limited to, the process shown in FIG. 87. In block 8702, the customer's cell phone number may be registered with the system. In block 8704, the customer may have specific identification information, such as an ID Number with the retailer that the customer gives the retailer. (For example a 4-digit code). In block 8706, the Buyer accesses his or her iPON™ account and chooses which iPON™ to redeem. In block 8708, the buyer selects the iPON™ and uses his or her associated promotional code number. This promotional code number may be given to the in-store representative to discount the appropriate amount of the iPON™ from the total sale—this promotional code preferably expires within a predetermined time period, for instance 2 hours, after having been used in the retailer store. In block 8710, when the store accepts the iPON™ promo code, the store notifies the Platform and this iPON™ is retired. To avoid multiple uses of the same iPON™ promotional code, the store may not redeem the same number more than once. If a customer does not spend the iPON™ after acquiring it, it may not be accessed again for a certain amount of time. For example, if a buyer acquires a code that is good for 2 hours, and the buyer does not spend it, the buyer cannot access it for 24 hours; and if the customer has purchased a $1,000 iPON™, and spends $500, then he or she will be able to look at his or her account for the exact balance to know how much is then available to spend.

In one embodiment, the Marketplace may provide Security and Protocols for Communication. In one embodiment, customer access to an account containing iPON™s stored in the iPON™ database uses Two Factor Authentication as described at the www.twofactorauth.org website. The customer's iPON™ account may then be verified by sending a message including a number sequence, such as 3739, to the customer's registered cellphone or email address, or both. This number sequence may then be entered when the customer signs on to his or her iPON™ account.

One advantage of some embodiments of the present invention is that the software system will reside on the server. However, it may interact with a retailer's website and allow for an on-line negotiation to arrive at a mutually agreed price.

Another advantage of some embodiments of the present invention is that the system has the ability to create and to manage an electronic coupon (iPON™) that is assigned to a customer's account.

The iPON™ comprises yet another advantage of an embodiment of the present invention. The iPON™ may originate in several ways including, but not limited to: (1) as part of a seller's or retailer's offer, bundled with a product, either as an initial offer or as a counteroffer in a negotiation; (2) sold directly to an interested buyer; or (3) assigned to the customer in another manner by the retailer or original account holder.

One embodiment of the present invention stores the iPON™ in a customer's account, and many things can be done with it which include, but are not limited to: (1) it can be enhanced by the issuer even while resident in the customer's account; (2) it can be redeemed at the issuing retailer either online or in a physical store with the assistance of a mobile device, such as a smart phone; (3) it can be redeemed in any currency that the retailer allows; and (4) it can be traded or sold.

Each customer may have an iPON™ account on this separate database, as is done with Apple iTunes, whereby each customer has an account. Each account could also be likened to a frequent flier account, whereby each customer could access his or her account on-line, and see his or her mileage inventory. Unlike Apple iTunes, where customers own and store songs and movies, the iPON™ may have several features, such as 1) the iPON™ can be transferred via the database to other customers; 2) the iPON™ can be sold to other customers, via the trading platform; 3) the iPON™ can be modified by the issuing retailer to add features that the retailer would wish to add—for example, the retailer will always know the customer that holds the iPON™, and will very likely know the customer's buying habits—the retailer can provide the customer through the iPON™ account a special offer, and add value to the iPON™ if used within a certain time period (e.g., if certain customers have a $10.00 iPON™ in their accounts gained through the purchase of shorts, the retailer may notify such customers that for 30 days the iPON™ is worth $15 towards the purchase of casual pants); 4) the database would charge a fee for the redemption or transfer of the iPON™s, not on the issuance of the iPON™s, whereas iTunes makes a profit on the purchase and issuance of a song; and 5) the ability to charge a license fee for the Negotiation software licensed to the retailer.

While storing the iPON™ Value in the database is similar to an airline frequent flyer account, the iPON™ may have several different features including, but not limited to 1) storage of multiple iPON™s from multiple retailers in the same account, so a customer only has to have one account; 2) accessibility through a mobile device, such as a smartphone, for use in the retailer's physical shop, for example, at a store in a shopping mall (today frequent flyer miles can only be used on-line or over the phone to purchase a flight, and often not at an airport due to the difficulty of redemption); 3) the ability to follow changes in value, as each iPON™ will be listed separately, although there may be a summary statement of value by retailer; and 4) the ability to have a declared cash value.

In one embodiment, the iPON™ may include features substantially similar to those that may be found in a gift card. However, the iPON™ may also include, but is not limited to, the following functionalities: 1) resides only on the server and be redeemed through the database that communicates with the retailer's servers; 2) purchased or awarded online; 3) in a preferred embodiment, it is not a physical card; 4) traded on the Platform, never on an independent gift card-trading platform; 5) used across international borders, as the iPON™ can be issued in any currency and re-set to any currency by the retailer if the retailer chooses; 6) the primary source of the iPON™ is the negotiation for a purchase; 7) capability to add other value enhancing features other than simply cash discount value; 8) identified with a specific registered customer; 9) not a cash equivalent, but a discount, allows function as a medium of value; and 10) offered by third party retailers, not simply the issuing retailer, it can be purchased by another retailer and offered to members to cross-promote products.

Unlike Internet applications that sell retailer's merchandise online, the iPON™ system provides a benefit to retailers that is largely missing—it reduces the price sensitivity of the Internet selling process. Sites that are not as retailer-friendly, whereby these sites essentially post several prices from several retailers for the same items, making the lowest price often the winner, and essentially creating a de facto auction. This gives the retailer the opportunity to: (1) avoid posting the lowest price and negotiate the sale; and (2) differentiate the product offering with the addition of an iPON™ to the offering. As mentioned previously the iPON™ can have many features, and is not limited to a cash discount on future sales.

Unlike any existing coupon, iTunes product, frequent flyer, or retailer loyalty reward program, one embodiment of the present invention also offers the retailer the opportunity to purchase iPON™ credits from other retailers and as part of the selling practice, and can offer an iPON™ from a manufacturer or another retailer to the customer. For example, an automobile manufacturer could purchase $500 iPON™ credits from a retailer, at a price less than $500, and offer these as part of the sale to entice buyers. A kitchen cabinet manufacturer could offer an iPON™ credit on a specific brand of refrigerator, for example.

Unlike a company offering coupons for merchandise it is retailing, independent from the retailer originating coupons, manufacturers, such as consumer product companies, can offer iPON™s, for sale or as an incentive to work as manufacturer coupons. Manufacturer coupons provide a discount at the Point Of Sale, and the manufacturer refunds to the retailer this discount after the same is made. These manufacturer coupons would reside in the customer's account, along with other iPON™s, and could be transferred or sold to other customers with iPON™ accounts. This point can be powerful as we could offer these coupons for sale to iPON™ holders—$5.00 for a $100 discount, and they could be traded—probably to a higher re-sale value to someone looking for a $100 coupon. Manufacturers would benefit, as someone paying for this coupon is likely to be a buyer.

Currently, in physical stores, discount sales are offered to attract buyers. Customers come in, look at the prices, and select an item if they like the value proposition. For a retailer, iPON™s can enhance this process as part of a physical in-store sale. Currently, salespeople in retail stores are involved with the normal tasks of assisting customers and marked prices are generally the final prices for an in-store sale. Once the iPON™ is available, these can be offered as part of the transaction. The iPON™ may be coded on the sales receipt, and the customer may go home, log into his or her account and input the iPON™ code and see the iPON™ credit appear in his or her account. This unique capability will have the effect of giving the retailer's sales force another tool in a store to make a sale.

One embodiment of the present invention is different from other systems in effect as each retailer controls the issuance, including using the Negotiator for iPON™ issuance.

In one embodiment, the present invention provides Exemplary Value Redemption of iPON™s Based on Retailer Proximity. At the retailer option, the iPON™ has the ability to increase in value automatically if the customer is detected to be within the defined range of the retailer store. This method may rely on a variety of location technologies, including the customer cell phone tower location information made available through geo-location technology of the customer's cell phone. If the customer is within a predetermined range of a retailer store, such as within one mile, the customer will be notified by a text message that the iPON™ increased by $10 if they use it to make an in-store retailer purchase.

In one embodiment, the present invention provides use of information not available today on mobile device. For example, in this embodiment, information that may be available on the mobile device may include the following: 1) ability to find receipts by store; 2) ability to see total value of iPON™ credits and for each issuer; 3) ability to trade and see status of offers to sell or buy an iPON™; 4) ability to be noticed on expiration date of an iPON™; 5) ability to see offers and enhancements of an iPON™; 6) Partner Use category allows transfer of an iPON™ from one retailer to another when the retailers have an agreement for such transfers; 7) Network Value category shows value of iPON™ that can be spent on retailers that belong to a Network that will honor the iPON™; 8) Cross Border application tells the user, by retailer, what the rate that will be available if the user wished to have the iPON™ issued in another currency, updated daily; 9) dining application allows communication to the iPON™ holder, including booking within the iPON™ terms.

An exemplary block diagram of an embodiment of Marketplace Server system 8800, such as is shown in FIG. 1, is shown in FIG. 88. Marketplace Server system 8800 is typically a programmed general-purpose computer system, such as a personal computer, tablet computer, mobile device, workstation, server system, minicomputer, mainframe computer, etc. Marketplace Server system 8800 includes one or more processors (CPUs) 8802A-8802N, input/output circuitry 8804, network adapter 8806, and memory 8808. CPUs 8802A-8802N execute program instructions in order to carry out the functions of the present invention. Typically, CPUs 8802A-8802N are one or more microprocessors, such as an INTEL PENTIUM® processor. FIG. 88 illustrates an embodiment in which Marketplace Server system 8800 is implemented as a single multi-processor computer system, in which multiple processors 8802A-8802N share system resources, such as memory 8808, input/output circuitry 8804, and network adapter 8806. However, the present invention also contemplates embodiments in which Marketplace Server system 8800 is implemented as a plurality of networked computer systems, which may be single-processor computer systems, multi-processor computer systems, or a mix thereof.

Input/output circuitry 8804 provides the capability to input data to, or output data from, Marketplace Server system 8800. For example, input/output circuitry may include input devices, such as keyboards, mice, touchpads, trackballs, scanners, etc., output devices, such as video adapters, monitors, printers, etc., and input/output devices, such as, modems, etc. Network adapter 8806 interfaces Marketplace Server system 8800 with a network 8810. Network 8810 may be any public or proprietary LAN or WAN, including, but not limited to the Internet.

Memory 8808 stores program instructions that are executed by, and data that are used and processed by, CPU 8802 to perform the functions of Marketplace Server system 8800. Memory 8808 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 8808 vary depending upon the function that verification Marketplace Server system 8800 is programmed to perform. In the example shown in FIG. 88, exemplary memory contents for a for an analysis system are shown. However, one of skill in the art would recognize that these functions, along with the memory contents related to those functions, may be included on one system, or may be distributed among a plurality of systems, based on well-known engineering considerations. The present invention contemplates any and all such arrangements.

In the example shown in FIG. 88, memory 8808 may include negotiator interface routines 8812, negotiator logic routines 8814, iPON™ database data 8816, iPON™ database routines 8818, and operating system 8824. Negotiator interface routines 8812 may generate the Negotiator Interface that may be used by retail customers to negotiate retailer item price and potentially offer an iPON™. Negotiator logic routines 8814 may implement an artificial intelligence using rule based programming to respond to specific customer input with specific counteroffers in real time using Negotiator Interface routines 8812. In one embodiment, iPON™ database data 8816 may include stored iPON™ data, such as cash or retailer reward credit. iPON™ database routines 8818 may provide the capability to manages iPON™ transactions such as storage of an iPON™, the issuance of an iPON™, a purchase of an iPON™, the sale of an iPON™, any changes in value or characteristics of the iPON™s, an interface with customers who hold and use the iPON™s on their computers and/or mobile devices, and the trading of iPON™s with other members.

Operating system 8824 provides overall system functionality.

An exemplary block diagram of an embodiment of Retailer Website system 8900, such as is shown in FIG. 1, is shown in FIG. 89. Retailer Website system 8900 is typically a programmed general-purpose computer system, such as a personal computer, tablet computer, mobile device, workstation, server system, minicomputer, mainframe computer, etc. Retailer Website system 8900 includes one or more processors (CPUs) 8902A-8902N, input/output circuitry 8904, network adapter 8906, and memory 8908. CPUs 8902A-8902N execute program instructions in order to carry out the functions of the present invention. Typically, CPUs 8902A-8902N are one or more microprocessors, such as an INTEL PENTIUM® processor. FIG. 89 illustrates an embodiment in which Retailer Website system 8900 is implemented as a single multi-processor computer system, in which multiple processors 8902A-8902N share system resources, such as memory 8908, input/output circuitry 8904, and network adapter 8906. However, the present invention also contemplates embodiments in which Retailer Website system 8900 is implemented as a plurality of networked computer systems, which may be single-processor computer systems, multi-processor computer systems, or a mix thereof.

Input/output circuitry 8904 provides the capability to input data to, or output data from, Retailer Website system 8900. For example, input/output circuitry may include input devices, such as keyboards, mice, touchpads, trackballs, scanners, etc., output devices, such as video adapters, monitors, printers, etc., and input/output devices, such as, modems, etc. Network adapter 8906 interfaces Retailer Website system 8900 with a network 8910. Network 8910 may be any public or proprietary LAN or WAN, including, but not limited to the Internet.

Memory 8908 stores program instructions that are executed by, and data that are used and processed by, CPU 8902 to perform the functions of Retailer Website system 8900. Memory 8908 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 8908 vary depending upon the function that verification Retailer Website system 8900 is programmed to perform. In the example shown in FIG. 89, exemplary memory contents for a for an analysis system are shown. However, one of skill in the art would recognize that these functions, along with the memory contents related to those functions, may be included on one system, or may be distributed among a plurality of systems, based on well-known engineering considerations. The present invention contemplates any and all such arrangements.

In the example shown in FIG. 89, memory 8908 may include Marketplace Manager routines 8912, which may include Analytic Reports routines 8914, iPON™ Management routines 8916, and Customer Alerts routines 8918, and operating system 8924. Analytic Reports routines 8914 may provide information on transactions and operation of the Retailer Website system 8900, such as information on customer sales, optimal selling price, information for negotiation, etc. iPON™ Management routines 8916 may provide the capability to manage iPON™ accounts and corresponding customer iPON™ information, iPON™ receipts, etc. Customer Alerts routines 8918 may provide the capability to communicate with customers by text or email. Operating system 8924 provides overall system functionality.

As shown in FIGS. 88 and 89, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

It is important to note that while aspects of the present invention may be implemented in the context of a fully functioning data processing system, those of ordinary skill in the art will appreciate that the processes of the present invention are capable of being distributed in the form of a computer program product including a computer readable medium of instructions. Examples of non-transitory computer readable media include storage media, examples of which include, but are not limited to, floppy disks, hard disk drives, CD-ROMs, DVD-ROMs, RAM, and, flash memory.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for processing at least one item identified by a buyer for purchase from a seller, comprising:
receiving, by at least one computing device, an identification of at least one item or service identified by a buyer for purchase in an electronic commerce transaction or in a physical purchase transaction, and receiving an indication of a price the buyer is willing to pay for the at least one item or service;
responsive to receiving the identification, generating, by the at least one computing device, transaction term data for the at least one item or service by:
receiving, by the at least one computing device, a sequence of transaction term data inputs from the buyer, and
generating, by the at least one computing device, a corresponding sequence of display information pages, each display information page including a transaction term data output generated in response to each received transaction term data input,
wherein the transaction term data includes at least some of a sales price for the identified item or service, a discount or credit for the identified item or service, a sales price for an item or service other than the identified item or service, a discount or credit for an item or service other than the identified item or service, and items or services other than the identified item or service to be included in the transaction, wherein the identified item or service or each item or service other than the identified item or service may be provided by the seller or by another party;
responsive to generating the transaction term data, generating, by the at least one computing device, a data file including at least some of the transaction term data including transaction term data relating to at least some of the identified item or service and each item or service other than the identified item or service, an identification of a party providing the identified item or service and each item or service other than the identified item or service, an identification of the buyer associated with the data file, and an identification of the seller, stored in memory, wherein the memory further stores a plurality of data files associated with different buyers, different sellers, and different transactions;
receiving, by the at least one computing device, an identification of one of the plurality of data files from a buyer, wherein the data file is associated with the buyer; and
completing the electronic commerce purchase transaction or the physical purchase transaction using at least some of the transaction term data included in the identified data file.

2. The method of claim 1, further comprising:
authenticating, by the at least one computing device, a buyer; and
providing, by the at least one computing device, the authenticated buyer with access to at least one data file associated with that buyer.

3. The method of claim 2, wherein access to at least one data file associated with that buyer comprises capability to identify a data file to be used to complete a transaction and capability to modify the data file.

4. The method of claim 1, further comprising:
receiving, by the at least one computing device, at least one modification to at least one of the plurality of stored data files, wherein the modification includes modifying at least some of the transaction term data in the data file.

5. The method of claim 4, wherein the modification is performed by the buyer.

6. The method of claim 4, wherein the modification is performed by the seller.

7. A system for processing at least one item identified by a buyer for purchase from a seller, comprising at least one computing device comprising a processor, memory accessible to the processor, and program instructions and data stored in the memory, the program instructions executable by the processor for:
receiving, by the at least one computing device, an identification of at least one item or service identified by a buyer for purchase in an electronic commerce transaction or in a physical purchase transaction, and receiving an indication of a price the buyer is willing to pay for the at least one item or service;
responsive to receiving the identification, generating, by the at least one computing device, transaction term data for the at least one item or service by:
receiving, by the at least one computing device, a sequence of transaction term data inputs from the buyer, and
generating, by the at least one computing device, a corresponding sequence of display information pages, each display information page including a transaction term data output generated in response to each received transaction term data input,
wherein the transaction term data includes at least some of a sales price for the identified item or service, a discount or credit for the identified item or service, a sales price for an item or service other than the identified item or service, a discount or credit for an item or service other than the identified item or service, and items or services other than the identified item or service to be included in the transaction, wherein the identified item or service or each item or service other than the identified item or service may be provided by the seller or by another party;
responsive to generating the transaction term data, generating, by the at least one computing device, a data file including at least some of the transaction term data including transaction term data relating to at least some of the identified item or service and each item or service other than the identified item or service, an identification of a party providing the identified item or service and each item or service other than the identified item or service, an identification of the buyer associated with the data file, and an identification of the seller, stored in memory, wherein the memory further stores a plurality of data files associated with different buyers, different sellers, and different transactions;
receiving, by the at least one computing device, an identification of one of the plurality of data files from a buyer, wherein the data file is associated with the buyer; and
completing the electronic commerce purchase transaction or the physical purchase transaction using at least some of the transaction term data included in the identified data file.

8. The system of claim 7, further comprising:
authenticating, by the at least one computing device, a buyer; and
providing, by the at least one computing device, the authenticated buyer with access to at least one data file associated with that buyer.

9. The system of claim 8, wherein access to at least one data file associated with that buyer comprises capability to identify a data file to be used to complete a transaction and capability to modify the data file.

10. The system of claim 7, further comprising:
receiving, by the at least one computing device, at least one modification to at least one of the plurality of stored data files, wherein the modification includes modifying at least some of the transaction term data in the data file.

11. The system of claim 10, wherein the modification is performed by the buyer.

12. The system of claim 10, wherein the modification is performed by the seller.

13. A method for processing an electronic coupon, comprising:
generating, by at least one computing device, electronic coupon data for the at least one item or service by:
receiving, by the at least one computing device, a sequence of electronic coupon data inputs from a recipient of the electronic coupon, and
generating, by the at least one computing device, a corresponding sequence of display information pages, each display information page including electronic coupon data output generated in response to each received electronic coupon data input,
wherein the electronic coupon data includes at least information identifying an issuer of the electronic coupon, information identifying at least one location at which or organization with which the electronic coupon may be redeemed, information identifying an owner of the electronic coupon, information indicating a value of the electronic coupon, a unique identifier of the electronic coupon, and information relating to a co-marketing feature;
responsive to generating the electronic coupon data, generating, by the at least one computing device, a data file including at least some of the electronic coupon data including information identifying an issuer of the electronic coupon, information identifying at least one location at which or organization with which the electronic coupon may be redeemed, information identifying an owner of the electronic coupon, information indicating a value of the electronic coupon, a unique identifier of the electronic coupon, and information relating to co-marketing, stored in memory, wherein the memory further stores a plurality of data files associated with different buyers, different sellers, and different transactions;
receiving, by the at least one computing device, an identification of an electronic coupon;
accessing a data file corresponding to the received identification of the electronic coupon,
redeeming the electronic coupon in an electronic commerce purchase transaction or a physical purchase transaction using at least some of the electronic coupon data included in the identified data file;
wherein the information relating to co-marketing further defines at least one additional location at which or organization with which the electronic coupon may be redeemed and is controlled by and modifiable by the issuer of the electronic coupon.

14. The method of claim 13, wherein the electronic coupon data further includes:
information relating to at least one enhancement to terms of the electronic coupon;
information indicating whether or not transfer of the electronic coupon to another owner is allowed;
information relating to re-issuance of the electronic coupon; and
information indicating a price at which the electronic coupon may be re-sold.

15. The method of claim 13, further comprising:
securing financial information and other electronic coupon information using a crypto-currency blockchain ledger system, wherein the electronic coupon data further includes:
information relating to additional security information, including at least one of a photograph of the owner of the electronic coupon;
a name of the owner of the electronic coupon; and
an email address of the owner of the electronic coupon.

16. The method of claim 13, wherein the electronic coupon data further includes:
video information;
audio information;
information defining an option to purchase an item, including information relating to terms of the option and an expiration time or date of the option;
information relating to an offer to purchase an item at a lower price;
information defining a variable value of the electronic coupon based on a location at which or organization with which the electronic coupon is be redeemed or based on a form of payment that is used; and
information indicating products on which the electronic coupon may be used.

17. A system for processing an electronic coupon, comprising at least one computing device comprising a processor, memory accessible to the processor, and program instructions and data stored in the memory, the program instructions executable by the processor for:
generating, by at least one computing device, electronic coupon data for the at least one item or service by:
receiving, by the at least one computing device, a sequence of electronic coupon data inputs from a recipient of the electronic coupon, and
generating, by the at least one computing device, a corresponding sequence of display information pages, each display information page including electronic coupon data output generated in response to each received electronic coupon data input,
wherein the electronic coupon data includes at least information identifying an issuer of the electronic coupon, information identifying at least one location at which or organization with which the electronic coupon may be redeemed, information identifying an owner of the electronic coupon, information indicating a value of the electronic coupon, a unique identifier of the electronic coupon, and information relating to a co-marketing feature;
responsive to generating the electronic coupon data, generating, by the at least one computing device, a data file including at least some of the electronic coupon data including information identifying an issuer of the electronic coupon, information identifying at least one location at which or organization with which the electronic coupon may be redeemed, information identifying an owner of the electronic coupon, information indicating a value of the electronic coupon, a unique identifier of the electronic coupon, and information relating to co-marketing, stored in memory, wherein the memory further stores a plurality of data files associated with different buyers, different sellers, and different transactions;
receiving, by the at least one computing device, an identification of an electronic coupon;
accessing a data file corresponding to the received identification of the electronic coupon,
redeeming the electronic coupon in an electronic commerce purchase transaction or a physical purchase transaction using at least some of the electronic coupon data included in the identified data file;
wherein the information relating to co-marketing further defines at least one additional location at which or organization with which the electronic coupon may be redeemed and is controlled by and modifiable by the issuer of the electronic coupon.

18. The system of claim 17, wherein the electronic coupon data further includes:
information relating to at least one enhancement to terms of the electronic coupon;
information indicating whether or not transfer of the electronic coupon to another owner is allowed;
information relating to re-issuance of the electronic coupon; and
information indicating a price at which the electronic coupon may be re-sold.

19. The system of claim 17, further comprising:
securing financial information and other electronic coupon information using a crypto-currency blockchain ledger system, wherein the electronic coupon data further includes:
information relating to additional security information, including at least one of a photograph of the owner of the electronic coupon;
a name of the owner of the electronic coupon; and
an email address of the owner of the electronic coupon.

20. The system of claim 17, wherein the electronic coupon data further includes:
video information;
audio information;
information defining an option to purchase an item, including information relating to terms of the option and an expiration time or date of the option;
information relating to an offer to purchase an item at a lower price;
information defining a variable value of the electronic coupon based on a location at which or organization with which the electronic coupon is be redeemed or based on a form of payment that is used; and
information indicating products on which the electronic coupon may be used.
